(19) United States
(12) Patent Application Publication
(10) Pub. No.: US 2022/0236704 A1
(43) Pub. Date: Jul. 28, 2022

(54) CONTROL SYSTEM, SERVER, APPARATUS AND CONTROL METHOD

(71) Applicant: Mitsubishi Electric Corporation, Tokyo (JP)

(72) Inventors: Masato NAGASAWA, Tokyo (JP); Satoko MIKI, Tokyo (JP); Junko KIJIMA, Tokyo (JP); Takashi SEKI, Tokyo (JP); Takashi ARAI, Tokyo (JP)

(21) Appl. No.: 17/592,666

(22) Filed: Feb. 4, 2022

Related U.S. Application Data
(63) Continuation of application No. PCT/JP2019/031638, filed on Aug. 9, 2019.

(51) Int. Cl. G05B 19/042; H04L 67/12; H04L 67/1097; F24F 11/65

(52) U.S. Cl. CPC G05B 19/042; H04L 67/12; G05B 2219/2614; F24F 11/65; H04L 67/1097

(57) ABSTRACT

A cloud server includes a history information acquirer that acquires history information including operation history information expressing a history of a device setting parameter of an air conditioner or a water heater, environment history information expressing the environment in which the air conditioner or the water heater operates, and user information expressing a user of the air conditioner or the water heater, a coefficient determiner that determines, based on the history information, a neural network coefficient of the neural network, and a schedule generator that uses the neural network, in which the neural network coefficient is determined by the coefficient determiner, to generate schedule information expressing a future operation schedule of the air conditioner or the water heater.

### CROSS REFERENCE TO RELATED APPLICATION

This application is a U.S. bypass application of International Patent Application No. PCT/JP2019/031638 filed on Aug. 9, 2019, the disclosure of which is incorporated herein by reference.

The present disclosure relates to a control system, a server, a device and a control method.

### BACKGROUND

In recent years, device control systems have been proposed that utilize machine learning in which a neural network is used. For example, an air conditioning system has been proposed that includes a plurality of air conditioning devices, a cloud server that is connected to the plurality of air conditioning devices via an internet and that processes, by machine learning, environment information acquired from the air conditioning devices to construct control rules for individually controlling the air conditioning devices (for example, see Patent Literature 1). After constructing the control rules, the cloud server uses the control rules to calculate command values for controlling optimal operating states of the air conditioning devices, and sends the command values to the air conditioning devices via the internet.

### PATENT LITERATURE

Patent Literature 1: Unexamined Japanese Patent Application Publication No. 2018-123998

However, with the air conditioning system proposed in Patent Literature 1, the environment information and the command values are frequently exchanged between the cloud server and the air conditioning devices via the internet. Consequently, when the communication traffic on the internet increases and the communication speed decreases, maintaining the air conditioning devices in the optimal states may become difficult.

The present disclosure is made with the view of the above situation, and an objective of the present disclosure is to provide a control system, a server, a device, and a control method whereby, when executing calculations using a neural network in the device and/or the server, the effects, on the operations of the device, of communication traffic on the network are reduced.

### SUMMARY

A control system according to the present disclosure that achieves the objective described above includes:

a server; and a device; wherein

the server includes
a history information acquirer that acquires history information including operation history information expressing a history of a device setting parameter of the device, environment history information expressing a history of an environment in which the device operates, and user information expressing a user of the device,
a coefficient determiner that determines, based on the history information, a first neural network coefficient of a first neural network for calculating a future device setting parameter of the device, the first neural network having a predetermined number of nodes and a predetermined number of layers,
a neural network calculator that calculates the future device setting parameter of the device from an environment parameter, included in the environment history information, indicating an environment at present by using the first neural network, for which the first neural network coefficient is determined by the coefficient determiner, and
a schedule generator that generates, based on the device setting parameter calculated by the neural network calculator, schedule information expressing a future operation schedule of the device, and

the device includes
a device controller that controls the device in accordance with the operation schedule expressed by the schedule information.

According to the present disclosure, in the server, the neural network calculator uses the first neural network, for which the first neural network coefficient is determined by the coefficient determiner, to calculate the future device setting parameter of the device from the environment parameter indicating the environment at present included in the environment history information. Additionally, the schedule generator generates, on the basis of the device setting parameter calculated by the neural network calculator, the schedule information expressing the future operation schedule of the device. Moreover, the device controller of the device controls the device in accordance with the operation schedule expressed by the schedule information. As a result, the device can be controlled in accordance with the operation schedule expressed by the schedule information by the device merely sending the history information to the server and acquiring the schedule information from the server every period corresponding to the operation schedule expressed by the schedule information. Therefore, the frequency at which the history information and the schedule information are exchanged between the device and the server is reduced, which leads to the benefit of a reduction of the effects, on the operations of the device, of the communication traffic on the network.

### BRIEF DESCRIPTION OF THE DRAWINGS

A more complete understanding of this application can be obtained when the following detailed description is considered in conjunction with the following drawings, in which:

FIG. 1 is a schematic configuration drawing of a control system according to Embodiment 1 of the present disclosure;

FIG. 2 is a block diagram illustrating the hardware configuration of an air conditioner according to Embodiment 1;

FIG. 3 is a block diagram illustrating the functional configuration of the air conditioner according to Embodiment 1;

FIG. 4A is a drawing illustrating an example of a temperature history of a room in which the air conditioner according to Embodiment 1 is installed;

FIG. 4B is a drawing illustrating an example of the temperature history of the room in which the air conditioner according to Embodiment 1 is installed;

FIG. 5 is a drawing illustrating an example of information stored in a history information storage according to Embodiment 1;

FIG. 6 is a block diagram illustrating the hardware configuration of a water heater according to Embodiment 1;

FIG. 7 is a block diagram illustrating the functional configuration of the water heater according to Embodiment 1;

FIG. 8A is a drawing illustrating an example of a temperature history of a bathroom in which the air conditioner according to Embodiment 1 is installed;

FIG. 8B is a drawing illustrating an example of the temperature history of the bathroom in which the air conditioner according to Embodiment 1 is installed;

FIG. 9A is a drawing illustrating an example of information stored in the history information storage according to Embodiment 1;

FIG. 9B is a drawing illustrating an example of the information stored in the history information storage according to Embodiment 1;

FIG. 10 is a block diagram illustrating the hardware configuration of a cloud server according to Embodiment 1;

FIG. 11 is a block diagram illustrating the functional configuration of the cloud server according to Embodiment 1;

FIG. 12 is an operation explanation drawing of a neural network calculator according to Embodiment 1;

FIG. 13 is a sequence drawing illustrating an example of the operations of the control system according to Embodiment 1;

FIG. 14 is a drawing illustrating an example of history attribute information according to Embodiment 1;

FIG. 15 is a flowchart illustrating an example of the flow of device control processing executed by the air conditioner according to Embodiment 1;

FIG. 16 is a flowchart illustrating an example of the flow of schedule generation processing executed by the cloud server according to Embodiment 1;

FIG. 17 is a flowchart illustrating an example of the flow of coefficient determination processing executed by the cloud server according to Embodiment 1;

FIG. 18 is a flowchart illustrating an example of the flow of device setting calculation processing executed by the cloud server according to Embodiment 1;

FIG. 19 is a block diagram illustrating the functional configuration of a cloud server according to Embodiment 2;

FIG. 20 is a drawing illustrating an example of preference feature amount information according to Embodiment 2;

FIG. 21 is a block diagram illustrating the functional configuration of an air conditioner according to Embodiment 2;

FIG. 22 is a drawing illustrating an example of information stored in a schedule storage according to Embodiment 2;

FIG. 23 is a sequence drawing illustrating an example of the operations of a control system according to Embodiment 2;

FIG. 24 is a drawing illustrating an example of history attribute information according to Embodiment 2;

FIG. 25 is a flowchart illustrating an example of the flow of preference feature amount information generation processing executed by the cloud server according to Embodiment 2;

FIG. 26 is a flowchart illustrating an example of the flow of coefficient determination processing executed by the cloud server according to Embodiment 2;

FIG. 27 is a flowchart illustrating an example of the flow of preference feature amount calculation processing executed by the cloud server according to Embodiment 2;

FIG. 28 is a block diagram illustrating the hardware configuration of an air conditioner according to Embodiment 3;

FIG. 29 is a block diagram illustrating the configuration of a neuro engine according to Embodiment 3;

FIG. 30 is a block diagram illustrating the functional configuration of the air conditioner according to Embodiment 3;

FIG. 31 is a block diagram illustrating the functional configuration of a cloud server according to Embodiment 3;

FIG. 32 is a sequence drawing illustrating an example of the operations of a control system according to Embodiment 3;

FIG. 33 is a drawing illustrating an example of coefficient attribute information according to Embodiment 3;

FIG. 34 is a flowchart illustrating an example of the flow of device control processing executed by the air conditioner according to Embodiment 3;

FIG. 35 is a flowchart illustrating an example of the flow of coefficient information generation processing executed by the cloud server according to Embodiment 3;

FIG. 36 is a block diagram illustrating the functional configuration of an air conditioner according to Embodiment 4;

FIG. 37 is a block diagram illustrating the functional configuration of a cloud server according to Embodiment 4;

FIG. 38 is a sequence drawing illustrating an example of the operations of a control system according to Embodiment 4;

FIG. 39 is a flowchart illustrating an example of the flow of device control processing executed by the air conditioner according to Embodiment 4;

FIG. 40 is a flowchart illustrating an example of the flow of coefficient information generation processing executed by the cloud server according to Embodiment 4;

FIG. 41 is a block diagram illustrating the functional configuration of an air conditioner according to Embodiment 5;

FIG. 42 is a block diagram illustrating the functional configuration of a cloud server according to Embodiment 5;

FIG. 43 is a sequence drawing illustrating an example of the operations of a control system according to Embodiment 5;

FIG. 44 is a sequence drawing illustrating an example of the operations of the control system according to Embodiment 5;

FIG. 45 is a flowchart illustrating an example of the flow of device control processing executed by the air conditioner according to Embodiment 5;

FIG. 46 is a flowchart illustrating an example of the flow of coefficient information generation processing executed by the cloud server according to Embodiment 5;

FIG. 47 is a block diagram illustrating the functional configuration of an air conditioner according to Embodiment 6;

FIG. 48 is a block diagram illustrating the functional configuration of a cloud server according to Embodiment 6;

FIG. 49 is a sequence drawing illustrating an example of the operations of a control system according to Embodiment 6;

FIG. 50 is a flowchart illustrating an example of the flow of device control processing executed by the air conditioner according to Embodiment 6;

FIG. 51 is a flowchart illustrating an example of the flow of teacher information sending processing executed by the cloud server according to Embodiment 6;

FIG. 52 is a schematic configuration drawing of a control system according to Embodiment 7 of the present disclosure;

FIG. 53 is a block diagram illustrating the functional configuration of an air conditioner according to Embodiment 7;

FIG. 54 is a block diagram illustrating the hardware configuration of the air conditioner according to Embodiment 7;

FIG. 55 is a block diagram illustrating the functional configuration of an air conditioner according to Embodiment 7;

FIG. 56 is a sequence drawing illustrating an example of the operations of a control system according to Embodiment 7;

FIG. 57 is a flowchart illustrating an example of the flow of device control processing executed by the air conditioner according to Embodiment 7;

FIG. 58 is a schematic configuration drawing of a control system according to Embodiment 8 of the present disclosure;

FIG. 59 is a block diagram illustrating the functional configuration of an air conditioner according to Embodiment 8;

FIG. 60 is a block diagram illustrating the functional configuration of a cloud server according to Embodiment 8;

FIG. 61 is a sequence drawing illustrating an example of the operations of the control system according to Embodiment 8;

FIG. 62 is a sequence drawing illustrating an example of the operations of a control system according to Embodiment 8;

FIG. 63 is a flowchart illustrating an example of the flow of device control processing executed by the air conditioner according to Embodiment 8;

FIG. 64 is a flowchart illustrating an example of the flow of the device control processing executed by the air conditioner according to Embodiment 8;

FIG. 65 is a sequence drawing illustrating an example of the operations of the control system according to Embodiment 8;

FIG. 66 is a flowchart illustrating an example of the flow of device control processing executed by the air conditioner according to Embodiment 8;

FIG. 67 is a sequence drawing illustrating an example of the operations of the control system according to Embodiment 8;

FIG. 68 is a schematic configuration drawing of a control system according to a modified example;

FIG. 69 is a block diagram illustrating the functional configuration of a cloud server according to the modified example;

FIG. 70 is a block diagram illustrating the functional configuration of a storage server according to the modified example;

FIG. 71 is a drawing illustrating an example of information stored in an NN related information storage according to the modified example;

FIG. 72 is a sequence drawing illustrating an example of the operations of a control system according to the modified example;

FIG. 73 is a drawing illustrating an example of a display image displayed on a terminal device according to the modified example;

FIG. 74 is a sequence drawing illustrating an example of the operations of a control system according to the modified example;

FIG. 75 is a block diagram illustrating the configuration of a cloud server according to a modified example;

FIG. 76 is a block diagram illustrating the configuration of an air conditioner according to a modified example;

FIG. 77 is a block diagram illustrating the configuration of a cloud server according to a modified example;

FIG. 78 is a block diagram illustrating the configuration of an air conditioner according to a modified example; and

FIG. 79 is a block diagram illustrating the configuration of a cloud server according to a modified example.

### DETAILED DESCRIPTION

Hereinafter, a control system according to embodiments of the present disclosure is described in detail while referencing the drawings. The control system according to each embodiment is a control system that uses a neural network to calculate, on the basis of user information related to a user of a device, a future device setting parameter of the device from an environment parameter indicating an environment of a location at which the device is installed and weather prediction information expressing a future weather condition.

### Embodiment 1

With the control system according to the present embodiment, a server uses a neural network to calculate a future device setting parameter of a device from an environment parameter of a location at which the device is installed and weather prediction information expressing a future weather condition. Here, the neural network has a predetermined number of nodes and a predetermined number of layers, and is for calculating the future device setting parameter of the device. Additionally, the server generates, from the calculated future device setting parameter of the device, schedule information expressing a future operation schedule of the device. The server includes a history information acquirer that acquires, from the device, history information including operation history information expressing a history of the device setting parameter of the device, environment history information expressing a history of an environment in which the device operates, and user information expressing a user of the device; and a weather information acquirer that acquires, from a weather server, weather information including weather record information expressing a past weather condition, and weather prediction information expressing a future weather condition. Additionally, the server includes a coefficient determiner that determines a weighting coefficient of the neural network on the basis of the history information and the weather record information that are acquired; and a neural network calculator that uses a first neural network, for which a first neural network coefficient is determined, to calculate the future device setting parameter of the device from the weather prediction information and an environment parameter, included in the environment history information, indicating an environment at present. Furthermore, the server includes a schedule generator that generates, on the basis of the device setting parameter calculated by the neural network calculator, schedule information expressing a future operation schedule of the device. Moreover, the device includes a device controller that controls the device in accordance with the operation schedule expressed by the schedule information.

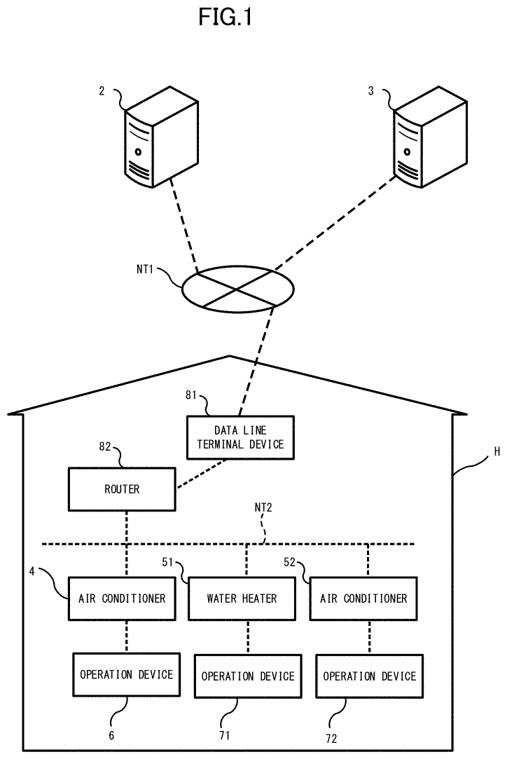

As illustrated in FIG. 1, the control system according to the present embodiment includes air conditioners 4, 52 and a water heater 51 that are installed in a house H, and a cloud server 2 capable of communicating via an external network NT1. In one example, the external network NT1 is the internet. Additionally, a weather server 3 is connected to the external network NT1. The weather server 3 distributes the weather record information expressing the past weather condition, and the weather prediction information expressing the future weather condition. Operation devices 6, 72 for operating the air conditioners 4, 52, the water heater 51, and an operation device 71 for operating the water heater 51 are installed in the house H. In this case, the air conditioner 4 is installed in a room such as a living room in the house H, and the air conditioner 52 is installed in a bathroom in the house H. Additionally, a router 82 connected to an internal network NT2, and a data line terminal device 81 connected to the router 82 and the external network NT1 are installed in the house H. The internal network NT2 is implemented as a wired local area network (LAN) or a wireless LAN, for example. The data line terminal device 81 is implemented as a modem, a gateway, or the like.

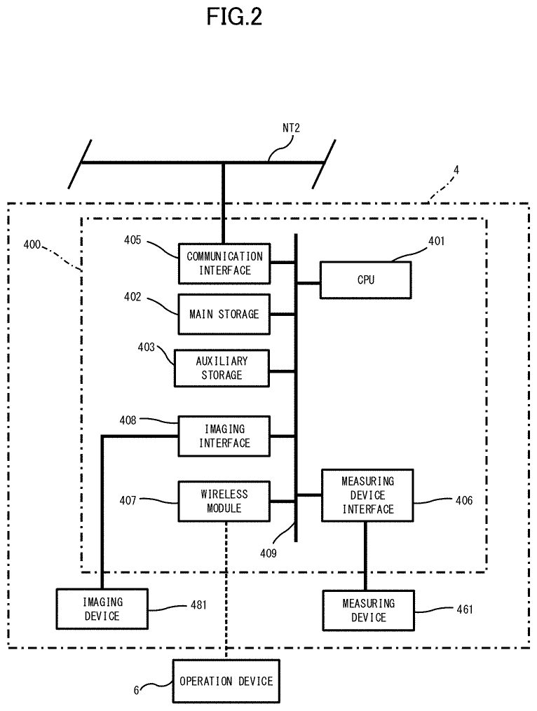

As illustrated in FIG. 2, the air conditioner 4 includes a controller 400, a measuring device 461 that measures a temperature of the room, and an imaging device 481 that images a user of the air conditioner 4. Note that the measuring device 461 is not limited to a device that measures the temperature of the room, and may be a device that measures an environment parameter indicating another environment of the room such as humidity, brightness, or the like of the room. In one example, a camera that captures an image expressing a temperature distribution of a surface of the user is used as the imaging device 481. Additionally, the air conditioner 4 includes a compressor (not illustrated in the drawings) and a blowing fan (not illustrated in the drawings) that operate on the basis of command signals input from the controller 400.

The controller 400 includes a central processing unit (CPU) 401, a main storage 402, an auxiliary storage 403, a communication interface 405, a measuring device interface 406, a wireless module 407, an imaging interface 408, and a bus 409 that connects these components to each other. The main storage 402 is constituted from volatile memory, and is used as a working area of the CPU 401. The auxiliary storage 403 is configured from non-volatile memory such as a magnetic disk, semiconductor flash memory, or the like, and stores a program for realizing the various functions of the controller 400. The communication interface 405 is connected to the internal network NT2, sends various information notified from the CPU 401 to the internal network NT2, and notifies the CPU 401 of various information received from the internal network NT2. The wireless module 407 wirelessly communicates with the operation device 6 and, when the wireless module 407 receives, from the operation device 6, operation information expressing operation content that the user performs on the operation device 6, the wireless module 407 notifies the CPU 401 of that operation information. When a measurement value signal is input from the measuring device 461, the measuring device interface 406 generates temperature information corresponding to that measurement value signal, and notifies the CPU 401 of the temperature information. When an image signal is input from the imaging device 481, the imaging interface 408 generates image information corresponding to that image signal, and notifies the CPU 401 of the image information. Note that the air conditioner 52 has the same hardware configuration as the air conditioner 4. Additionally, in the case of the air conditioner 52, the measuring device 461 measures an environment parameter such as temperature, humidity, brightness, or the like of the bathroom of the house H.

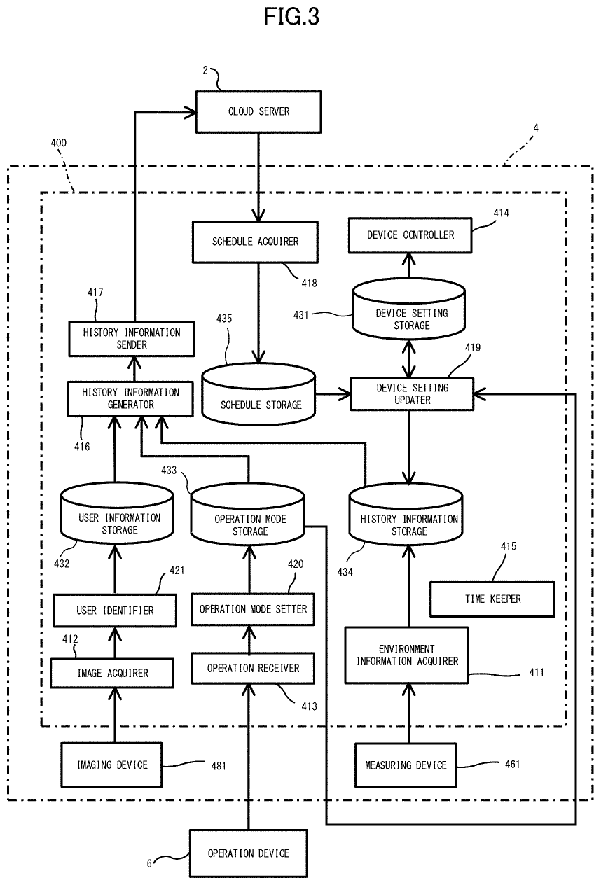

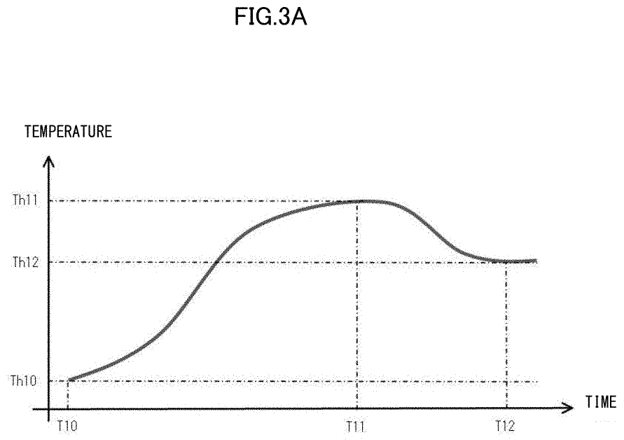

The CPU 401 reads out the program stored in the auxiliary storage 403 to the main storage 402 and executes the program to function as an environment information acquirer 411, an image acquirer 412, an operation receiver 413, a device controller 414, a time keeper 415, a history information generator 416, a history information sender 417, a schedule acquirer 418, a device setting updater 419, an operation mode setter 420, and a user identifier 421, as illustrated in FIG. 3. Note that the air conditioner 52 has the same functional configuration. As illustrated in FIG. 3, the auxiliary storage 403 illustrated in FIG. 2 includes a device setting storage 431 that stores device setting information expressing the device setting parameter of the air conditioner 4, and a user information storage 432 that stores user information about the user of the air conditioner 4. In one example, the user information storage 432 associates information expressing a position of a region of the surface of the user where heat dissipation is great with user identification information that identifies the user, and stores the associated information. Here, the position is calculated from a temperature distribution of the surface of the user expressed by the image information of each user captured by the imaging device 481. Additionally, the auxiliary storage 403 includes a history information storage 434 that stores the environment history information and device history information of the air conditioner 4, a schedule storage 435 that stores schedule information expressing an operation schedule of the air conditioner 4, and an operation mode storage 433 that stores operation mode information of the air conditioner 4.

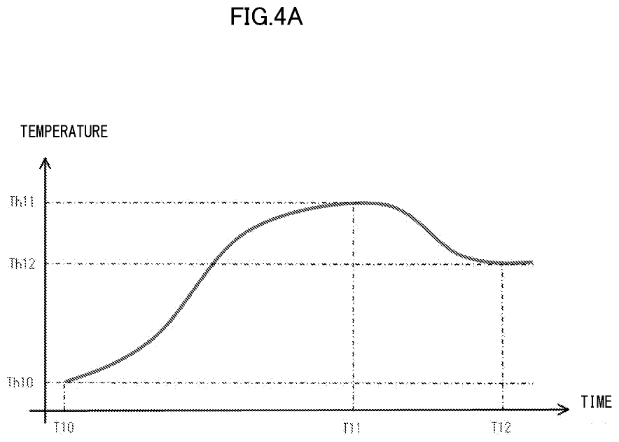

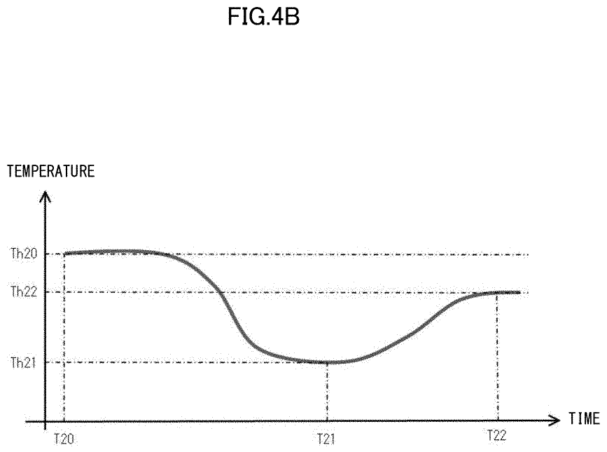

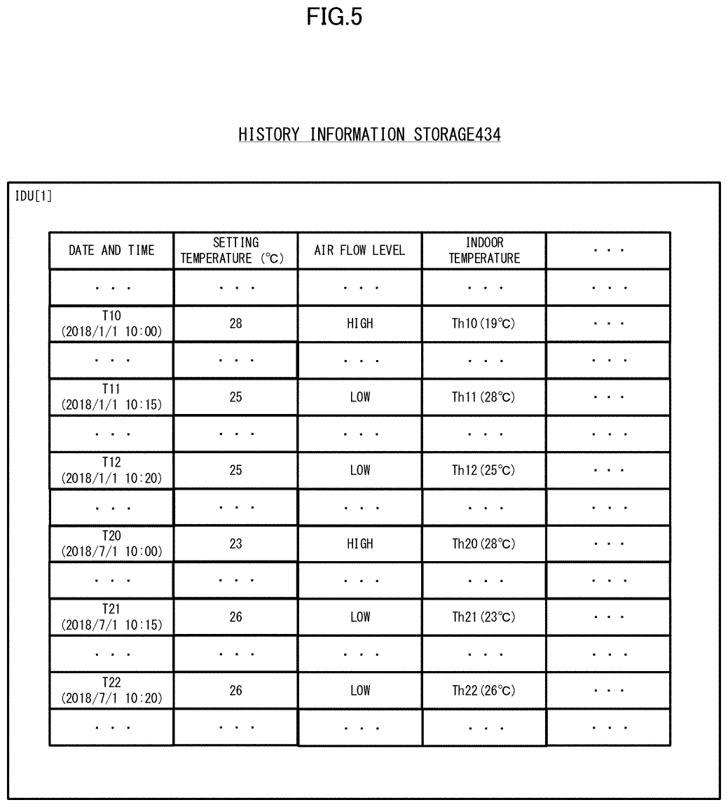

The history information storage 434 stores, for every user of the air conditioner 4, a history of the device setting information of the air conditioner 4 and a history of environment information expressing the environment parameter including the temperature information. In one example, as illustrated in FIG. 4A, it is assumed that a user that resides at the house H returns to the house H in the winter and, at a date and time T10 (for example, Jan. 1, 2018 10:00), while the operation mode of the air conditioner 4 is in a manual operation mode, sets a setting temperature to Th11 (for example, 28° C.), and an air flow level to “high” to operate the air conditioner 4. At this time, the temperature of the room in which the air conditioner 4 is installed is assumed to be Th10 (for example, 19° C.). In this case, the room is warmed by the air conditioner 4 and, at a date and time T11 (for example, Jan. 1, 2018 10:15), which is after the date and time T10, the temperature of the room reaches the setting temperature Th11. Here, it is assumed that the chilled body of the user is warmed and, as such, the user sets the setting temperature of the air conditioner 4 to Th12 (for example, 25° C.), which is lower than Th11, and sets the air flow level to “low.” In this case, the room is cooled by the air conditioner 4 and, at a date and time T12 (for example, Jan. 1, 2018 10:20), which is after the date and time T11, the temperature of the room reaches the setting temperature Th12. Meanwhile, as illustrated in FIG. 4B, it is assumed that the user that resides at the house H returns to the house H in the summer and, at a date and time T20 (for example, Jul. 1, 2018 10:00), while the operation mode of the air conditioner 4 is in the manual operation mode, sets the setting temperature to Th21 (for example, 23° C.), and the air flow level to “high” to operate the air conditioner 4. At this time, the temperature of the room in which the air conditioner 4 is installed is assumed to be Th20 (for example, 28° C.). In this case, the room is cooled by the air conditioner 4 and, at a date and time T21 (for example, Jul. 1, 2018 10:15), which is after the date and time T20, the temperature of the room reaches the setting temperature Th21. Here, it is assumed that the body of the user is cooled and, as such, the user sets the setting temperature of the air conditioner 4 to Th22 (for example, 26° C.), which is higher than Th21, and sets the air flow level to “low.” In this case, the room is warmed by the air conditioner 4 and, at a date and time T22 (for example, Jul. 1, 2018 10:20), which is after the date and time T21, the temperature of the room reaches the setting temperature Th22. In this case, as illustrated in FIG. 5, the history information storage 131 associates the operation history information expressing the history of the setting temperature and the air flow level of the air conditioner 4 and the environment history information expressing the history of the indoor temperature of the room with date and time information, and stores the associated information. Here, the history information storage 131 associates the operation history information and the environment history information with user identification information IDU [1] and device identification information IDA [1] identifying the air conditioner 4, and stores the associated information.

Returning to FIG. 3, the environment information acquirer 411 acquires, via the measuring device interface 406, the environment information that is the environment parameter indicating the temperature of the room measured by the measuring device 461. Note that, when the measuring device 461 measures another environment parameter of the room such as the humidity, the brightness, or the like of the room, the environment information acquirer 411 acquires environment information expressing this other environment parameter. The environment information acquirer 411 stores the acquired environment information chronologically in the history information storage 434. The image acquirer 412 acquires the image information of the user imaged by the imaging device 481.

When the operation receiver 413 is notified, by the wireless module 407, of operation information sent from the operation device 6, the operation receiver 413 receives the notified operation information. Then, when the operation information is related to an update of the device setting parameter of the air conditioner 4, the operation receiver 413 generates device setting information expressing the device setting parameter corresponding to the operation information, and stores the device setting information in the device setting storage 431. When the operation information is related to a change of the operation mode of the air conditioner 4, the operation receiver 413 notifies the operation mode setter 420 of operation mode information expressing the operation mode corresponding to the operation information. The device controller 414 controls the operations of the compressor and the blowing fan on the basis of the device setting information stored in the device setting storage 431.

The user identifier 421 identifies, from the temperature distribution of the surface of the user expressed by the image information acquired by the image acquirer 412, the region of the surface of the user where heat dissipation is great, and identifies the user of the air conditioner 4 on the basis of the information about the user and the position of the identified region stored in the user information storage 432. Additionally, the user identifier 421 stores the user identification information of the identified user of the air conditioner 4 in the user information storage 432. The schedule acquirer 418 acquires, from the cloud server 2, the schedule information expressing the operation schedule of the air conditioner 4. and stores the acquired schedule information in the schedule storage 435.

The device setting updater 419 references the operation mode information of the air conditioner 4 stored in the operation mode storage 433 and, when the operation mode is set to an automatic mode, generates the device setting information of the air conditioner 4 on the basis of the schedule information stored in the schedule storage 435 and a time at present measured by the time keeper 415. Then, the device setting updater 419 stores the generated device setting information in the device setting storage 431. The device setting updater 419 periodically stores the device setting information, stored in the device setting storage 431, chronologically in the history information storage 434.

In one example, the time keeper 415 includes a software timer, and measures a date and time at which the environment information acquirer 411 acquires the environment information, a date and time at which the device setting updater 419 stores the device setting information in the history information storage 434, and a date and time at present. Here, the environment information acquirer 411 associates the acquired environment information with the date and time measured by the time keeper 415 and stores the associated information in the history information storage 434. Additionally, the device setting updater 419 associates the device setting information acquired from the device setting storage 431 with the date and time measured by the time keeper 415, and stores the associated information in the history information storage 434.

The history information generator 416 generates history information that includes the environment history information including the plurality of temperature information stored in the history information storage 434, the user identification information of the user of the air conditioner 4 stored in the user information storage 432, and the operation history information including the plurality of device setting information stored in the history information storage 434, and history attribute information corresponding to the history information. In one example, the history information generator 416 generates history attribute information for which the file format is JSON schema, and generates attribute information for which the file format is JSON. The history information sender 417 sends the history information and the history attribute information generated by the history information generator 416 to the cloud server 2. The history information sender 417 performs reversible information compression processing on the history information and the history attribute information and then sends the processed information. When the operation mode setter 420 is notified of the operation mode information by the operation receiver 413, the operation mode setter 420 stores the notified operation mode information in the operation mode storage 433.

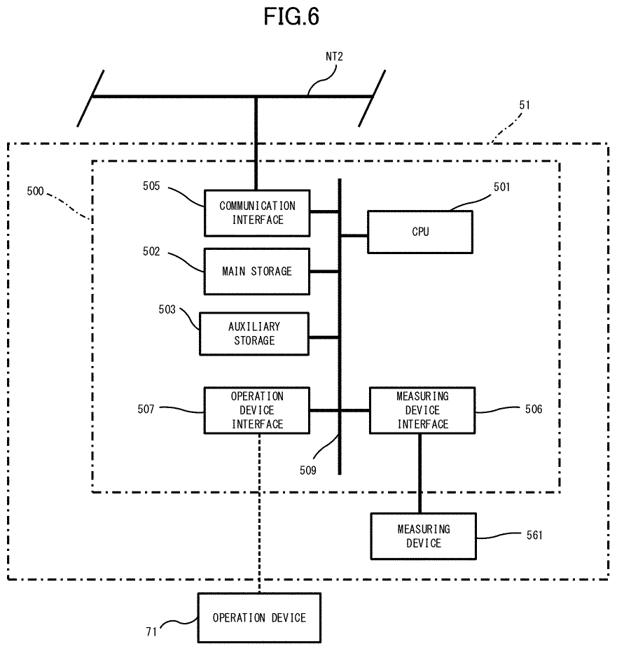

As illustrated in FIG. 6, the water heater 51 includes a controller 500 that controls the water heater 51, and a measuring device 561 that measures the temperature of the hot water. The controller 500 includes a CPU 501, a main storage 502, an auxiliary storage 503, a communication interface 505, a measuring device interface 506, an operation device interface 507, and a bus 509 that connects these components to each other. The CPU 501, the main storage 502, the auxiliary storage 503, the communication interface 505, and the measuring device interface 506 are the same as in the air conditioner 4. The operation device interface 507 is wiredly connected to the operation device 6, and when the operation device interface 507 receives, from the operation device 6, operation information expressing operation content performed by the user on the operation device 6, the operation device interface 507 notifies the CPU 501 of that operation information.

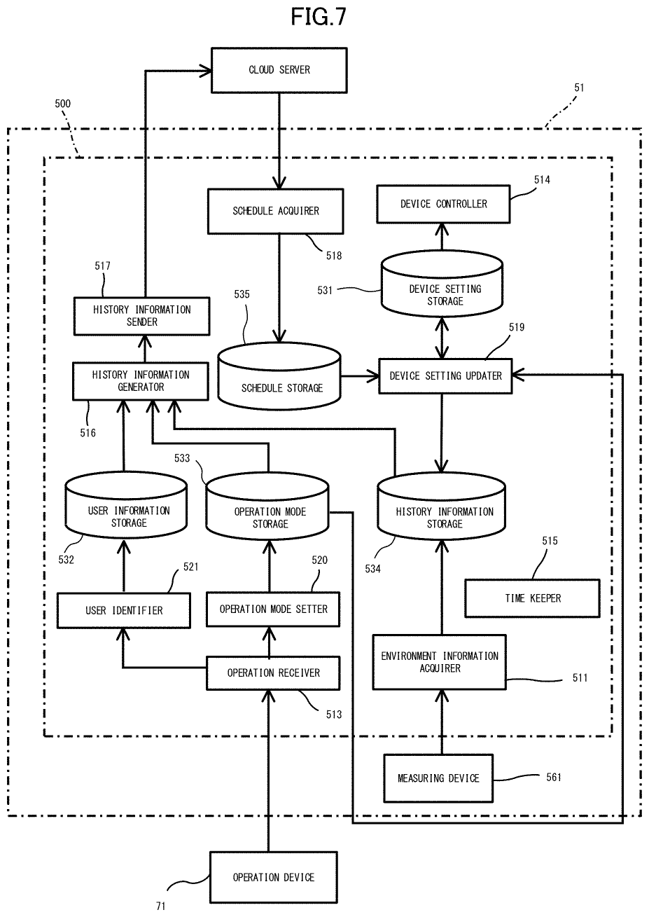

The CPU 501 reads out the program stored in the auxiliary storage 503 to the main storage 502 and executes the program to function as an environment information acquirer 511, an operation receiver 513, a device controller 514, a time keeper 515, a history information generator 516, a history information sender 517, a schedule acquirer 518, a device setting updater 519, an operation mode setter 520, and a user identifier 521, as illustrated in FIG. 7. As illustrated in FIG. 7, the auxiliary storage 503 illustrated in FIG. 6 includes a device setting storage 531 that stores device setting information expressing a device setting parameter of the water heater 51, and a user information storage 532 that stores user information about the user of the water heater 51, that is, the user of the bathroom. Furthermore, the auxiliary storage 503 includes a history information storage 534 that stores device history information and environment history information of the water heater 51, a schedule storage 535 that stores schedule information expressing an operation schedule of the water heater 51, and an operation mode storage 533 that stores operation mode information of the water heater 51.

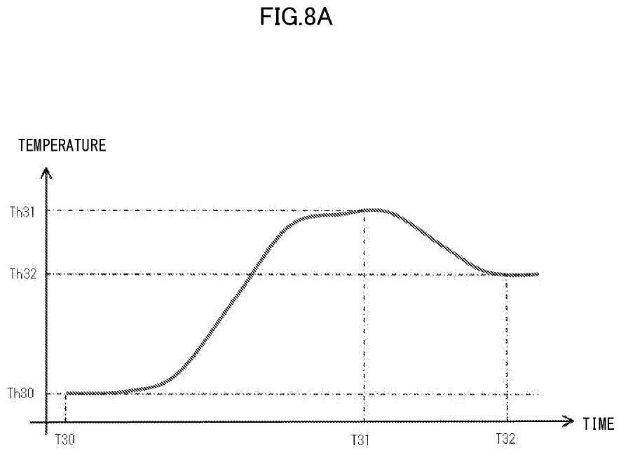

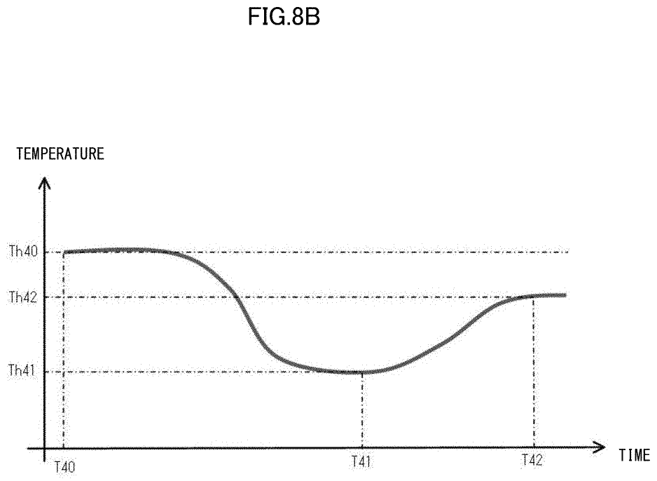

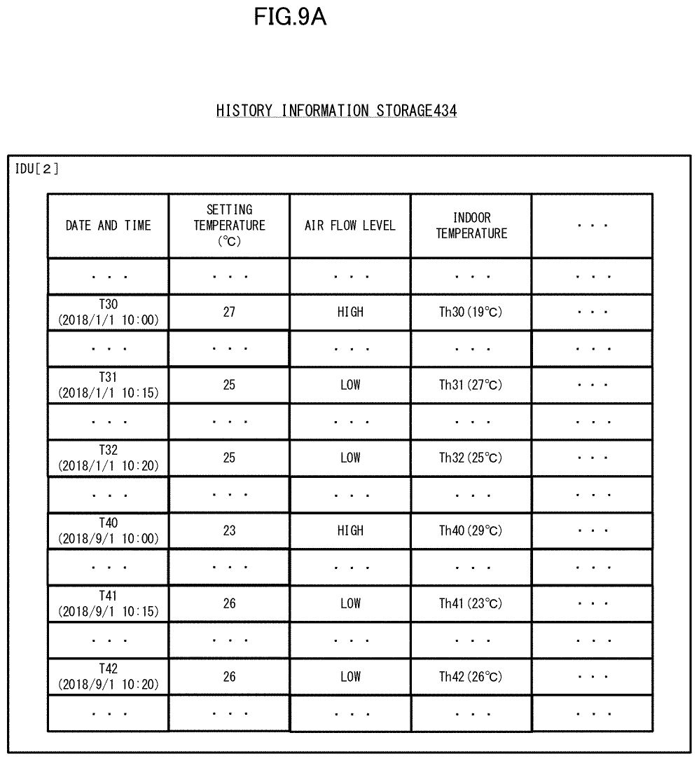

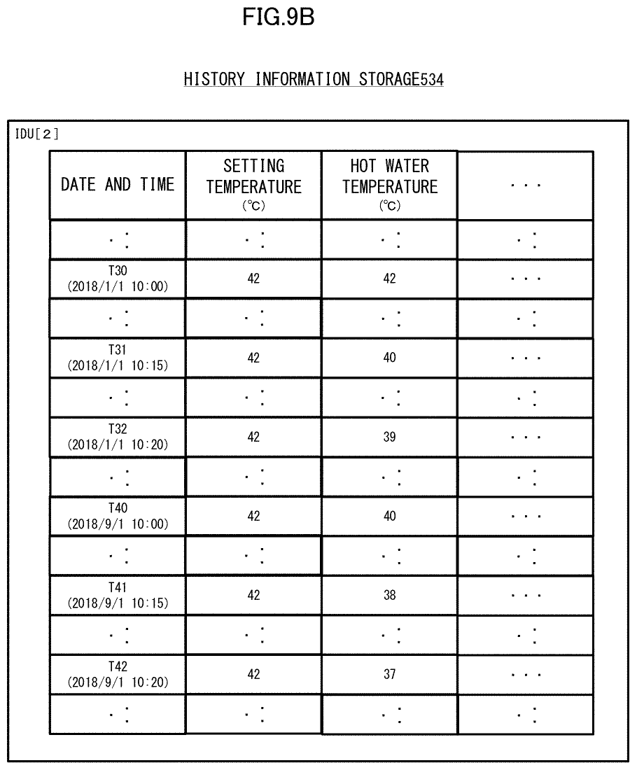

The history information storage 534 stores, for every user of the water heater 51, a history of the device setting information of the water heater 51 and a history of environment information expressing an environment parameter including temperature information. In one example, as illustrated in FIG. 8A, it is assumed that, at a bath time at a date and time T30 in winter (for example, Jan. 1, 2018 10:00), another user that resides at the house H sets the setting temperature to Th31 (for example, 27° C.), and the air flow level to “high” while the operation mode of the air conditioner 52 is in the manual operation mode to operate the air conditioner 52. At this time, the temperature of the bathroom in which the air conditioner 52 is installed is assumed to be Th30 (for example, 19° C.). Additionally, it is assumed that the bathtub of the bathroom is filled with hot water supplied from the water heater 51, and that the temperature of the hot water is 42° C. In this case, the bathroom is warmed by the air conditioner 52 and, at a date and time T31 (for example, Jan. 1, 2018 10:15), which is after the date and time T30, the temperature of the bathroom reaches the setting temperature Th31. It is assumed that, at this time, the hot water cools with the passage of time, and the temperature thereof has decreased to 40° C. Here, it is assumed that the user feels hot and, as such, sets the setting temperature of the air conditioner 52 to Th32 (for example, 25° C.), which is lower than Th31, and sets the air flow level to “low.” In this case, the bathroom is cooled by the air conditioner 52 and, at a date and time T32 (for example, Jan. 1, 2018 10:20), which is after the date and time T31, the temperature of the bathroom reaches the setting temperature Th32. It is assumed that, at this time, the hot water cools with the passage of time, and that the temperature thereof has decreased to 39° C. Meanwhile, as illustrated FIG. 8B, it is assumed that, at a bath time at a date and time T40 in autumn (for example, Sep. 1, 2018 10:00), another user that resides at the house H sets the setting temperature to Th41 (for example, 23° C.), and the air flow level to “high” while the operation mode of the air conditioner 52 is in the manual operation mode to operate the air conditioner 52. At this time, the temperature of the bathroom in which the air conditioner 52 is installed is assumed to be Th40 (for example, 29° C.). In this case, the bathroom is cooled by the air conditioner 52 and, at a date and time T41 (for example, Sep. 9, 2018 10:15), which is after the date and time T40, the temperature of the bathroom reaches the setting temperature Th41. Here, it is assumed that the body of the user is cooled and, as such, the user sets the setting temperature of the air conditioner 52 to Th42 (for example, 26° C.), which is higher than Th41, and sets the air flow level to “low.” In this case, the bathroom is warmed by the air conditioner 52 and, at a date and time T42 (for example, Sep. 1, 2018 10:20), which is after the date and time T41, the temperature of the bathroom reaches the setting temperature Th42. In this case, as illustrated in FIG. 9A, the history information storage 434 of the air conditioner 52 installed in the bathroom associates the operation history information expressing the history of the setting temperature and the air flow level of the air conditioner 52 and the environment history information expressing the history of the indoor temperature of the bathroom with the date and time information, and stores the associated information. Moreover, as illustrated in FIG. 9B, the history information storage 534 of the water heater 51 associates the operation history information expressing the history of the setting temperature of the water heater 51 and the environment history information expressing the history of the temperature of the hot water with the date and time information, and stores the associated information. Here, the history information storage 131 associates the operation history information and the environment history information of each of the air conditioner 52 and the water heater 51 with user identification information IDU [2], device identification information IDA [2] identifying the air conditioner 52, and device identification information IDA [3] identifying the water heater 51, and stores the associated information.

Returning to FIG. 7, the environment information acquirer 511 acquires, from the measuring device interface 506, the temperature information expressing the temperature of the hot water measured by the measuring device 561. In one example, the user identifier 521 identifies the user by acquiring, from the controller 400 of the air conditioner 52, the user identification information stored in the user information storage 432 of the controller 400. Moreover, the user identifier 521 stores, in the user information storage 532, the user identification information of the identified user of the bathroom.

The operation receiver 513 is the same as the operation receiver 413 described above. The device controller 514 controls the water heater 51 on the basis of the device setting information stored in the device setting storage 531. The schedule acquirer 518 acquires, from the cloud server 2, the schedule information expressing the operation schedule of the water heater 51, and stores the acquired schedule information in the schedule storage 535.

When the operation mode of the water heater 51 is set to the automatic mode, the device setting updater 519 generates the device setting information of the water heater 51 on the basis of the schedule information stored in the schedule storage 535 and the time at present measured by the time keeper 515. Moreover, the device setting updater 519 stores the generated device setting information in the device setting storage 531. The device setting updater 519 periodically stores the device setting information, stored in the device setting storage 531, chronologically in the history information storage 434. The time keeper 515 measures a date and time at which the environment information acquirer 511 acquires the environment information, a date and time at which the device setting updater 519 stores the device setting information in the history information storage 534, and the date and time at present. Here, the environment information acquirer 511 associates the acquired environment information with the date and time measured by the time keeper 515, and stores the associated information in the history information storage 534. Additionally, the device setting updater 519 associates the device setting information acquired from the device setting storage 531 with the date and time measured by the time keeper 515, and stores the associated information in the history information storage 534.

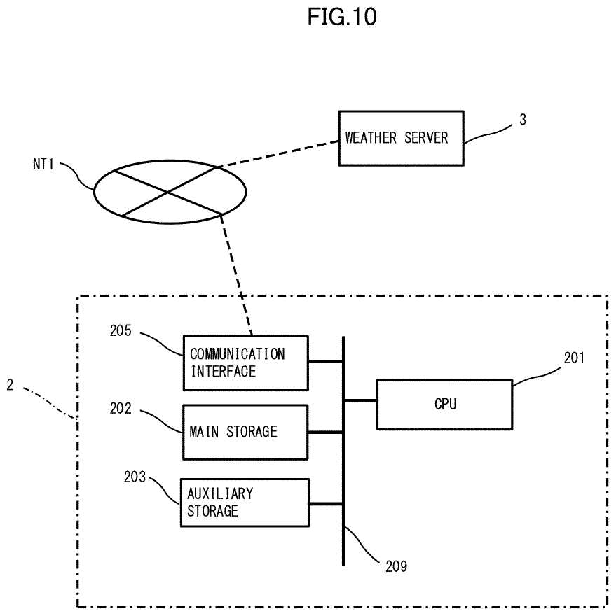

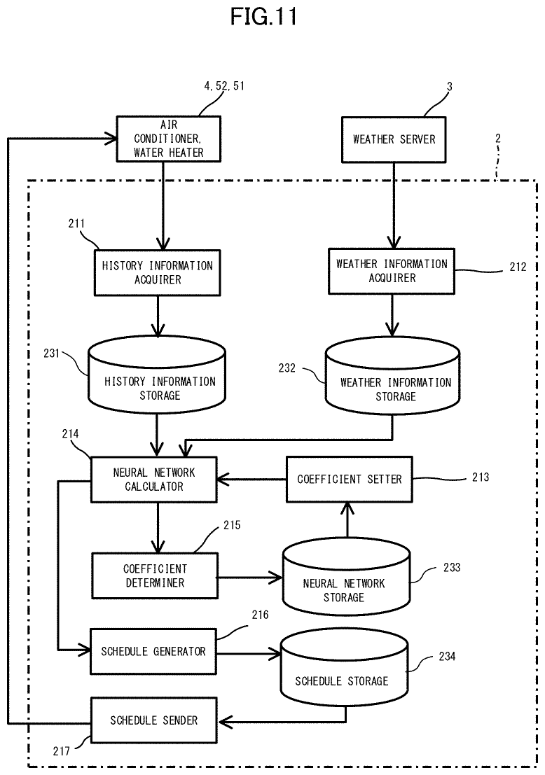

As illustrated in FIG. 10, the cloud server 2 includes a CPU 201, a main storage 202, an auxiliary storage 203, a communication interface 205, and a bus 209 that connects these components to each other. In one example, the CPU 201 is a multi-core processor. The main storage 202 is constituted from volatile memory, and is used as a working area of the CPU 201. The auxiliary storage 203 is configured from non-volatile memory that has large capacity, and stores a program for realizing the various functions of the cloud server 2. The communication interface 205 is connected to the external network NT1, and is capable of communicating with the weather server 3 via the external network NT1. The CPU 201 reads out the program stored in the auxiliary storage 203 to the main storage 202 and executes the program to function as a history information acquirer 211, a weather information acquirer 212, a coefficient setter 213, a neural network calculator 214, a coefficient determiner 215, a schedule generator 216, and a schedule sender 217, as illustrated in FIG. 11. Additionally, as illustrated in FIG. 11, the auxiliary storage 203 illustrated in FIG. 10 includes a history information storage 231 that stores the history information acquired from the air conditioner 4, a weather information storage 232 that stores the weather prediction information and the weather record information acquired from the weather server 3, a neural network storage 233, and a schedule storage 234 that stores the schedule information to be sent to the air conditioner 4.

The neural network storage 233 stores information expressing a hereinafter described structure of the neural network, and the weighting coefficient of the neural network. The information expressing the structure of the neural network includes information expressing a shape of an activation function at each node, number of layers information, information about the number of nodes in each layer, and the like. Additionally, the neural network storage 233 stores information expressing an initial coefficient that is an initial value of the weighting coefficient used when determining the weighting coefficient of the neural network from the operation history information, the environment history information, and the weather record information of the air conditioners 4, 52 and the water heater 51 described above.

The history information acquirer 211 acquires, from the air conditioners 4, 52 and the water heater 51, the history information including the operation history information, the environment history information, and the user information. The history information acquirer 211 executes information expansion processing on the history information, which has been subjected to the reversible information compression processing, acquired from the air conditioners 4, 52 and the water heater 51 and, then, acquires the operation history information, the environment history information, and the user information included in the history information. The history information acquirer 211 stores, in the history information storage 231, the operation history information, the environment history information, and the user information that are acquired. The weather information acquirer 212 acquires, from the weather server 3 and via the external network NT1, the weather information including the weather record information expressing the past weather condition and the weather prediction information expressing the future weather condition. Here, the weather information acquirer 212 acquires the weather information from the weather server 3 by sending weather information request information requesting, to the weather server 3, sending of the weather information.

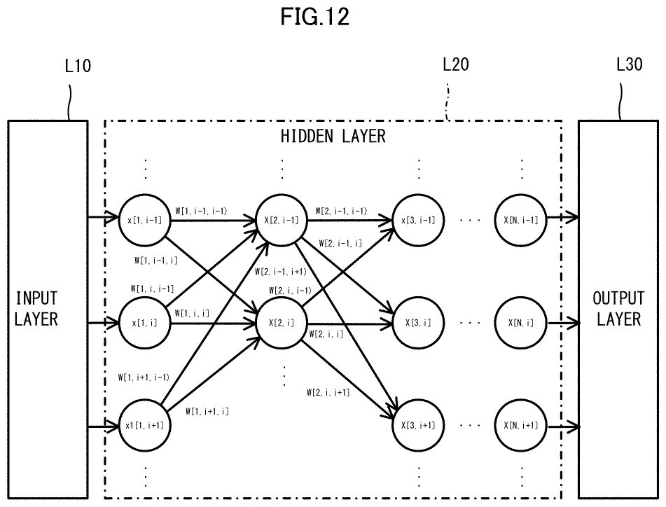

The neural network calculator 214 uses a neural network having a predetermined number of nodes and a predetermined number of layers to calculate, from the environment parameter such as the indoor temperature, the hot water temperature, or the like, a numerical value indicating the date and time, and information obtained by quantifying a weather condition, the device setting parameter, such as the setting temperature and the air flow level of the air conditioners 4, 52, the setting temperature of the water heater 51, and the like, for each time frame of a single day. In this case, the neural network is the first neural network for calculating the future device setting parameter of each of the air conditioners 4, 52 and the water heater 51. As illustrated in FIG. 12, this neural network includes an input layer L10, a hidden layer L20, and an output layer L30. The input layer L10 inputs, to the hidden layer L20, the environment parameter such as the indoor temperature, the hot water temperature, or the like, the numerical value indicating the date and time, and the information obtained by quantifying the weather condition. In this case, when, for example, there are four types of weather conditions, namely “sunny”, “cloudy”, “rain”, and “snow”, it is sufficient that a method for quantifying the weather conditions is used in which numerical values NUM1, NUM2, NUM3, and NUM4 corresponding to the respective weather conditions are set such that the relationship NUM1<NUM2<NUM3<NUM4 is satisfied. Specifically, it is sufficient that the numerical values corresponding to “sunny”, “cloudy”, “rain”, and “snow” are respectively set to “10”, “20”, “30”, and “40.”

The hidden layer L20 includes N layers (where N is a positive integer) that each include a predetermined number M[j] of nodes x[j, i] (where 1≤i≤M[j], and M[j] is a positive integer). Specifically, the hidden layer L20 has a structure in which various node rows are connected to each other. Here, an output y[j, i] of each nodes x[j, i] is expressed by the relational expression of Equation (1) below:

Equation (1)

y[j,k]=f(Σᵢ₌₁^{M[j-1]}W[j−1,i,k]×y[j−1,i]) (1)

Here, W[j, i, k] represents the weighting coefficient, and f(*) represents the activation function. The weighting coefficient W[j, i, k] corresponds to the first neural network coefficient that determines the structure of the neural network described above. A non-linear function such as a sigmoid function, a ramp function, a step function, a softmax function, or the like is used as the activation function. For example, when the activation function is a sigmoid function, the activation function is expressed by the relational expression of Equation (2) below:

$$Equation 2$$

$$y o = f ( y i ) = \frac{1}{1 + {e}^{- yi}} \qquad ( 2 )$$

Here, yi represents an argument, and yo represents an output value. When the activation function is a ramp function, the activation function is expressed by the relational expression of Equation (3) below:

Equation 3

yo=f(yi)=max(0,yi) (3)

Here, yi represents an argument, and yo represents an output value.

The information input to the nodes of the hidden layer L20 is the sum of products obtained by multiplying the output of each node of the previous layer by the weighting coefficient. The output of the activation function in which the sum is the argument is transmitted to the next layer. The output layer L30 outputs the output y[j, i] from the ultimate layer of the hidden layer L20 without modification.

The coefficient setter 213 sets the weighting coefficient described above. The neural network calculator 214 uses the neural network, in which the weighting coefficient is set by the coefficient setter 213, to calculate the future device setting parameters of the air conditioners 4, 52 and the water heater 51 from the weather prediction information and the environment parameter indicating the environment at present included in the environment history information. Here, the environment parameter expressing the environment at present is a parameter expressing the indoor temperature acquired from the air conditioners 4, 52 or the temperature of the hot water acquired from the water heater 51. In some cases, due to the measuring frequencies of the measuring devices 461 of the air conditioners 4, 52 and the measuring device 561 of the water heater 51 and an acquisition frequency of the environment parameter of the history information acquirer 211, the environment parameter expressing the current environment is a parameter expressing an environment a few seconds to a few minutes before the present time. Here, the neural network calculator 214 uses the neural network described above to calculate, from the environment parameter such as the indoor temperature at present, the hot water temperature at present, or the like expressed by the environment history information included in the history information, the numerical value indicating the date and time at present, and the information obtained by quantifying the future weather condition expressed by the weather prediction information, the device setting parameter of the air conditioners 4, 52 for each time frame of a single day.

The coefficient determiner 215 determines the weighting coefficient of the neural network on the basis of the operation history information and the environment history information included in the history information, and the weather record information. Firstly, the coefficient determiner 215 acquires the information expressing the initial coefficient from the neural network storage 233, and sets the acquired initial coefficient as the weighting coefficient of the neural network. Next, the coefficient determiner 215 acquires the device setting parameter that the neural network calculator 214 calculates using the neural network on the basis of the past environment parameter expressed by the environment history information, the date and time expressed by the date and time information, and information obtained by quantifying the past weather condition expressed by the weather record information. Next, the coefficient determiner 215 acquires the past device setting parameter expressed by the operation history information stored in the history information storage 231, and calculates an error from the device setting parameter calculated using the neural network. Then, the coefficient determiner 215 determines, on the basis of the calculated error, the weighting coefficient of the neural network by the backpropagation method. Here, the coefficient determiner 215 uses an autoencoder, for example, to determine the weighting coefficient.

The coefficient determiner 215 uses dropout information when determining the weighting coefficient of the neural network. The dropout information is defined for each node of the hidden layer L20 described above, and is information expressing whether the node is deactivated, that is, whether the output of the node x[j, i] is set to “0” when the coefficient determiner 215 determines the weighting coefficient of the neural network. Each node is activated with a predetermined probability P, and is deactivated with a probability (1-P). The probability P is set for every node, and takes a value that is in a range of greater than 0 and less than or equal to 1. When the probability P is set to “1”, the corresponding node is always activated. For example, when rY is a variable that takes “1” with the probability P and takes “0” with the probability (1-P), the output y[j, i] of each node x[j, i] is expressed by the relational expressions of Equations (4) and (5) below:

Equation 4

y[j,k]=f(Σᵢ₌₁^{M[j-1]}W[j−1,i,k]×y[j−1,i])×rY (4)

Equation 5

rY˜Bernoulli(P) (5)

Here, Bernoulli(*) represents a function that takes “1” with probability according to the Bernoulli distribution.

The schedule generator 216 generates, on the basis of the device setting parameter calculated by the neural network calculator 214, schedule information expressing the future operation schedule of each of the air conditioners 4, 52 and the water heater 51. The schedule sender 217 sends the generated schedule information to the air conditioners 4, 52 and the water heater 51.

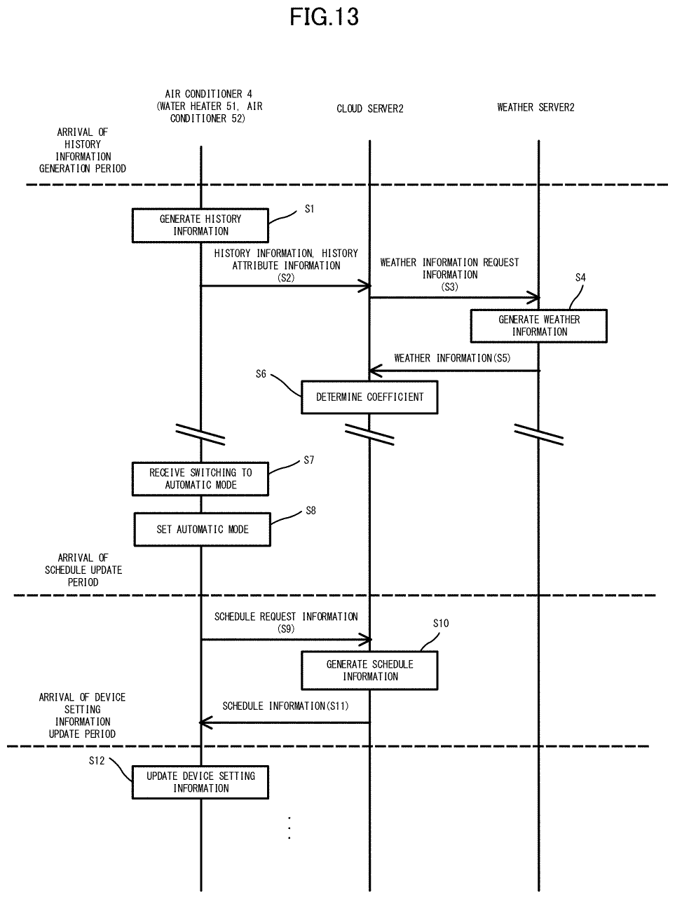

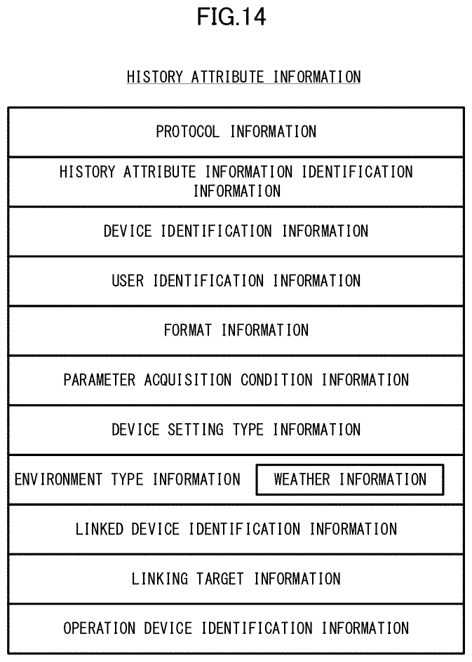

Next, the operations of the control system according to the present embodiment are described while referencing FIGS. 13 and 14. Firstly, when a history information generation period arrives, the air conditioners 4, 52 and the water heater 51 generate the history information and the history attribute information using the operation history information, the environment history information, the date and time information, and the user information stored in the history information storages 434, 534 (step S1).

The history information includes protocol information, history information identification information that identifies the generated history information, the operation history information, and the environment history information. The protocol information includes a variety of information related to a communication protocol used when sending the history information to the cloud server 2. As illustrated in FIG. 14, for example, the history attribute information includes the protocol information and a variety of attribute information. Examples of the attribute information include history attribute information identification information that identifies the generated history attribute information, device identification information that identifies the air conditioner 4, 52 or the water heater 51, the user identification information described above, format information, parameter acquisition condition information, device setting type information, environment type information, linked device identification information, linking target information, and operation device identification information. In one example, the history information identification information includes at least one of identification information imparted to the attribute information, identification information imparted to the history information, and identification information of the air conditioner 4, 52 or the water heater 51. The format information includes information expressing a data format or a file format and information expressing a compression format of each of the attribute information and the history information. In one example, the format information includes information expressing that the file format of the attribute information is JSON schema and information expressing that the file format of the history information is JSON. Additionally, the format information includes information expressing a number of history information files, and a file size of each of the history information files. For example, a configuration is possible in which, when flag information included in the format information is “0”, the number of history information files is expressed, when “1”, the file size of the first history information is expressed, when “2” the file size of the second history information is expressed, when “N”, the file size of the Nth history information is expressed, and when “N+1”, the compression format of the history information is expressed.

The parameter acquisition condition information includes information expressing acquisition conditions of a variety of parameters such as a period in which the operation history information or the environment history information is acquired, and a time interval for acquiring the device setting parameter and the environment parameter. Additionally, the parameter acquisition condition information may include information expressing a presence/absence of change history of the acquisition conditions of the variety of parameters and, when the acquisition conditions of the variety of parameter have been changed, a change date and time. Here, for example, a configuration is possible in which, when flag information included in the parameter acquisition condition information is “0”, an acquisition date and time of the parameter is expressed, when “1”, an acquisition start date and time of the parameter is expressed, when “2”, an acquisition end date and time of the parameter is expressed, and when “3”, an acquisition interval of the parameter is expressed. The device setting type information is information that supplements the content of the operation history information, and includes information expressing the type of the device setting parameter such as ON/OFF, the setting temperature, the setting air flow, a setting air direction, and the like of each of the air conditioners 4, 52 and the water heater 51. Here, for example, a configuration is possible in which, when flag information included in the device setting type information is “0”, the ON/OFF of each of the air conditioners 4, 52 and the water heater 51 is expressed, when “1”, the setting temperature is expressed, when “2”, the setting air flow is expressed, and when “3”, the setting air direction is expressed. The operation device identification information includes information expressing whether the operation device 6, 71, 72 that set the device setting parameter is a remote controller, a TV, or a mobile terminal such as a smartphone in the house H, or a remote control terminal connected via the cloud server 2. For example, a configuration is possible in which the operation device identification information is set to “0” when the operation device is the remote controller, to “1” when the mobile terminal, and to “2” when the remote control terminal.

The environment type information is information that supplements the content of the environment history information, and includes information expressing the type of the environment parameter such as a room temperature, an air temperature outside the house H, whether a person is detected in the house H, the temperature of the surface of the person residing in the house H, a detection state by a smell sensor, a CO2 concentration, a concentration of microparticles (for example, PM 2.5) in the air, and the like. Here, for example, a configuration is possible in which, when flag information included in the environment type information is “0”, the room temperature is expressed, when “1”, humidity is expressed, when “2”, the outside air temperature is expressed, and when “3”, whether a person is detected is expressed. Additionally, the environment type information includes the weather information. In one example, the linked device identification information includes identification information of a device that operates linked with the air conditioner 4, 52 or the water heater 51. In one example, the linking target information includes identification information of an operation state of a device that is to be linked with the air conditioner 4, 52 or the water heater 51. In one example, the linked device identification information includes identification information of a ventilation fan that is linked with the water heater 51. In such a case, in one example, the linking target information includes information expressing that an operation of the ventilation fan linked with the water heater 51 is an ON/OFF operation.

Returning to FIG. 13, thereafter, the generated history information is sent from the air conditioners 4, 52 and the water heater 51 to the cloud server 2 (step S2). When the cloud server 2 receives the history information, the cloud server 2 stores, in the history information storage 231, the operation history information, the environment history information, the date and time information, and the user information included in the history information. Next, weather information request information requesting, to the weather server 3, sending of the weather information including the weather prediction information and the weather record information is sent from the cloud server 2 to the weather server 3 (step S3). Meanwhile, when the weather server 3 receives the weather information request information, the weather server 3 identifies the weather prediction information and the weather record information of the region in which the house H exists, and generates weather information including the weather prediction information and the weather record information that are identified (step S4). Next, the generated weather information is sent from the weather server 3 to the cloud server 2 (step S5). Meanwhile, when the cloud server 2 receives the weather information, the cloud server 2 stores, in the weather information storage 232, the weather record information and the weather prediction information included in the received weather information. Then, the cloud server 2 determines the weighting coefficient of the neural network on the basis of the operation history information, the environment history information, the date and time information, the user information, and the weather record information that are acquired (step S6).

Next, it is assumed that the air conditioner 4, 52 or the water heater 51 receives a switching operation performed by the user for switching to the automatic mode (step S7). In this case, the operation mode is set to the automatic mode by the air conditioner 4, 52 or the water heater 51 storing, in the operation mode storage 433, 533, operation mode information expressing that the operation mode is the automatic mode (step S8). Next, when the air conditioner 4, 52 or the water heater 51 determines that a predetermined update period of the operation schedule of the air conditioner 4, 52 or the water heater 51 has arrived, schedule request information requesting, to the cloud server 2, sending of the schedule information is sent from the air conditioner 4, 52 or the water heater 51 to the cloud server 2 (step S9). Meanwhile, when the cloud server 2 receives the schedule request information, the cloud server 2 uses the neural network described above to calculate, from the environment parameter at present, the numerical value indicating the date and time, and the information obtained by quantifying the weather condition, a device setting parameter indicating the setting temperature and the air flow level of the air conditioners 4, 52, the setting temperature and the like of the water heater 51, in each time frame of a single day. Then, the cloud server 2 uses the calculated device setting parameter to generate the schedule information (step S10). Next, the generated schedule information is sent from the cloud server 2 to the air conditioner 4, 52 or the water heater 51 (step S11). Meanwhile, when the air conditioner 4, 52 or the water heater 51 receives the schedule information, the air conditioner 4, 52 or the water heater 51 stores the received schedule information in the schedule storage 435, 535. Thereafter, it is assumed that the air conditioner 4, 52 or the water heater 51 references the schedule information stored in the schedule storage 435, 535 to determine that the update period of the device setting information has arrived. In such a case, the air conditioner 4, 52 or the water heater 51 updates, on the basis of the schedule information, the device setting information stored in the device setting storage 431, 531 (step S12). Thereafter, the processing of the aforementioned step S12 is repeatedly executed every time the update period of the device setting information arrives.

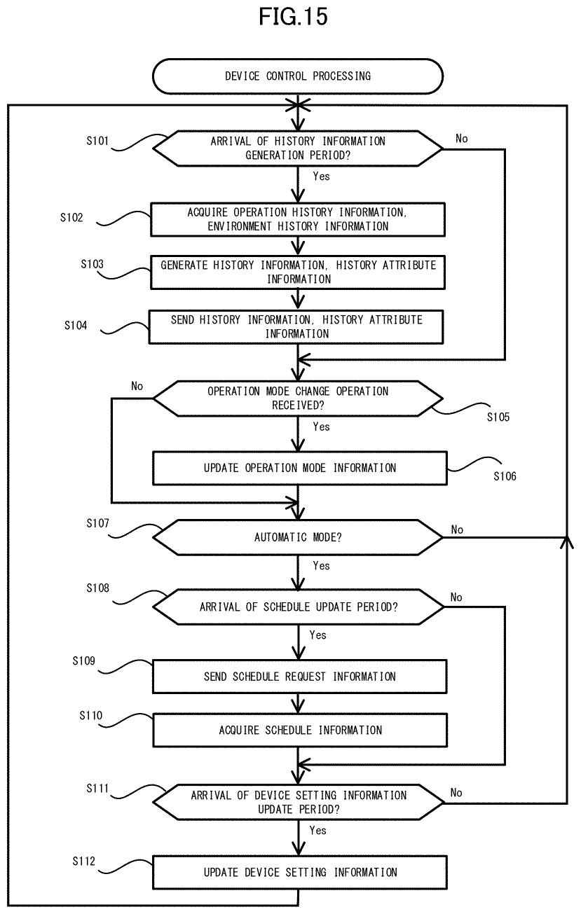

Next, device control processing executed by the air conditioner 4, 52 according to the present embodiment is described while referencing FIG. 15. In one example, this device control processing starts when the power to the air conditioner 4, 52 is turned ON. Note that device control processing that is the same as the device control processing described in the following is executed for the water heater 51 as well. In the following, device control processing for the air conditioner 4, 52 is described.

Firstly, the history information generator 416 determines whether the history information generation period for generating history information to be sent to the cloud server 2 has arrived (step S101). When the history information generator 416 determines that the history information generation period has not arrived (step S101; No), the processing of hereinafter described step S105 is executed with no modification.

However, it is assumed that the history information generator 416 determines that the history information generation period has arrived (step S101; Yes). In this case, the history information generator 416 acquires the operation history information and the environment history information from the history information storage 434 (step S102). Next, the history information generator 416 uses the operation history information and the environment history information that are acquired, the date and time information, and the user information stored in the user information storage 432 to generate history information that includes these pieces of information (step S103). Next, the history information sender 417 sends the generated history information to the cloud server 2 (step S104).

Thereafter, the operation receiver 413 determines whether a change operation of the operation mode of the air conditioner 4 is received (step S105). Specifically, the operation receiver 413 determines whether operation information related to a change of the operation mode of the air conditioner 4 is received. When the operation receiver 413 determines that the change operation of the operation mode of the air conditioner 4 is not received (step S105; No), the processing of hereinafter described step S108 is executed without modification. However, when the operation receiver 413 determines that operation information related to a change of the operation mode of the air conditioner 4 is received (step S105; Yes), the operation mode setter 420 updates the operation mode information stored in the operation mode storage 433 (step S106). Next, the schedule acquirer 418, 518 references the operation mode information stored in the operation mode storage 433 to determine whether the operation mode of the air conditioner 4, 52 or the water heater 51 is the automatic mode (step S107). When the schedule acquirer 418 determines that the operation mode of the air conditioner 4, 52 or the water heater 51 is the manual mode (step S107; No), the processing of step S101 is executed again. However, when the schedule acquirer 418 determines that the operation mode of the air conditioner 4, 52 or the water heater 51 is the automatic mode (step S107; Yes), the schedule acquirer 418 determines whether a schedule update period has arrived (step S108). When the schedule acquirer 418 determines that the schedule update period has not arrived (step S108; No), the processing of hereinafter described step S112 is executed without modification. However, it is assumed that the schedule acquirer 418 determines that the schedule update period has arrived (step S108; Yes). In this case, the schedule acquirer 418 sends the schedule request information described above to the cloud server 2 (step S109) to acquire the schedule information from the cloud server 2 (step S110). The schedule acquirer 418 stores the acquired schedule information in the schedule storage 435. Then, a device setting information generator 116 references the schedule information stored in the schedule storage 435 to determine whether an update period of the device setting information of the air conditioner 4, 52 or the water heater 51 has arrived (step S111). When the device setting information generator 116 determines that the update period of the device setting information of the air conditioner 4, 52 or the water heater 51 has not arrived (step S111; No), the processing of step S101 is executed again. However, when the device setting information generator 116 determines that the update period of the device setting information of the air conditioner 4, 52 or the water heater 51 has arrived (step S111; Yes), the device setting information generator 116 updates the device setting information on the basis of the schedule information stored in the schedule storage 435 (step S113). Then, the processing of step S101 is executed again.

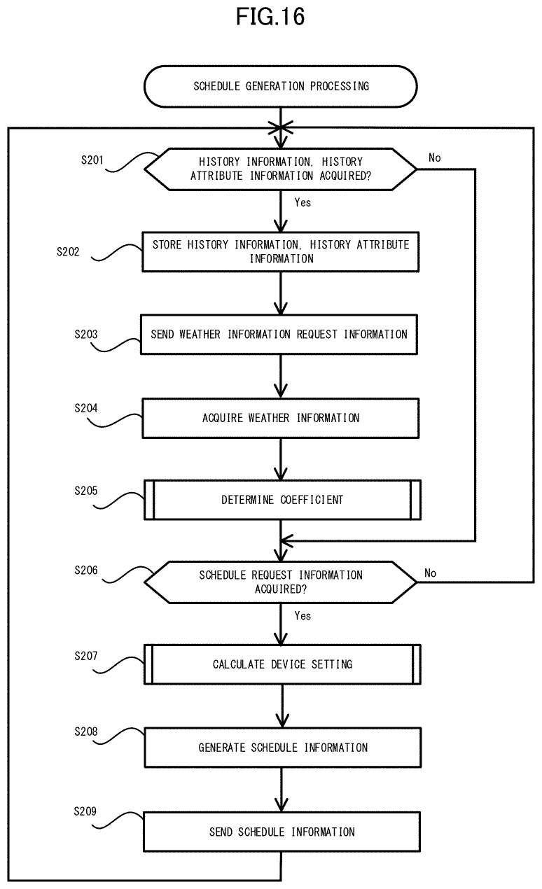

Next, schedule generation processing executed by the cloud server 2 according to the present embodiment is described while referencing FIGS. 16 to 18. In one example, this schedule generation processing starts when the power to the cloud server 2 is turned ON.

Firstly, as illustrated in FIG. 16, the history information acquirer 211 determines whether the history information is acquired from the air conditioner 4, 52 or the water heater 51 (step S201). When the history information acquirer 211 determines that the history information is not acquired (step S201; No), the processing of hereinafter described step S206 is executed without modification. However, when the history information acquirer 211 determines that the history information is acquired (step S201; Yes), the history information acquirer 211 stores the acquired history information in the history information storage 231 (step S202). Next, the weather information acquirer 212 sends weather information request information requesting, to the weather server 3, sending of the weather information (step S203) to acquire the weather information from the weather server 3 (step S204). Here, the weather information acquirer 212 stores, in the weather information storage 232, the weather prediction information and the weather record information included in the acquired weather information. Next, coefficient determination processing for determining, on the basis of the operation history information and the environment history information included in the history information and the weather record information, the coefficient of the neural network described above is executed (step S205).

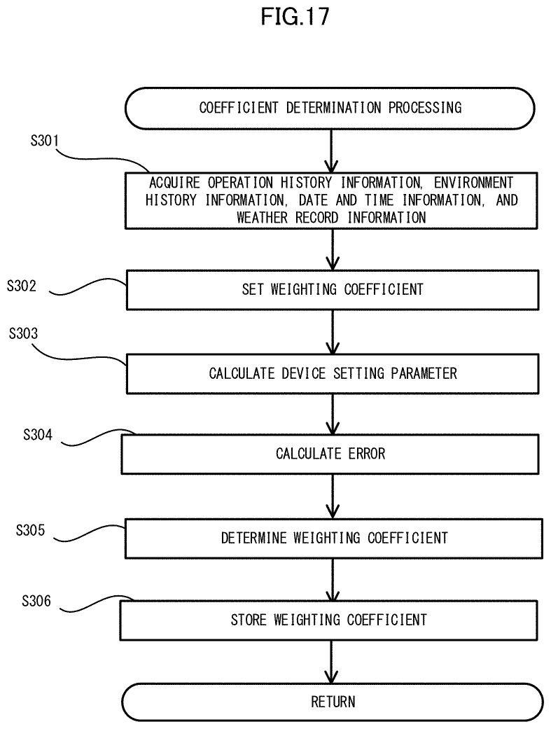

Here, details of the coefficient determination processing are described in detail while referencing FIG. 17. Firstly, the neural network calculator 214 acquires the operation history information, the environment history information, and the date and time information from the history information storage 231, and acquires the weather record information from the weather information storage 232 (step S301). The operation history information, the environment history information, and the date and time information correspond to teacher information for training the neural network. Next, the coefficient setter 213 acquires, from the neural network storage 233, information expressing an initial weighting coefficient that is an initial value of the weighting coefficient, and sets the weighting coefficient of the neural network to the initial weighting coefficient (step S302). Next, the neural network calculator 214 uses the neural network in which the initial weighting coefficient is set to calculate, from the environment parameter included in the acquired environment history information, the date and time expressed by the date and time information, and the information obtained by quantifying the weather condition expressed by the weather record information, the device setting parameter at each of a plurality of time frames on a predetermined day (step S303). Then, for each of the plurality of time frames, the coefficient determiner 215 calculates the error between the calculated device setting parameter and the device setting parameter included in the operation history information (step S304). Next, the coefficient determiner 215 determines, on the basis of the calculated error, each weighting coefficient by the backpropagation method (step S305). Then, the coefficient determiner 215 stores the determined weighting coefficients in the neural network storage 233 (step S306).

Returning to FIG. 16, next, the schedule generator 216 determines whether the schedule request information is acquired from the air conditioner 4, 52 or the water heater 51 (step S206). When the schedule generator 216 determines that the schedule request information is not acquired (step S206; No), the processing of step S201 is executed again. However, when the schedule generator 216 determines that the schedule request information is acquired (step S206; Yes), device setting calculation processing is executed (step S207).

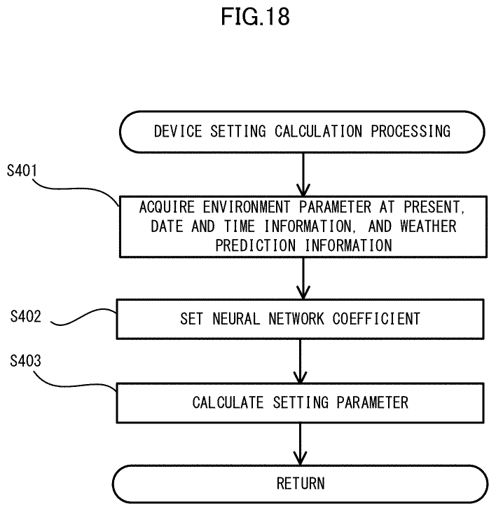

Here, details of the device setting calculation processing are described in detail while referencing FIG. 18. Firstly, the neural network calculator 214 acquires, from the history information storage 231, the environment parameter at present and the date and time respectively included in the environment history information and the date and time information, and acquires the weather prediction information from the weather information storage 232 (step S401). Next, the coefficient setter 213 acquires, from the neural network storage 233, the weighting coefficient determined in the coefficient determination processing, and sets the weighting coefficient of the neural network to the acquired weighting coefficient (step S402). Then, the neural network calculator 214 uses the neural network in which the weighting coefficient is set to calculate the future device setting parameter from the environment parameter at present, the date and time expressed by the date and time information, and the information obtained by quantifying the weather condition expressed by the weather prediction information that are acquired (step S403).

Returning to FIG. 16, thereafter, the schedule generator 216 uses the calculated device setting parameter to generate the schedule information (step S208). Here, the schedule generator 216 stores the generated schedule information in the schedule storage 234. Next, the schedule sender 217 sends the schedule information stored in the schedule storage 234 to the air conditioner 4, 52 or the water heater 51 (step S209). Then, the processing of step S201 is executed again.

As described above, with the control system according to the present embodiment, in the cloud server 2, the neural network calculator 214 uses the neural network, for which the weighting coefficient is determined by the coefficient determiner 215, to calculate the future device setting parameters of the air conditioners 4, 52 and the water heater 51 from the weather prediction information and the environment parameter at present included in the environment history information. Additionally, the schedule generator 216 generates, on the basis of the device setting parameters calculated by the neural network calculator 214, the future operation schedules of the air conditioners 4, 52 and the water heater 51. Meanwhile, the device setting updater 419, 519 of the air conditioner 4, 52 or the water heater 51 updates the device setting information stored in the device setting storage 431, 531 in accordance with the operation schedule expressed by the schedule information, and the device controller 414, 514 controls the air conditioner 4, 52 or the water heater 51 on the basis of the device setting parameter expressed by the device setting information stored in the device setting storage 431, 531. As a result, the air conditioner 4, 52 or the water heater 51 can be controlled as a result of the air conditioner 4, 52 or the water heater 51 merely sending the history information to the cloud server 2 and acquiring the schedule information from the cloud server 2 every period corresponding to the operation schedule expressed by the schedule information. Therefore, the frequency at which the history information and the schedule information are exchanged between the air conditioner 4, 52 or the water heater 51 and the cloud server 2 is reduced, which leads to the benefit of a reduction of the effects, on the operations of the air conditioner 4, 52 or the water heater 51, of the communication traffic on the external network NT1.

With the control system according to the present embodiment, the air conditioner 4, 52 or the water heater 51 sends the history information related to the air conditioner 4, 52 or the water heater 51 to the cloud server 2 as teacher information, and the cloud server 2 generates the schedule information on the basis of the device setting parameter calculated by the neural network calculator 214. As a result, the air conditioner 4 can be operated on an operation schedule suited to the physical features or lifestyle of the user, without being provided with a neuro engine.

Furthermore, with the control system according to the present embodiment, the air conditioner 4, 52 or the water heater 51 acquires, from the air conditioner 4, 52 or the water heater 51, the user information and sends the acquired user information to the cloud server 2. As a result, the cloud server 2 determines the weighting coefficient of the neural network in consideration of the content of the user information and, as such, when, for example, the user of the air conditioner 4, 52 or the water heater 51 changes (for example, when the user changes from a father, a mother, a son, or a daughter to a grandmother), an environment suited to that user can be provided.

### Embodiment 2

With a control system according to the present embodiment, a server uses a second neural network to calculate a preference feature amount from operation history information expressing a history of a device setting parameter of a device, environment history information of a location at which the device is installed, and weather record information expressing a past weather condition. Here, the second neural network has a predetermined number of nodes and a predetermined number of layers and is for calculating a preference feature amount indicating a feature amount of a preference of a user. Additionally, the preference feature amount is information obtained by quantifying the feature amount of the preference of the user of the device. The server includes a history information acquirer that acquires history information including operation history information expressing a history of the device setting parameter of the device, environment history information expressing a history of an environment in which the device operates, and user information expressing the user of the device; and a weather information acquirer that acquires, from a weather server, weather information including weather record information expressing a past weather condition. Additionally, the server includes a coefficient determiner that determines a weighting coefficient of the second neural network on the basis of the weather record information and the history information, and a neural network calculator that uses the second neural network, for which the weighting coefficient is determined by the coefficient determiner, to calculate the preference feature amount from the history information and the weather record information. Moreover, the device includes a schedule storage that associates a plurality of types of schedule information expressing an operation schedule of the device with the preference feature amount information, and stores the associated information, a schedule identifier that identifies schedule information corresponding to the preference feature amount calculated by the neural network calculator, and a device controller that controls the device in accordance with the operation schedule expressed by the schedule information identified by the schedule identifier.

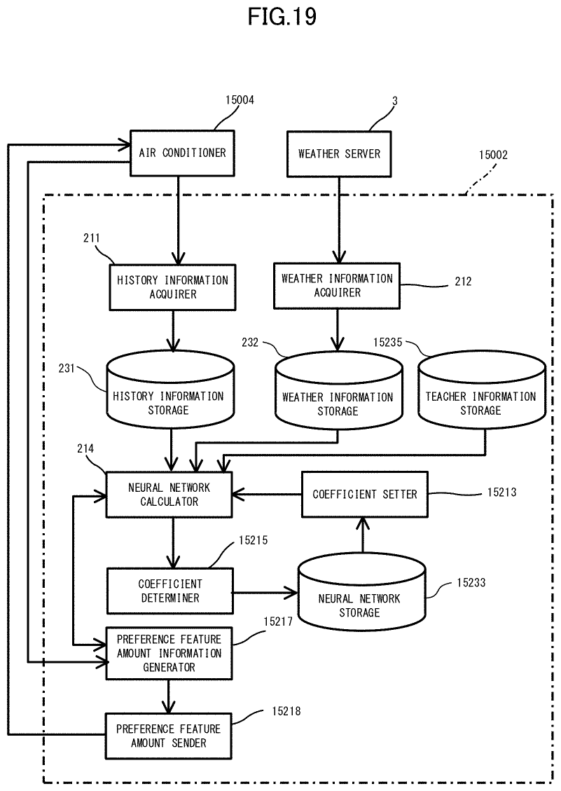

As with the control system described using FIG. 1 in Embodiment 1, the control system according to the present embodiment includes an air conditioner and a water heater installed in a house H, and a cloud server illustrated in FIG. 19 that is capable of communicating with the air conditioner and the water heater via an external network NT1. Note that, in the present embodiment, constituents that are the same as in Embodiment 1 are denoted with the same reference numerals used in Embodiment 1. Additionally, only the air conditioner is described in the present embodiment. The water heater executes the same processing as the air conditioner. Additionally, it is assumed that an internal network NT2 is laid and a router and a data line terminal device that are connected to the internal network NT2 are installed in the house H.

As described using FIG. 2, an air conditioner 15004 according to the present embodiment can identify the user by using an image captured by an imaging device 481. With the control system according to the present embodiment, in the air conditioner 15004, user feature amount information expressing a physical feature of the user is generated from the image obtained by using the imaging device 481 to image the user. Then, the generated user feature amount information is sent from the air conditioner 15004 to a cloud server 15002. Meanwhile, the cloud server 15002 determines the weighting coefficient of the neural network on the basis of the operation history information, the environment history information, and the preference feature amount stored in a teacher information storage 15235. Here, the cloud server 15002 uses the neural network to determine which category of a plurality of types of physical features to classify the user into. Examples of the plurality of types of physical features include “sensitive to heat (a person that, as an individual physical feature, is relatively sensitive to heat)” and “sensitive to cold (a person that, as an individual physical feature, is relatively sensitive to cold).” Then, the cloud server 15002 sends the preference feature amount information corresponding to the determined category to the air conditioner 15004. As a result, the air conditioner 15004 operates in accordance with the operation schedule expressed by the schedule information corresponding to the category of “sensitive to heat”, for example. In the present embodiment, a configuration is possible in which the air conditioner 15004 is not provided with a function for performing the calculations of the neural network.

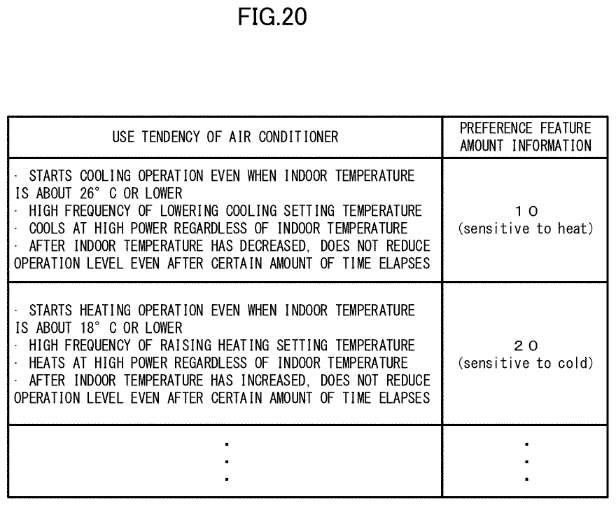

The hardware configuration of the cloud server 15002 according to the present embodiment is the same as the hardware configuration of the cloud server 2 described using FIG. 10 in Embodiment 1. With the cloud server 15002, the CPU 201 reads out the program stored in the auxiliary storage 203 to the main storage 202 and executes the program to function as a history information acquirer 211, a weather information acquirer 212, a coefficient setter 15213, a neural network calculator 214, a coefficient determiner 15215, a preference feature amount information generator 15217, and a preference feature amount sender 15218, as illustrated in FIG. 19. Additionally, as illustrated in FIG. 19, the auxiliary storage 203 illustrated in FIG. 10 includes a history information storage 231 that stores the history information and history attribute information acquired from the air conditioner 15004, a weather information storage 232 that stores the weather record information acquired from the weather server 3, a neural network storage 15233, and the teacher information storage 15235. Note that, in FIG. 19, the constituents that are the same as in Embodiment 1 are denoted with the same reference numerals as used in FIG. 11. The teacher information storage 15235 stores teacher information that is used by the coefficient determiner 15215 to determine the neural network coefficient. The teacher information is information obtained by combining environment information expressing a history of an indoor environment parameter of the house H, operation history information expressing a history of a setting parameter of the air conditioner 15004 installed in the house H, and the preference feature amount indicating the feature amount of the preference of the user of the air conditioner 15004. Here, the preference feature amount is obtained by categorizing the feature of the preference of the user when using the air conditioner 15004. Regarding the preference feature amount, as illustrated in FIG. 20, in the case of, for example, tendencies of starting cooling operation even when the indoor temperature is about 26° C. or lower, lowering a cooling setting temperature with high frequency, cooling at high power regardless of the indoor temperature, and, after the indoor temperature has decreased due to the cooling operation, not reducing the operation level even after a certain amount of time elapses, it is predictable that the user is sensitive to heat, and the preference feature amount for the combination of the environment history information and the operation history information expressed by these tendencies is characterized as “sensitive to heat”, expressed by “10.” Additionally, in the case of, for example, tendencies of starting heating operation even when the indoor temperature is about 18° C. or higher, raising a heating setting temperature with high frequency, heating at high power regardless of the indoor temperature, and, after the indoor temperature has risen due to the heating operation, not reducing the operation level even after a certain amount of time elapses, it is predictable that the user is sensitive to cold, and the preference feature amount for the combination of the environment history information and the operation history information expressed by these tendencies is characterized as “sensitive to cold”, expressed by “20.”

The teacher information stored in the teacher information storage 15235 may be automatically created by a program executed by the cloud server 15002 or another information processing device (not illustrated in the drawings) other than the cloud server 15002. Alternatively, an administrator that administrates the cloud server 15002 may create the teacher information by artificially defining the preference feature from the environment history information and the operation history information that is collected from the air conditioner 15004 at any time. Additionally, when estimating the preference feature amount, the weather record information may be used in addition to the operation history information and the environment history information. A configuration is possible in which, on a hot or very hot summer day, for example, when the cooling operation is started or the cooling setting temperature is lowered regardless of the indoor environment, the user of the air conditioner 15004 is estimated to be “sensitive to heat”, and the preference feature amount for the combination of the environment history information and the operation history information corresponding to these operations is characterized as “sensitive to heat”, expressed by “10.”

The neural network storage 15233 stores information expressing a hereinafter discussed structure of the neural network, and the weighting coefficient of the neural network. The information expressing the structure of the neural network includes information expressing a shape of an activation function at each node, number of layers information, information about the number of nodes in each layer, and the like. Additionally, the neural network storage 233 stores information expressing an initial coefficient that is an initial value of the weighting coefficient used when determining the weighting coefficient of the neural network from the operation history information, the environment history information, and the weather record information of the air conditioners 4, 52 and the water heater 51 described above.

The neural network calculator 214 uses a neural network having a predetermined number of nodes and a predetermined number of layers to calculate the preference feature amount indicating the feature of the preference of the user from the operation history information, the environment history information, and the weather record information. Here, the neural network is the second neural network for calculating the preference feature amount indicating the feature of the preference of the user.

The coefficient setter 15213 sets the weighting coefficient of the neural network. Then, the neural network calculator 214 uses the neural network, in which the weighting coefficient is set by the coefficient setter 15213, to calculate the preference feature amount indicating the feature of the preference of the user of the air conditioners 4, 52 and the water heater 51 from the weather record information, the operation history information, and the environment history information. The neural network calculator 214 uses the neural network to calculate the preference feature amount from the operation history information, the environment history information, and information obtained by quantifying a past weather condition expressed by the weather record information.

The coefficient determiner 15215 determines the weighting coefficient of the neural network on the basis of the preference feature amount information, the operation history information, the environment history information, and the weather record information. Firstly, the coefficient determiner 15215 acquires, from the neural network storage 15233, the information expressing the initial coefficient, and sets the acquired initial coefficient as the weighting coefficient of the neural network. Next, the coefficient determiner 15215 acquires the preference feature amount that the neural network calculator 214 uses the neural network to calculate on the basis of the operation history information, the environment history information, and the information obtained by quantifying the past weather condition expressed by the weather record information that are stored in the teacher information storage 15235. Then, the coefficient determiner 15215 acquires, from the teacher information storage 15235, the preference feature amount information corresponding to the combination of the operation history information and the environment history information, and calculates an error with the preference feature amount calculated using the neural network. Then, the coefficient determiner 15215 determines, on the basis of the calculated error, the weighting coefficient of the neural network by the backpropagation method.

When the preference feature amount information generator 15217 receives preference feature amount request information from the air conditioner 15004, the preference feature amount information generator 15217 causes the neural network calculator 214 to calculate the preference feature amount. Then, the preference feature amount information generator 15217 generates preference feature amount information expressing the calculated preference feature amount. The preference feature amount sender 15218 sends the generated preference feature amount information to the air conditioner 15004 that is the sender of the preference feature amount request information.

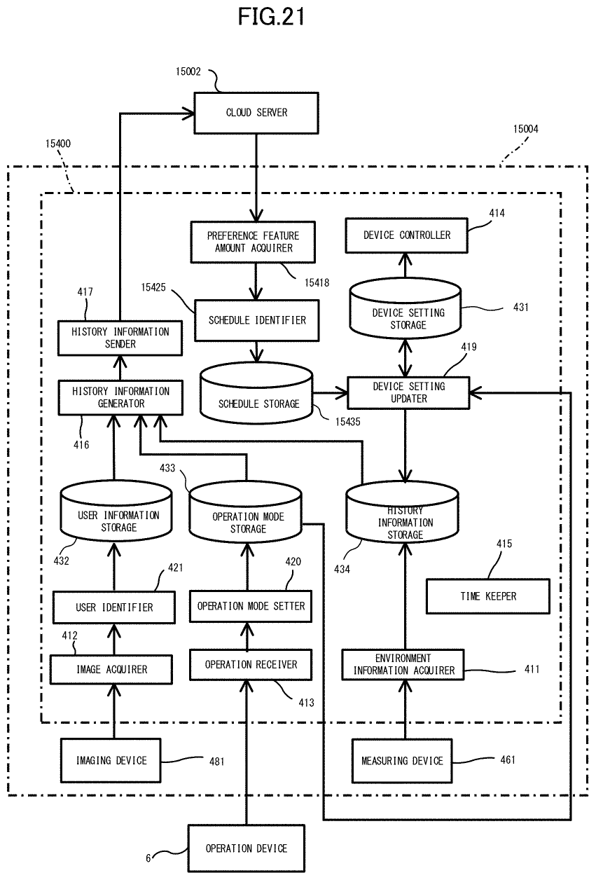

The CPU 401 of the air conditioner 15004 according to the present embodiment reads out the program stored in the auxiliary storage 403 to the main storage 402 and executes the program to function as an environment information acquirer 411, an image acquirer 412, an operation receiver 413, a device controller 414, a time keeper 415, a history information generator 416, a history information sender 417, a preference feature amount acquirer 15418, a device setting updater 419, an operation mode setter 420, a user identifier 421, and a schedule identifier 15425, as illustrated in FIG. 21. Additionally, as illustrated in FIG. 20, the auxiliary storage 403 includes a device setting storage 431, a user information storage 432, an operation mode storage 433, a history information storage 434, and a schedule storage 15435.

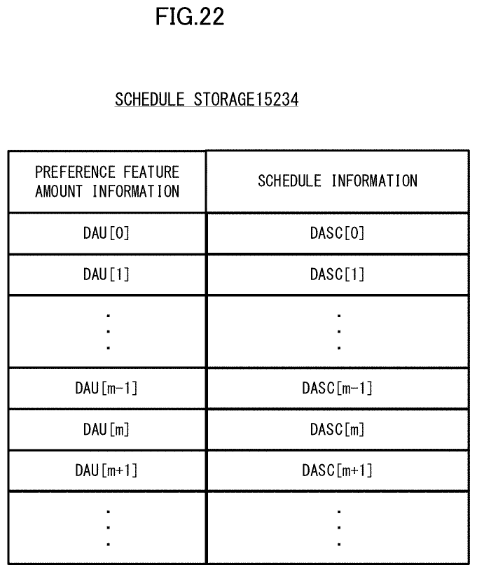

As illustrated in FIG. 22, for example, the schedule storage 15435 associates a plurality of types of schedule information with the preference feature amount information expressing the preference feature amount, and stores the associated information. Here, the feature of the preference of the user is categorized on the basis of, for example, the physical feature of the user, and the preference feature amount is information obtained by quantifying each preference. For example, a configuration is possible in which, for the preference feature amount information, “10” is assigned to “sensitive to heat”, “20” is assigned to “sensitive to cold”, “30” is assigned to “sensitive to heat at first, but immediately lowers settings when the room cools”, “40” is assigned to “sensitive to heat only immediately after returning home”, “90” is assigned to “sensitive to heat only during time frame after finishing bathing”, “100” is assigned to “sensitive to heat during mealtimes”, “110” is assigned to “uses air conditioner rarely”, and “120” is assigned to “only uses on extremely hot days.”

The preference feature amount acquirer 15418 acquires the preference feature amount information from the cloud server 15002, and notifies the schedule identifier 15425 of the acquired preference feature amount information. The schedule identifier 15425 identifies, from the plurality of types of schedule information stored in the schedule storage 15435, the schedule information corresponding to the preference feature amount calculated by the neural network calculator 214 and acquired by the preference feature amount acquirer 15418. Then, the device setting updater 419 updates, on the basis of the schedule information identified by the schedule identifier 15425, the device setting information stored in the device setting storage 431.

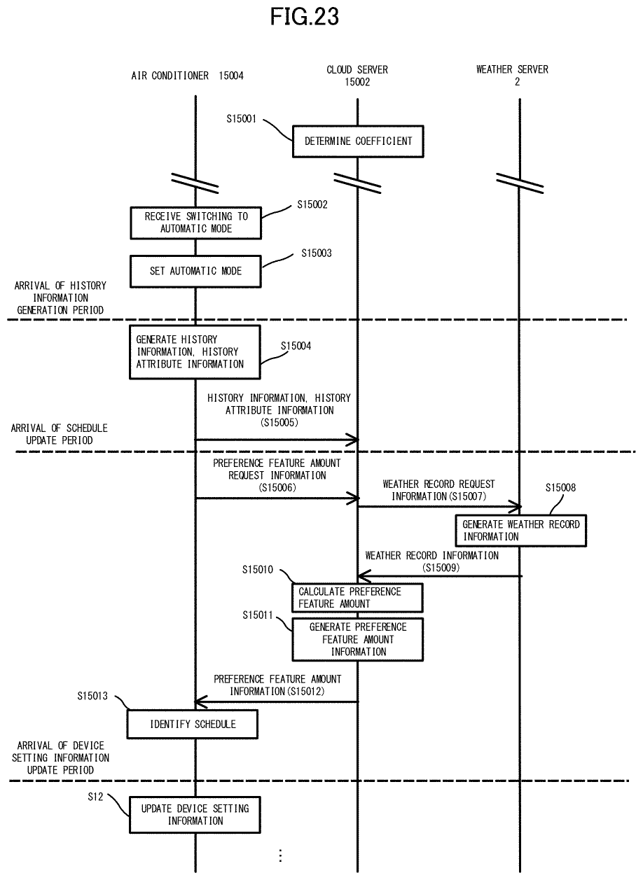

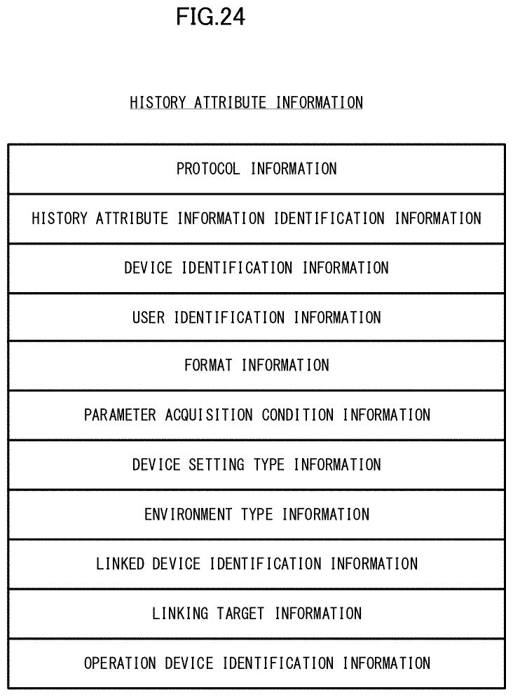

Next, the operations of the control system according to the present embodiment are described while referencing FIGS. 23 and 24. Note that, in FIG. 23, the processes that are the same as in Embodiment 1 are denoted with the same reference numerals as used in FIG. 13. Firstly, the cloud server 15002 determines the weighting coefficient of the neural network on the basis of the operation history information, the environment history information, and the preference feature amount information that are acquired from the teacher information storage 15235 (step S15001). Next, it is assumed that the air conditioner 4, 52 or the water heater 51 receives a switching operation performed by the user for switching to the automatic mode (step S15002), and the operation mode is set to the automatic mode (step S15003).

Thereafter, when a history information generation period arrives, the air conditioner 15004 generates the history information and the history attribute information using the operation history information, the environment history information, the date and time information, and the user information stored in the history information storages 434, 534 (step S15004). In one example, the history attribute information has a structure such as that illustrated in FIG. 24. Next, the generated history information and history attribute information are sent from the air conditioner 15004 to the cloud server 2 (step S15005).

Next, when the air conditioner 15004 determines that a predetermined update period of the operation schedule of the air conditioner 15004 has arrived, schedule request information requesting, to the cloud server 15002, sending of the schedule information is sent from the air conditioner 15004 to the cloud server 15002 (step S15006). Meanwhile, when the cloud server 15002 receives the schedule request information, weather record request information requesting, to the weather server 3, sending of the weather record information is sent from the cloud server 15002 to the weather server 3 (step S15007). Meanwhile, when the weather server 3 receives the weather record request information, the weather server 3 generates weather record information of the region in which the house H, in which the air conditioner 4, 52 or the water heater 51 is installed, exists (step S15008). Then, the generated weather record information is sent from the weather server 3 to the cloud server 15002 (step S15009). Next, the cloud server 15002 uses the neural network to calculate the preference feature amount of the user from the operation history information, the environment history information, and the weather record information (step S15010). Then, the cloud server 15002 generates preference feature amount information expressing the calculated preference feature amount (step S15011). Next, the generated preference feature amount information is sent from the cloud server 15002 to the air conditioner 15004 (step S15012). Meanwhile, when the air conditioner 15004 receives the preference feature amount information, the air conditioner 15004 identifies the schedule information corresponding to the received preference feature amount from among the plurality of types of schedule information stored in the schedule storage 15435 (step S15013). Then, the air conditioner 15004 updates, on the basis of the schedule information, the device setting information stored in the device setting storage 431 (step S12). Thereafter, the processing of the aforementioned step S12 is repeatedly executed every time the update period of the device setting information arrives.

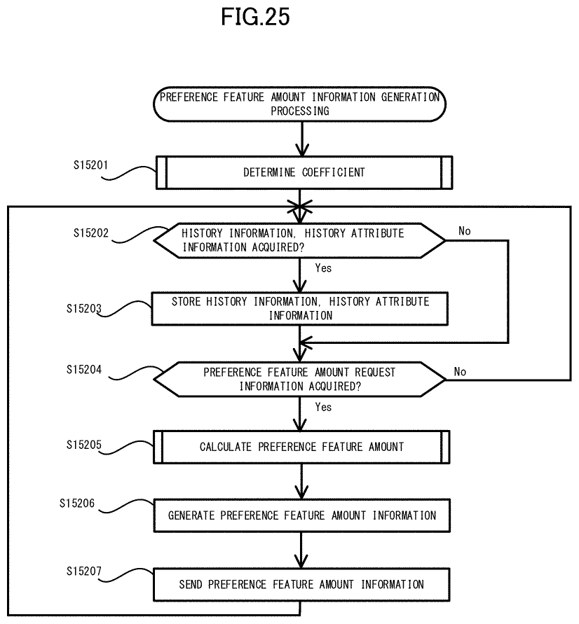

Next, preference feature amount information generation processing executed by the cloud server 15002 according to the present embodiment is described while referencing FIGS. 25 to 27. In one example, this preference feature amount information generation processing starts when the power to the cloud server 15002 is turned ON.

Firstly, as illustrated in FIG. 25, coefficient determination processing is executed for determining the coefficient of the neural network on the basis of the operation history information, the environment history information, the weather record information, and the preference feature amount information that are acquired from the teacher information storage 15235 (step S15201).

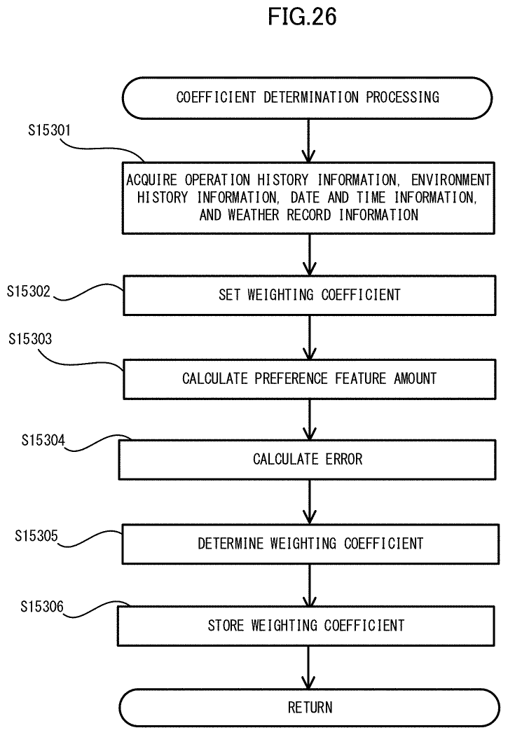

Here, details of the coefficient determination processing are described in detail while referencing FIG. 26. Firstly, the neural network calculator 214 acquires the operation history information, the environment history information, and the date and time information from the teacher information storage 15235, and acquires the weather record information from the weather information storage 232 (step S15301). Next, the coefficient setter 15213 acquires, from the neural network storage 15233, information expressing an initial weighting coefficient that is an initial value of the weighting coefficient, and sets the weighting coefficient of the neural network to the initial weighting coefficient (step S15302). Next, the neural network calculator 214 uses the neural network for which the initial weighting coefficient is set to calculate the preference feature amount from the environment parameter included in the environment history information, the date and time expressed by the date and time information, and the information obtained by quantifying the weather condition expressed by the weather record information that are acquired (step S15303). Then, the coefficient determiner 15215 acquires, from the history information storage 231, the preference feature amount information included in the history attribute information, and calculates an error between the calculated preference feature amount and the preference feature amount expressed by the acquired preference feature amount information (step S15304). Next, the coefficient determiner 15215 determines, on the basis of the calculated error, the weighting coefficient of the neural network by the backpropagation method (step S15305). Then, the coefficient determiner 15215 stores the determined weighting coefficient in the neural network storage 15233 (step S15306).

Returning to FIG. 25, the history information acquirer 211 determines whether the history information is acquired from the air conditioner 15004 (step S15202). When the history information acquirer 211 determines that the history information is not acquired (step S15202; No), the processing of hereinafter described step S15204 is executed without modification. However, when the history information acquirer 211 determines that the history information is acquired (step S15202; Yes), the history information acquirer 211 stores the acquired history information in the history information storage 231 (step S15203). Next, the preference feature amount information generator 15217 determines whether the preference feature amount request information is acquired from the air conditioner 15004 (step S15204). When the preference feature amount information generator 15217 determines that the preference feature amount request information is not acquired (step S15204; No), the processing of step S15201 is executed again. However, when the preference feature amount information generator 15217 determines that the preference feature amount request information is acquired (step S15204; Yes), preference feature amount calculation processing is executed (step S15205).

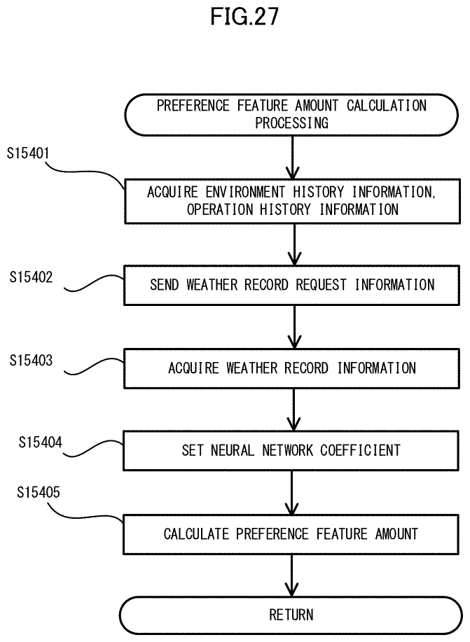

Here, details of the preference feature amount calculation processing are described in detail while referencing FIG. 27. Firstly, the neural network calculator 214 acquires the environment history information and the operation history information from the history information storage 231 (step S15401). Next, the weather information acquirer 212 sends the weather record request information requesting, to the weather server 3, sending of the weather record information (step S15402) to acquire the weather record information from the weather server 3 (step S15403). Here, the weather information acquirer 212 stores the acquired weather record information in the weather information storage 232. Then, the coefficient setter 15213 acquires, from the neural network storage 15233, the weighting coefficient determined in the coefficient determination processing, and sets the weighting coefficient of the neural network to the acquired weighting coefficient (step S15404). Thereafter, the neural network calculator 214 uses the neural network in which the weighting coefficient is set to calculate, from the acquired environment history information and operation history information, and the information obtained by quantifying the weather condition expressed by the weather record information, the preference feature amount that is the feature amount of the preference of the user (step S15405).

Returning to FIG. 25, next, the preference feature amount information generator 15217 generates preference feature amount information expressing the preference feature amount calculated by the neural network calculator 214 (step S15206). Next, the preference feature amount sender 15218 sends the generated preference feature amount information to the air conditioner 15004 (step S15207). Then, the processing of step S15201 is executed again.

As described above, with the control system according to the present embodiment, in the cloud server 2, the neural network calculator 214 uses the neural network, for which the weighting coefficient is determined by the coefficient determiner 215, to calculate the preference feature amount that is the feature amount of the preference of the user from the weather record information, the environment history information, and the operation history information. Meanwhile, the schedule identifier 15425 of the air conditioner 15004 identifies, from the plurality of types of schedule information stored in the schedule storage 15435, the schedule information corresponding to the preference feature amount calculated by the cloud server 15002; the device setting updater 419 updates the device setting information stored in the device setting storage 431 in accordance with the operation schedule expressed by the schedule information identified by the schedule identifier 15425; and the device controller 414 controls the air conditioner 15004 on the basis of the device setting parameter expressed by the device setting information stored in the device setting storage 431. As a result, the air conditioner 15004 can be controlled as a result of the air conditioner 15004 merely sending the history information to the cloud server 2 and acquiring the preference feature amount information from the cloud server 2 every period corresponding to the operation schedule expressed by the schedule information. Therefore, it is sufficient that only the preference feature amount information is sent from the cloud server 15002 to the air conditioner 15004, which leads to the benefit of a reduction of the effects, on the operations of the air conditioner 15004, of the communication traffic on the external network NT1.

Note that, in the present embodiment, an example is described in which the schedule information is sent from the cloud server 15002 to the air conditioner 15004, 52, but the present embodiment is not limited thereto, and a configuration is possible in which the preference feature amount information expressing the preference feature amount is sent to the air conditioner 15004, 52. For example, a configuration is possible in which, when the air conditioner 15004, 52 includes the measuring device 461, the air conditioner 15004, 52 is controlled using the preference feature amount information and the environment history information obtained by the measuring device 461. In such a case, since the amount of information of the preference feature amount information is less than that of the schedule information, the communication traffic can be reduced a corresponding amount.

### Embodiment 3

With a control system according to the present embodiment, a device uses a neural network to calculate a future device setting parameter of the device from an environment parameter of a location at which the device is installed and a future weather condition expressed by weather prediction information. Here, the neural network has a predetermined number of nodes and a predetermined number of layers, and is for calculating the future device setting parameter of the device. A server includes a history information acquirer that acquires, from the device, history information including operation history information expressing a history of the device setting parameter, environment history information expressing a history of an environment in which the device operates, and user information expressing a user of the device; and a weather information acquirer that acquires, from a weather server, weather information including weather record information expressing a past weather condition. Additionally, the server includes a coefficient determiner that determines a weighting coefficient of the neural network on the basis of the history information and the weather record information that are acquired. The device includes a neural network calculator that uses the neural network for which neural network coefficient is determined to calculate the future device setting parameter of the device from the weather prediction information and an environment parameter, included in the environment history information, indicating an environment at present.

As with the control system described using FIG. 1 in Embodiment 1, the control system according to the present embodiment includes an air conditioner and a water heater installed in a house H, and a cloud server that is capable of communicating with the air conditioner and the water heater via an external network NT1. Note that, in the present embodiment, constituents that are the same as in Embodiment 1 are denoted with the same reference numerals used in Embodiment 1. Additionally, only the air conditioner is described in the present embodiment. The water heater executes the same processing as the air conditioner. Additionally, it is assumed that an internal network NT2 is laid and a router and a data line terminal device that are connected to the internal network NT2 are installed in the house H.

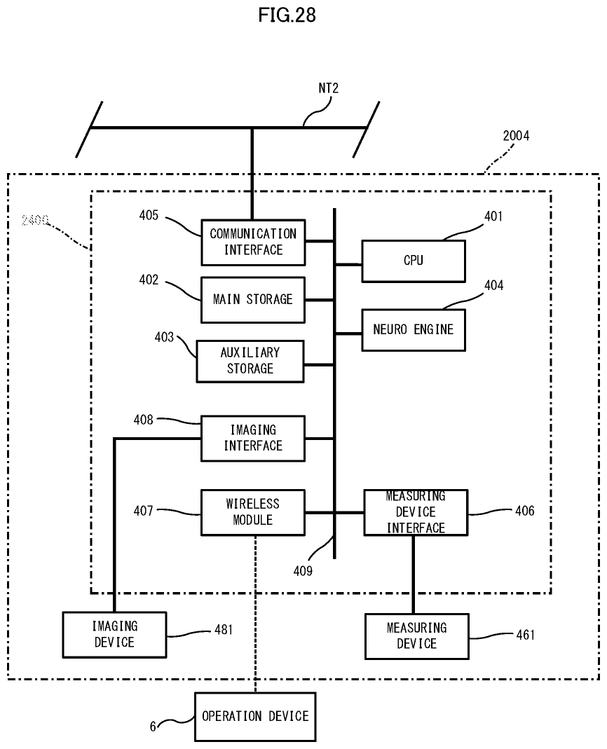

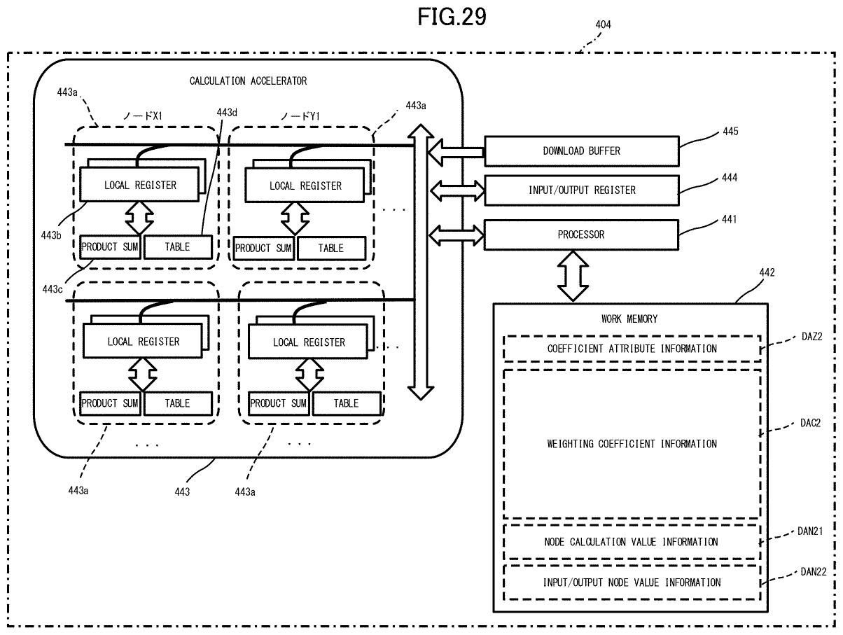

As illustrated in FIG. 28, an air conditioner 2004 according to the present embodiment includes a controller 2400, a measuring device 461, and an imaging device 481. Additionally, the air conditioner 2004 includes a compressor (not illustrated in the drawings) and a blowing fan (not illustrated in the drawings) that operate on the basis of command signals input from the controller 2400. The controller 2400 includes a CPU 401, a main storage 402, an auxiliary storage 403, a communication interface 405, a measuring device interface 406, a wireless module 407, an imaging interface 408, a neuro engine 404, and a bus 409 that connects these components to each other. Note that, in FIG. 28, the constituents that are the same as in Embodiment 1 are denoted with the same reference numerals as used in FIG. 2. The neuro engine 404 is hardware dedicated to calculation processing using a neural network that has a predetermined number of nodes and a predetermined number of layers. The neuro engine 404 has the same functions as the neural network calculator 214 described in Embodiment 1. As illustrated in FIG. 29, the neuro engine 404 includes a processor 441, a work memory 442, a calculation accelerator 443, an input/output register 444, and a download buffer 445. Here, hereinafter described coefficient attribute information and coefficient information are acquired from a cloud server 2002. Note that, in one example, the coefficient attribute information has a JSON schema file format, and the coefficient information has a JSON file format. Here, the coefficient attribute information is temporarily stored in the download buffer 445, and then is stored in the work memory 442 used by the processor 441. The processor 441 reads out coefficient attribute information DAZ2 of the work memory 442 and, on the basis of information expressing the number of layers and the number of nodes of the neural network and information expressing the structure of the neural network included in the coefficient attribute information DAZ2, secures memory regions needed to store weighting coefficient information DAC2, node calculation value information DAN21, and input/output node value information DAN22. Then, the processor 441 associates the weighting coefficient and the nodes of the neural network in each of the memory regions.

Additionally, the processor 441 stores the weighting coefficient information DAC2 in the corresponding portion of the work memory 442. The processor 441 stores input value information to the neural network, which is inputted from the input/output register 444, in the memory region for storing the input/output node value information DAN22 and, then, sequentially reads out the weighting coefficient information DAC2. The processor 441 sets, in the calculation program, activation function information included in the coefficient attribute information DAZ2 stored in the work memory 442 and, then, executes sequential calculations for each layer and each node of the neural network. Then, when the calculations for each layer and each node of the neural network are complete, the processor 441 stores the resulting output value information in the memory region storing the input/output node value information DAN22 and, thereafter, transfers the output value information from the memory region storing the input/output node value information DAN22 to an output portion of the input/output register 444. Note that, in the calculation processing executed by the processor 441, the work memory 442 must have large capacity and, also, there are frequent transfers of numerical information between the processor 441 and the work memory 442. Accordingly, a certain amount of time is needed to carry out the neural network calculations using the processor 441. As such, in some cases, a graphical processing unit (GPU) capable of high-speed calculation is used as the processor 441 to shorten the calculation time of the neural network.

A calculation accelerator 443 is a dedicated accelerator configured from hardware, and is specialized in processing specific to the calculations of a neural network that executes the enormous number of simple calculations required for every node of the neural network. The calculation accelerator 443 includes a plurality of node unit calculators 443a. The various node unit calculators 443a are provided for every node (for example node X1, Y1) of the neural network. Each node unit calculator 443a includes a local register 443b, a product sum calculator 443c, and a conversion table section 443d. The number of the node unit calculators 443a that is provided is the same as the number of the nodes of the neural network. Additionally, considering that the number of registers differs depending on the scale of the neural network, the local register 443b corresponding to the conversion table section 443d and the product sum calculator 443c has a structure capable of selecting the needed number of local registers. Moreover, the calculation accelerator 443 selects the required number of local registers 443b on the basis of the information expressing the number of layers and the number of nodes of the neural network included in the coefficient attribute information acquired from the cloud server 2002.

After the calculation accelerator 443 selects the needed number of local registers 443b, the weighting coefficient information is stored in each local register 443b and the calculations of each node of the neural network are executed. Additionally, the conversion table section 443d is for carrying out the calculations of the activation function described above, and the content of the conversion table section 443d is set on the basis of information expressing the shape of the activation function included in the coefficient attribute information. Moreover, as described later, the coefficient attribute information includes structure information expressing the structure of the neural network. The node unit calculators 443 a reference information related to the structure of the neural network included in the coefficient attribute information to determine the position of the local register 443b in which the weighting coefficient of the neural network is stored and a connection relationship between the node unit calculators 443a, and acquire the coefficient information. Due to being provided with such a hardware configuration, the calculation accelerator 443 can carry out calculations individually for every node of the neural network, or can carry out calculations at once for a plurality of nodes. This calculation accelerator 443 is capable of processing at higher speeds than when performing calculations using the work memory 442 and the processor 441. Additionally, the calculation accelerator 443 reads out results of the calculations obtained using the neural network from the local register 443b of the node unit calculator 443a corresponding to an output node, and outputs the results to the output portion of the input/output register 444.

Note that the calculation accelerator 443 cannot change the circuit scale of the hardware, regardless of the scale of the calculations. As such, the neuro engine 404 according to the present embodiment has a configuration that combines the calculation accelerator 443, the processor 441, and the work memory 442.

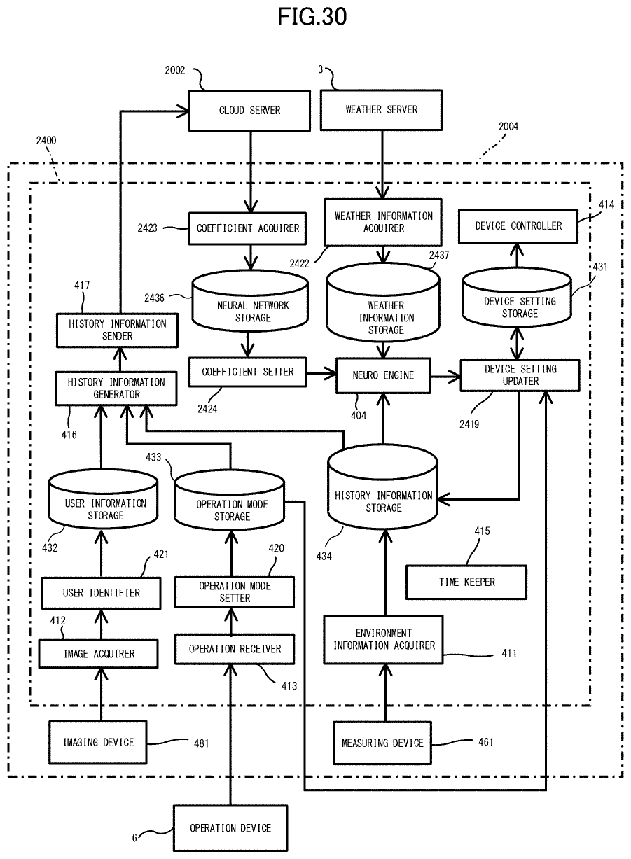

Returning to FIG. 28, the CPU 401 reads out the program stored in the auxiliary storage 403 to the main storage 402 and executes the program to function as an environment information acquirer 411, an image acquirer 412, an operation receiver 413, a device controller 414, a time keeper 415, a history information generator 416, a history information sender 417, a device setting updater 2419, an operation mode setter 420, a user identifier 421, a weather information acquirer 2422, a coefficient acquirer 2423, and a coefficient setter 2424, as illustrated in FIG. 30. Additionally, as illustrated in FIG. 30, the auxiliary storage 403 illustrated in FIG. 28 includes a device setting storage 431, a user information storage 432, an operation mode storage 433, a history information storage 434, a neural network storage 2436, and a weather information storage 2437. The neural network storage 2436 stores neural network structure information expressing the structure of the neural network and weighting coefficient information expressing the weighting coefficient of the neural network that the neuro engine 404 uses. The structure information of the neural network includes information expressing a shape of an activation function at each node, number of layers information, information about the number of nodes in each layer, and the like. The weather information storage 2437 stores the weather prediction information acquired from the cloud server 2002.

The weather information acquirer 2422 is a second weather information acquirer that acquires, from the weather server 3, weather information including weather prediction information expressing a future weather condition. Here, the weather information acquirer 2422 acquires the weather information from the weather server 3 by sending weather information request information requesting, to the weather server 3, sending of the weather information. The coefficient acquirer 2423 acquires, from the cloud server 2002, the coefficient information including the information expressing the weighting coefficient of the neural network realized in the neuro engine 404. Here, the coefficient acquirer 2423 acquires the coefficient information from the cloud server 2002 by sending coefficient request information requesting, to the cloud server 2002, sending of the coefficient information. Additionally, the coefficient acquirer 2423 executes information expansion processing on the coefficient information and the coefficient attribute information that are acquired from the cloud server 2002 and that have been subjected to reversible information compression processing. Then, the coefficient acquirer 2423 stores the weighting coefficient information included in the coefficient information in the neural network storage 2436.

The coefficient setter 2424 sets the weighting coefficient of the neural network. The neuro engine 404 uses the neural network, in which the weighting coefficient is set by the coefficient setter 2424, to calculate the future device setting parameter of the air conditioner 2004 from the weather prediction information and the environment parameter indicating the environment at present included in the environment history information. Here, the environment parameter expressing the environment at present is a parameter expressing the indoor temperature acquired from the air conditioners 2004, 52 or the temperature of the hot water acquired from the water heater 51. In some cases, due to the measuring frequencies of the measuring device 461 of the air conditioners 2004, 52 and the measuring device 561 of the water heater 51 and an acquisition frequency of the environment parameter of the history information acquirer 211, the environment parameter expressing the current environment is a parameter expressing an environment a few seconds to a few minutes before the present time. Additionally, the neuro engine 404 uses the neural network to calculate the device setting parameter from the environment parameter such as the indoor temperature at present, the hot water temperature at present, or the like expressed by the environment history information included in the history information, the numerical value indicating the date and time at present, and the information obtained by quantifying the future weather condition expressed by the weather prediction information.

The device setting updater 2419 references the operation mode information stored in the operation mode storage 433 and, when the operation mode is set to the automatic mode, uses the device setting information calculated by the neuro engine 404 to update the device setting information stored in the device setting storage 431. Here, the period in which the device setting updater 2419 updates the device setting information can be set to a time that arrives at predetermined regular time intervals. For example, the period can be set to a time that arrives at time intervals of five minutes.

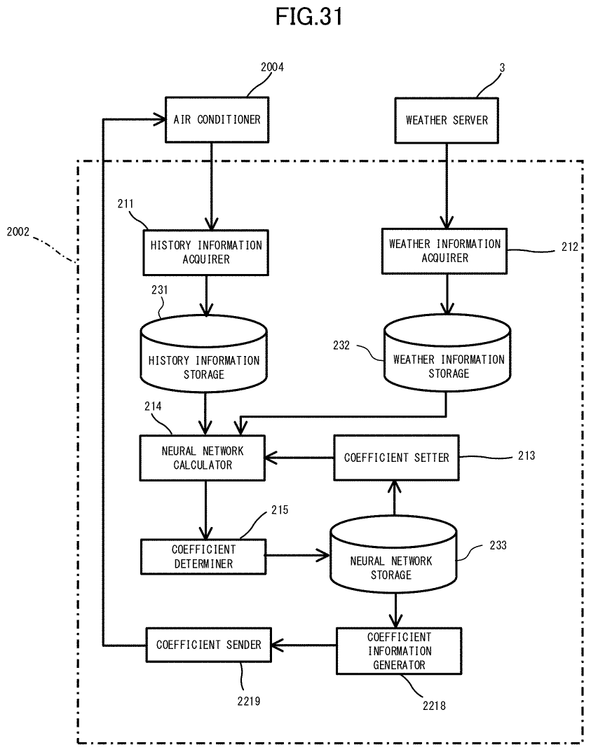

The hardware configuration of the cloud server 2002 is the same as the hardware configuration of the cloud server 2 of Embodiment 1 illustrated in FIG. 10. With the cloud server 2002, the CPU 401 reads out the program stored in the auxiliary storage 403 to the main storage 402 and executes the program to function as a history information acquirer 211, a weather information acquirer 212, a coefficient setter 213, a neural network calculator 214, a coefficient determiner 215, a coefficient information generator 2218, and a coefficient sender 2219, as illustrated in FIG. 31. Note that, in FIG. 31, the constituents that are the same as in Embodiment 1 are denoted with the same reference numerals as used in FIG. 10. Additionally, as illustrated in FIG. 31, the auxiliary storage 203 illustrated in FIG. 10 includes a history information storage 231, a weather information storage 232 that stores the weather record information acquired from the weather server 3, and a neural network storage 233.

The weather information acquirer 212 is a first weather information acquirer that acquires, from the weather server 3, the weather record information expressing the past weather condition. Here, the weather information acquirer 212 acquires the weather record information from the weather server 3 by sending weather record request information requesting, to the weather server 3, sending of the weather record information. As in Embodiment 1, the coefficient determiner 215 determines the weighting coefficient of the neural network on the basis of the history information and the weather record information. The coefficient information generator 2218 generates coefficient information that includes information expressing the weighting coefficient determined by the coefficient determiner 215. In one example, the coefficient information generator 2218 generates coefficient attribute information for which the file format is JSON schema, and generates coefficient information for which the file format is JSON. The coefficient sender 2219 sends the coefficient information generated by the coefficient information generator 2218 to the air conditioner 2004. Here, the coefficient sender 2219 performs reversible information compression processing on the coefficient information and the coefficient attribute information and then sends the processed information. As a result, the amount of information sent from the cloud server 2002 to the air conditioner 2004 can be reduced.

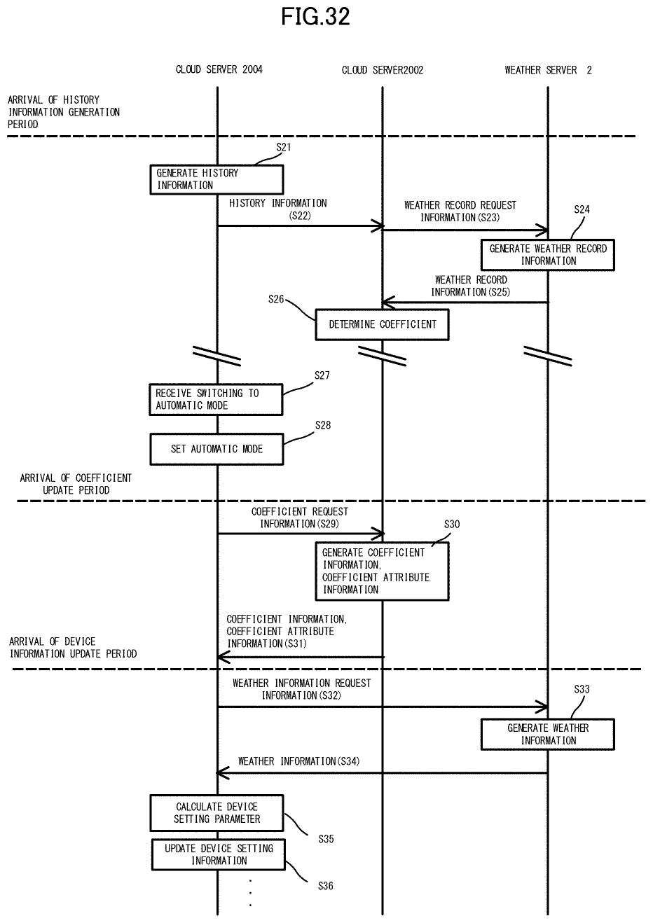

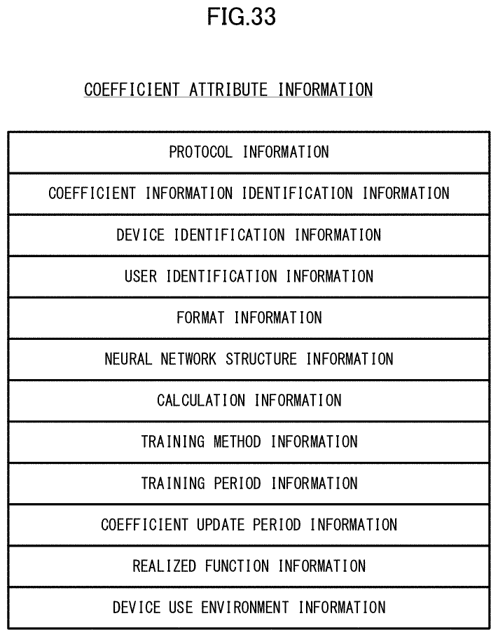

Next, the operations of the control system according to the present embodiment are described while referencing FIGS. 32 and 33. Firstly, when a history information generation period arrives, the air conditioner 2004 generates the history information using the operation history information, the environment history information, the date and time information, and the user information stored in the history information storage 434 (step S21). The structure of the history information is the same as the structure of the history information described using FIG. 12 in Embodiment 1. Then, the generated history information is sent from the air conditioner 2004 to the cloud server 2002 (step S22). When the cloud server 2002 receives the history information, the cloud server 2002 stores, in the history information storage 231, the operation history information, the environment history information, the date and time information, and the user information included in the history information.

Next, weather record request information requesting, to the weather server 3, sending of the weather record information is sent from the cloud server 2002 to the weather server 3 (step S23). Meanwhile, when the weather server 3 receives the weather record request information, the weather server 3 generates weather record information of the region in which the house H exists (step S24). Next, the generated weather record information is sent from the weather server 3 to the cloud server 2002 (step S25). Meanwhile, when the cloud server 2002 receives the weather record information, the cloud server 2002 stores the received weather record information in the weather information storage 232. Then, the cloud server 2002 determines the weighting coefficient of the neural network on the basis of the operation history information, the environment history information, the date and time information, the user information, and the weather record information that are acquired (step S26). The cloud server 2002 stores information expressing the determined weighting coefficient in the neural network storage 233.

Next, it is assumed that the air conditioner 2004 receives a switching operation performed by the user for switching to the automatic mode (step S27). In this case, the operation mode is set to the automatic mode by the air conditioner 2004 storing, in the operation mode storage 433, operation mode information expressing that the operation mode is the automatic mode (step S28). Next, when the air conditioner 2004 determines that a predetermined update period of the weighting coefficient of the neural network realized by the neuro engine 2104 has arrived, coefficient request information requesting, to the cloud server 2002, sending of the coefficient information is sent from the air conditioner 2004 to the cloud server 2002 (step S29). Meanwhile, when the cloud server 2002 receives the coefficient request information, the cloud server 2002 generates coefficient information including the information expressing the weighting coefficient stored in the neural network storage 233 (step S30).

The coefficient information includes protocol information, coefficient information identification information that identifies the generated coefficient information, and the weighting coefficient information. The protocol information includes a variety of information related to a communication protocol used when sending the coefficient information to the air conditioner 2004. As illustrated in FIG. 33, for example, the coefficient attribute information includes the protocol information and a variety of attribute information. Examples of the attribute information include coefficient attribute information identification information that identifies the generated coefficient attribute information, device identification information that identifies the air conditioner 4, 52 or the water heater 51 that is the target for which the device setting parameter is to be calculated using the neural network, the user identification information described above, format information, neural network structure information, calculation information, training method information, training period information, coefficient update period information, realized function information, and device use environment information. In one example, the coefficient information identification information includes at least one of identification information imparted to the attribute information, identification information imparted to the weighting coefficient information, and identification information of the air conditioner 4, 52 or the water heater 51. The format information includes information expressing a data format or a file format and information expressing a compression format of each of the attribute information and the weighting coefficient information. In one example, the format information includes information expressing that the file format of the attribute information is JSON schema and information expressing that the file format of the weighting coefficient information is JSON. The neural network structure information includes information expressing the number of layers and the number of nodes of each layer of the neural network, information expressing the degree of the matrix used in the calculations using the neural network, and information expressing the shape of the activation function at each node of the neural network. Additionally, the neural network structure information includes normalization processing or drop-out information of the calculations using the neural network, and information about the node connected to an input side and the node connected to an output side of each node of the neural network. Here, the “drop-out information” is information expressing whether any of the nodes of the neural network are deactivated when determining the weighting coefficient of the neural network. The calculation information includes information expressing processing methods for when performing calculations using the neural network, such as multi-thread processing, pipeline processing, and the like. The training method information includes information expressing a training method such as backpropagation using an autoencoder. The training period information includes information expressing a present or past period at which the operation history information, the environment history information, and the weather record information, which are used when determining the coefficient of the neural network, are acquired. The coefficient update period information includes information expressing a period in which the weighting coefficient of the neural network is updated. The realized function information is information expressing a function of the air conditioner 4, 52 or the water heater 51 that is to be controlled by the device setting parameter calculated using the neural network. Additionally, the realized function information includes information expressing operation content performed on the operation device 6, 71, 72 when the user manually changes the device setting parameter calculated using the neural network. The device use environment information includes information expressing the arrangement of each of the air conditioners 4, 52 and the water heater 51 in the house H, and information expressing the composition of the household residing in the house H.

Returning to FIG. 32, next, the generated coefficient information is sent from the cloud server 2002 to the air conditioner 2004 (step S31). Meanwhile, when the air conditioner 2004 receives the coefficient information, the air conditioner 2004 stores the received coefficient information in the neural network storage 2436. Then, the air conditioner 2004 acquires the weighting coefficient stored in the neural network storage 2436, and sets the acquired weighting coefficient in the neuro engine 404. Thereafter, it is assumed that the air conditioner 2004 determines that the update period of the device setting information has arrived. In this case, weather information request information requesting, to the weather server 3, sending of the weather information including the weather prediction information and the weather record information is sent from the air conditioner 2004 to the weather server 3 (step S32). Meanwhile, when the weather server 3 receives the weather information request information, the weather server 3 identifies the weather prediction information of the region in which the house H exists, and generates weather information including the identified weather prediction information (step S33). Next, the generated weather information is sent from the weather server 3 to the air conditioner 2004 (step S34).

Next, the air conditioner 2004 uses the neural network in which the weighting coefficient is set to calculate the future device setting parameter of the air conditioner 2004 from the future weather condition expressed by the weather prediction information and the environment parameter indicating the environment at present included in the environment history information (step S35). Then, the air conditioner 2004 uses the calculated device setting parameter to update the device setting information stored in the device setting storage 431 (step S36). Thereafter, the series of processing from step S32 to step S36 is repeatedly executed every time the update period of the device setting information arrives.

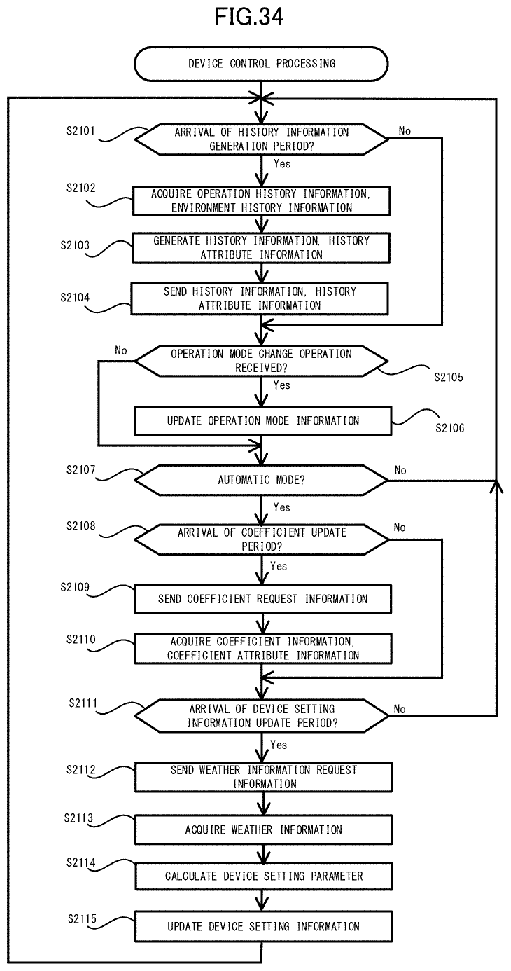

Next, device control processing executed by the air conditioner 2004 according to the present embodiment is described while referencing FIG. 34. In one example, this device control processing starts when the power to the air conditioner 2004 is turned ON.

Firstly, the series of processing from step S2101 to step S2106 is executed. Here, the series of processing from step S2101 to step S2106 is the same as the series of processing from step S101 to step S106 described using FIG. 15 in Embodiment 1. Next, the coefficient acquirer 2423 references the operation mode information stored in the operation mode storage 433 to determine whether the operation mode of the air conditioner 2004 is the automatic mode (step S2107). When the coefficient acquirer 2423 determines that the operation mode of the air conditioner 2004 is the manual mode (step S2107; No), the processing of step S2101 is executed again. However, when the coefficient acquirer 2423 determines that the operation mode of the air conditioner 2004 is the automatic mode (step S2107; Yes), the coefficient acquirer 2423 determines whether a coefficient update period of the neural network has arrived (step S2108). When the coefficient acquirer 2423 determines that the coefficient update period has not arrived (step S2108; No), the processing of hereinafter described step S2111 is executed without modification. However, it is assumed that the coefficient acquirer 2423 determines that the coefficient update period has arrived (step S2108; Yes). In this case, the coefficient acquirer 2423 sends the coefficient request information to the cloud server 2002 (step S2109) to acquire the coefficient information from the cloud server 2002 (step S2110). The coefficient acquirer 2423 stores the acquired coefficient information in the neural network storage 2436.

Next, the device setting updater 2419 determines whether a predetermined update period of the device setting information of the air conditioner 2004 has arrived (step S2111). When the device setting updater 2419 determines that the update period of the device setting information of the air conditioner 2004 has not arrived (step S2111; No), the processing of step S2101 is executed again. However, it is assumed that the device setting updater 2419 determines that a update period of the device setting information of the air conditioner 2004 has arrived (step S2111; Yes). In this case, the weather information acquirer 2422 sends, to the weather server 3, the weather information request information (step S2112) to acquire the weather information from the weather server 3 (step S2113). Here, the weather information acquirer 2422 stores, in the weather information storage 2437, the weather prediction information included in the acquired weather information.

Thereafter, the neuro engine 404 uses the neural network, in which the weighting coefficient is set by the coefficient setter 2424, to calculate, on the basis of the weather prediction information and the environment parameter at present included in the environment history information, the device setting parameter of the air conditioner 2004 (step S2114). Next, the device setting updater 2419 uses the calculated device setting parameter to update the device setting information stored in the device setting storage 431 (step S2115). Then, the processing of step S2101 is executed again.

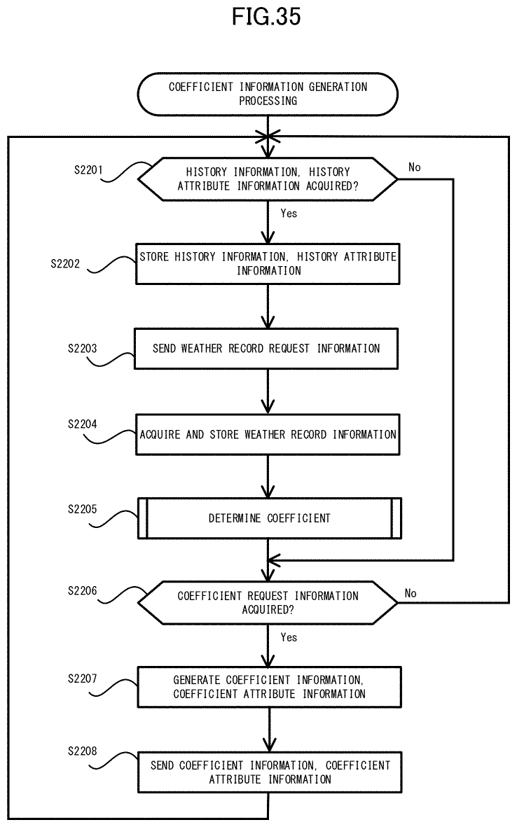

Next, coefficient information generation processing executed by the cloud server 2002 according to the present embodiment is described while referencing FIG. 35. In one example, this coefficient information generation processing starts when the power to the cloud server 2002 is turned ON.

Firstly, the processing of steps S2201 and S2202 is executed. The content of the processing of steps S2201 and S2202 is the same as that of the processing of steps S201 and S202 described using FIG. 16 in Embodiment 1. Next, a weather record acquirer 2212 sends weather record request information requesting, to the weather server 3, sending of the weather record information (step S2203) to acquire the weather record information from the weather server 3 (step S2204). Here, the weather record acquirer 2212 stores the acquired weather record information in the weather information storage 232. Next, coefficient determination processing is executed for determining the coefficient of the neural network described above on the basis of the operation history information and the environment history information included in the history information, and the weather record information (step S2205). The content of the coefficient determination processing is the same as that of the coefficient determination processing described using FIG. 17 in Embodiment 1. However, in step S303 of FIG. 17, the neural network calculator 214 uses the neural network in which the initial weighting coefficient is set to calculate, from the environment parameter included in the acquired environment history information and the information obtained by quantifying the weather condition expressed by the weather record information, the device setting parameter for every date and time expressed by the date and time information. Then, in step S304, the coefficient determiner 215 calculates, for every date and time expressed by the date and time information, the error between the calculated device setting parameter and the device setting parameter included in the operation history information.

Then, the coefficient information generator 2218 determines whether the coefficient request information is acquired from the air conditioner 2004 (step S2206). When the coefficient information generator 2218 determines that the coefficient request information is not acquired (step S2206; No), the processing of step S2201 is executed again. Meanwhile, when the coefficient information generator 2218 determines that the coefficient request information is acquired (step S2206; Yes), the coefficient information generator 2218 generates coefficient information including the weighting coefficient information stored in the neural network storage 233 (step S2207). Thereafter, the coefficient sender 2219 sends the generated coefficient information to the air conditioner 2004 (step S2208). Then, the processing of step S2201 is executed again.

As described above, with the control system according to the present embodiment, in the cloud server 2002, the coefficient determiner 215 determines the weighting coefficient of the neural network and sends the coefficient information that includes the information expressing the determined weighting coefficient to the air conditioner 2004. Additionally, in the air conditioner 2004, the neuro engine 404 uses the neural network, in which the weighting coefficient expressed by the coefficient information received from the cloud server 2002 is set, to calculate the future device setting parameter of the air conditioner 2004 from the weather prediction information and the environment parameter at present included in the environment history information. Moreover, the device controller 414 controls the air conditioner 2004 on the basis of the device setting parameter calculated by the neuro engine 404. As a result, the air conditioner 2004 can be controlled as a result of the air conditioner 2004 merely sending the history information to the cloud server 2002 and acquiring the coefficient information from the cloud server 2002 every time the coefficient information update period arrives, and acquiring the weather information from the cloud server 2002 every time the device setting information update period arrives. Therefore, the frequency at which the history information, the coefficient information, and the weather information are exchanged between the air conditioner 2004 and the cloud server 2002 is reduced, which leads to the benefit of a reduction of the effects, on the operations of the air conditioner 2004, of the communication traffic on the external network NT1. Additionally, when the neural network needs to be re-trained, the air conditioner 2004 can re-send the history information to the cloud server 2002 and acquire information expressing a weighting coefficient of the revised neural network.

Note that the amount of information related to a neural network is much greater than the amount of information of a typical so-called IoT home appliance. For example, the amount of communication in a home appliance can be reduced by installing the neural network itself in that home appliance, However, in such a case, although measurement information of a sensor of the home appliance or operation information of the home appliance can be processed in real time, the content that can be processed and/or the training functions that can be realized in the home appliance are limited due to the measuring resources of the CPU and/or the memory of the home appliance. In particular, due to the capacity of the memory of home appliances, it is difficult to retain the huge amount of information related to the neural network, such as the past history information of the home appliance. Additionally, it is difficult to manage all home appliances, from multi-function high-spec home appliances that have sufficient CPU resources and/or memory to single-function low-cost home appliances that are only provided with a comparatively low-performance CPU, on the same platform. As such, as a control system that includes a cloud server and devices, there is a need for the realization of a control system that, even when each device is provided with different CPU resources, can uniformly use the training function of the neural network for each device and that is less likely to be affected by communication traffic. Additionally, in a control system using these neural networks, a case is anticipated in which a neural network trained for a single user is used across home appliances of different manufacturers or different models, and/or platforms of different manufacturers. Moreover, in order to use this neural network that is trained for a single user across home appliances of different manufacturers or different models, and/or platforms of different manufacturers, there is also a need to unify the information related to the neural networks in a standard data format.

To answer these needs, with the control system according to the present embodiment, as described above, the coefficient information and the coefficient attribute information have predetermined structures. As a result, a benefit is realized in that it is easier to use the coefficient information and the coefficient attribute information across the platforms of different manufacturers.

According to the present embodiment, the air conditioner 2004 sends the history information related to the air conditioner 2004 to the cloud server 2002, and the cloud server 2002 determines the weighting coefficient of the neural network on the basis of the received history information. As a result, even though the air conditioner 2004 does not include a coefficient determiner, the air conditioner 2004 can acquire, from the cloud server 2002, the weighting coefficient of the neural network that is determined on the basis of the history information related to the air conditioner 2004. Accordingly, when, for example, implementing a new air conditioner 2004 due to a malfunction or the end of life of an existing air conditioner 2004, the weighting coefficient of the neural network determined on the basis of the history information related to the air conditioner 2004 used to-date can be inherited and applied. Accordingly, the operation tendencies when automatically operating the air conditioner 2004 are maintained and, as such, the environment in which the air conditioner 2004 is installed is maintained, which is a benefit.

Furthermore, as described above, the coefficient attribute information according to the present embodiment includes the coefficient information identification information, the device identification information, the user identification information, the format information, the neural network structure information, the calculation information, the training method information, the training period information, the coefficient update period information, the realized function information, and the device use environment information. As such, the coefficient information is easier to distribute to the market, for example, or to apply to air conditioners, water heaters, and the like of different manufacturers, which is a benefit.

### Embodiment 4

With a control system according to the present embodiment, a device includes a schedule storage that associates a plurality of types of schedule information expressing an operation schedule of the device with preference feature amount information that is information obtained by quantifying a preference of a user of the device, and stores the associated information. The device uses a second neural network to identify the schedule information expressing the operation schedule of the device from environment history information of a location at which the device is installed, and weather record information expressing a past weather condition. Here, the second neural network has a predetermined number of nodes and a predetermined number of layers and is for calculating a preference feature amount indicating a feature of the preference of the user. A server includes a history information acquirer that acquires, from the device, history information including operation history information expressing a history of the device setting parameter, environment history information expressing a history of an environment in which the device operates, and user information expressing the user of the device; and a weather information acquirer that acquires, from a weather server, weather information including the weather record information expressing the past weather condition, and weather prediction information expressing a future weather condition. Additionally, the server includes a coefficient determiner that determines a weighting coefficient of the second neural network on the basis of the history information and the weather record information that are acquired. The device includes a neural network calculator that uses the second neural network for which the weighting coefficient is determined to calculate the feature amount of the preference of the user from the operation history information, the environment history information, and the weather record information.

As with the control system described using FIG. 1 in Embodiment 1, the control system according to the present embodiment includes an air conditioner and a water heater installed in a house H, and a cloud server that is capable of communicating with the air conditioner and the water heater via an external network NT1. Note that, in the present embodiment, constituents that are the same as in Embodiment 1 are denoted with the same reference numerals used in Embodiment 1. Additionally, only the air conditioner is described in the present embodiment. The water heater executes the same processing as the air conditioner. Additionally, it is assumed that an internal network NT2 is laid and a router and a data line terminal device that are connected to the internal network NT2 are installed in the house H.

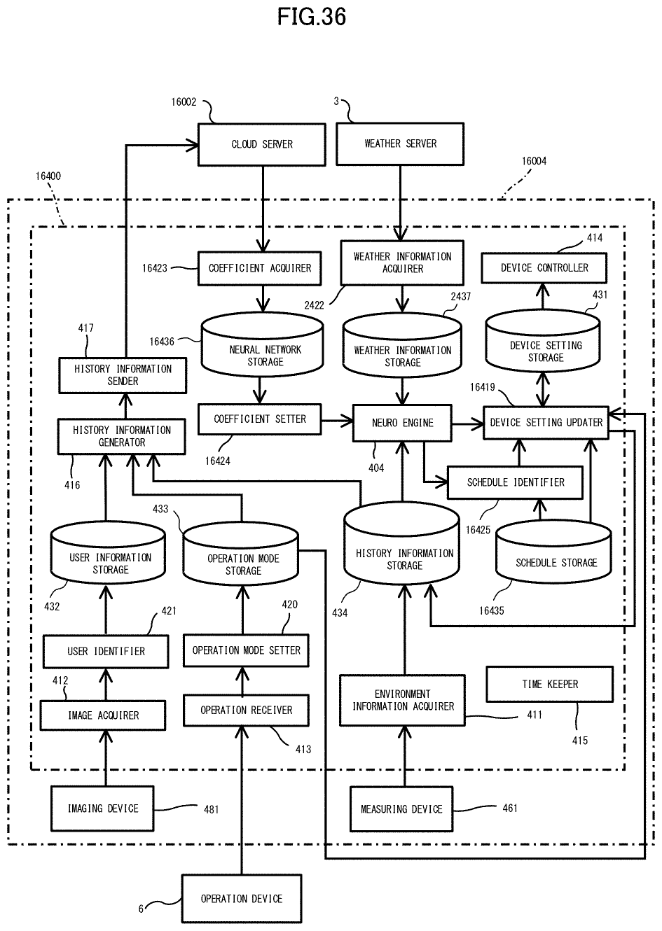

The hardware configuration of an air conditioner 16004 according to the present embodiment is the same as the hardware configuration of the air conditioner 2004 described using FIG. 28 in Embodiment 3. As illustrated in FIG. 36, the air conditioner 16004 includes a controller 16400, a measuring device 461, and an imaging device 481. Note that, in FIG. 36, the constituents that are the same as in Embodiment 3 are denoted with the same reference numerals as used in FIG. 30.

As illustrated in FIG. 36, in the controller 16400, the CPU reads out a program stored in an auxiliary storage to a main storage and executes the program to function as an environment information acquirer 411, an image acquirer 412, an operation receiver 413, a device controller 414, a time keeper 415, a history information generator 416, a history information sender 417, a device setting updater 2419, an operation mode setter 420, a user identifier 421, a weather information acquirer 2422, a coefficient acquirer 16423, and a coefficient setter 16424. Additionally, the auxiliary storage includes a device setting storage 431, a user information storage 432, an operation mode storage 433, a history information storage 434, a neural network storage 16436, a weather information storage 2437, and a schedule storage 16435. Note that the CPU, the main storage, and the auxiliary storage are the same as the CPU 401, the main storage 402, and the auxiliary storage 403 illustrated in FIG. 28. The neural network storage 16436 stores the second neural network that is for calculating the preference feature amount that is the feature amount of the preference of the user of the air conditioner 16004. The neural network storage 16436 stores neural network structure information expressing the structure of the neural network and weighting coefficient information expressing the weighting coefficient of the neural network that the neuro engine 404 uses. As described using FIG. 22 in Embodiment 2, the schedule storage 16435 associates a plurality of types of schedule information with the preference feature amount, and stores the associated information.

The coefficient acquirer 16423 acquires, from the cloud server 16002 via the external network NT1, coefficient information including information expressing the weighting coefficient of the neural network realized in the neuro engine 404. Here, the coefficient acquirer 16423 acquires the coefficient information from the cloud server 16002 by sending coefficient request information requesting, to the cloud server 16002, sending of the coefficient information. The coefficient setter 16424 sets the weighting coefficient of the neural network. Then, the neuro engine 404 uses the neural network, in which the weighting coefficient is set by the coefficient setter 16424, to calculate the preference feature amount from the weather prediction information, the operation history information, and the environment history information. Here, the neuro engine 404 uses the neural network to calculate the preference feature amount from the operation history information and the environment history information included in the history information, and information obtained by quantifying a future weather condition expressed by the weather prediction information.

The schedule identifier 16425 identifies, from the plurality of types of schedule information stored in the schedule storage 16435, the schedule information corresponding to the preference feature amount that is calculated by the neuro engine 404. The device setting updater 16419 references the operation mode information stored in the operation mode storage 433 and, when the operation mode is set to the automatic mode, updates device setting information stored in the device setting storage 431 on the basis of the schedule information identified by the schedule identifier 16425.

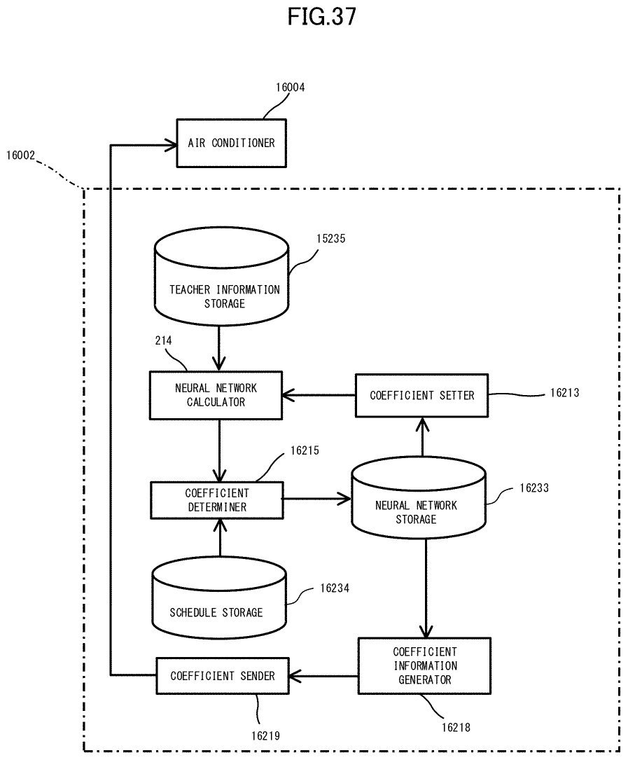

The hardware configuration of the cloud server 16002 is the same as the hardware configuration of the cloud server 2 of Embodiment 1 illustrated in FIG. 10. With the cloud server 16002, the CPU 201 illustrated in FIG. 10 reads out a program stored in the auxiliary storage 203 to the main storage 202 and executes the program to function as a coefficient setter 15213, a neural network calculator 214, a coefficient determiner 16215, and a coefficient sender 16219, as illustrated in FIG. 37. Note that, in FIG. 37, the constituents that are the same as in Embodiment 1 are denoted with the same reference numerals as used in FIG. 10. Additionally, as illustrated in FIG. 37, the auxiliary storage 203 illustrated in FIG. 10 includes a neural network storage 16233, a schedule storage 16234, and a teacher information storage 15235. As with the schedule storage 16435 described above, the schedule storage 16234 associates a plurality of types of schedule information with the preference feature amount, and stores the associated information. As in Embodiment 2, the teacher information storage 15235 stores teacher information that is used by the coefficient determiner 16215 to determine the neural network coefficient.

The coefficient determiner 16215 determines the weighting coefficient of the neural network on the basis of the history information and the weather record information. The coefficient information generator 16218 generates coefficient information that includes information expressing the weighting coefficient determined by the coefficient determiner 16215. The coefficient sender 16219 sends the coefficient information generated by the coefficient information generator 16218 to the air conditioner 16004. Here, the coefficient sender 16219 performs reversible information compression processing on the coefficient information and then distributes the processed information. As a result, the amount of information sent from the cloud server 16002 to the air conditioner 16004 can be reduced.

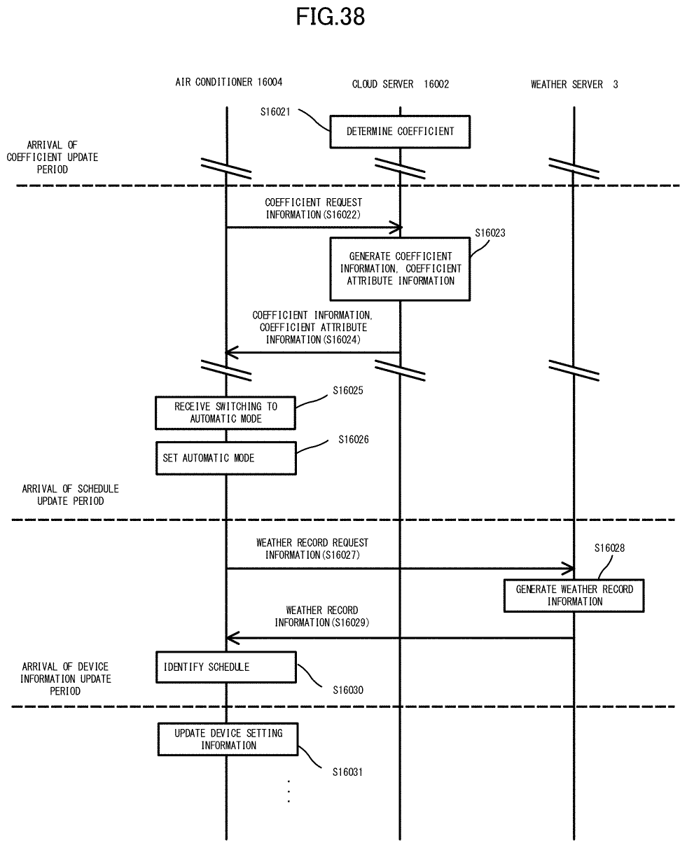

Next, the operations of the control system according to the present embodiment are described while referencing FIG. 38. Note that, in FIG. 38, the processes that are the same as in Embodiment 3 are denoted with the same reference numerals as used in FIG. 32. Firstly, the cloud server 16002 determines the weighting coefficient of the neural network on the basis of the operation history information, the environment history information, and the preference feature amount information that are acquired from the teacher information storage 15235 (step S16021).

Next, when the air conditioner 16004 determines that a predetermined update period of the weighting coefficient of the neural network realized by the neuro engine 404 has arrived, coefficient request information requesting, to the cloud server 16002, sending of the coefficient information is sent from the air conditioner 16004 to the cloud server 2 (step S16022). Meanwhile, when the cloud server 16002 receives the coefficient request information, the cloud server 16002 generates coefficient information including information expressing the weighting coefficient stored in the neural network storage 16233, and coefficient attribute information (step S16023). The respective structures of the coefficient information and the coefficient attribute information are the same as the structures described in Embodiment 3.

Next, the coefficient information and the coefficient attribute information that are generated are sent from the cloud server 16002 to the air conditioner 16004 (step S16024). Meanwhile, when the air conditioner 16004 receives the coefficient information and the coefficient attribute information, the air conditioner 16004 stores the received coefficient information and coefficient attribute information in the neural network storage 16436. Then, the air conditioner 16004 acquires the weighting coefficient information stored in the neural network storage 16436, and sets the weighting coefficient expressed by the acquired weighting coefficient information in the neuro engine 404.

Thereafter, it is assumed that the air conditioner 16004 receives a switching operation performed by the user for switching to the automatic mode (step S16025). In this case, the air conditioner 16004 sets the operation mode to the automatic mode (step S16026). Next, it is assumed that the air conditioner 16004 determines that an update period of the schedule information has arrived. In this case, weather record request information requesting, to the weather server 3, sending of weather record information is sent from the air conditioner 16004 to the weather server 3 (step S16027). Meanwhile, when the weather server 3 receives the weather record request information, the weather server 3 generates weather record information of the region in which the house H exists (step S16028). Next, the generated weather information is sent from the weather server 3 to the air conditioner 16004 (step S16029).

Then, the air conditioner 16004 uses the neural network in which the weighting coefficient is set to calculate the preference feature amount from the future weather condition expressed by the weather prediction information, the operation history information, and the environment history information. Moreover, the air conditioner 16004 identifies, from the plurality of types of schedule information stored in the schedule storage 16435, the schedule information corresponding to the calculated preference feature amount (step S16030). Then, the air conditioner 16004 updates, on the basis of the identified schedule information, the device setting information stored in the device setting storage 431 (step S16031). Thereafter, the processing of the aforementioned step S16031 is repeatedly executed every time the update period of the device setting information arrives.

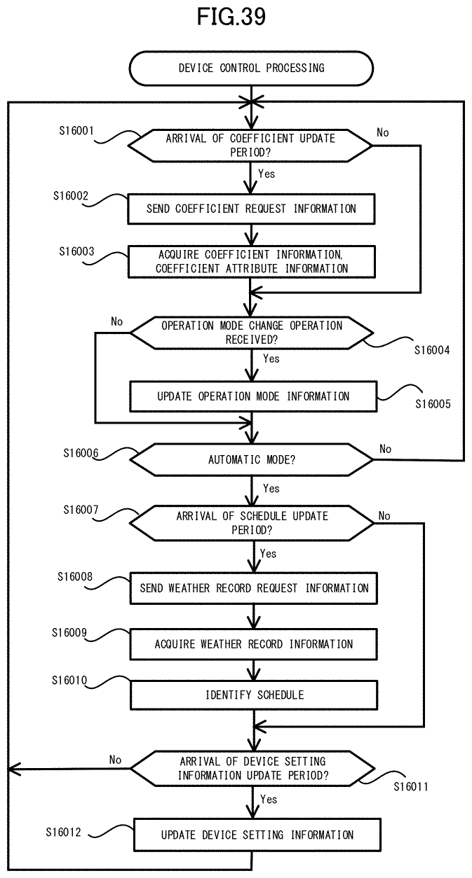

Next, device control processing executed by the air conditioner 16004 according to the present embodiment is described while referencing FIG. 39. In one example, this device control processing starts when the power to the air conditioner 16004 is turned ON.

Firstly, the coefficient acquirer 16423 determines whether a coefficient update period of the neural network has arrived (step S16001). When the coefficient acquirer 16423 determines that the coefficient update period has not arrived (step S16001; No), the processing of hereinafter described step S16004 is executed without modification. However, it is assumed that the coefficient acquirer 16423 determines that the coefficient update period has arrived (step S16001; Yes). In this case, the coefficient acquirer 16423 sends the coefficient request information to the cloud server 16002 (step S16002) to acquire the coefficient information and the coefficient attribute information from the cloud server 16002 (step S16003). The coefficient acquirer 2423 stores the coefficient information and the coefficient attribute information that are acquired in the neural network storage 16436.

Next the processing of steps S16004 and S16005 is executed. Here, the processing of steps S16004 and S16005 is the same as that of the processing of steps S105 and S106 described using FIG. 15 in Embodiment 1. Then, the schedule identifier 16425 references the operation mode information stored in the operation mode storage 433 to determine whether the operation mode of the air conditioner 16004 is the automatic mode (step S16006). When the schedule identifier 16425 determines that the operation mode of the air conditioner 16004 is the manual mode (step S16006; No), the processing of step S16001 is executed again.

However, it is assumed that the device setting updater 16425 determines that the operation mode of the air conditioner 16004 is the automatic mode (step S16006; Yes). In this case, the schedule identifier 16425 determines whether a predetermined update period of the operation schedule of the air conditioner 16004 has arrived (step S16007). When the schedule identifier 16425 determines that the update period of the operation schedule of the air conditioner 16004 has not arrived (step S16007; No), the processing of hereinafter described step S16011 is executed. However, it is assumed that the schedule identifier 16425 determines that the update period of the operation schedule of the air conditioner 16004 has arrived (step S16007; Yes). In this case, the weather information acquirer 2422 sends the weather record request information to the weather server 3 (step S16008) to acquire the weather record information from the weather server 3 (step S16009). Here, the weather information acquirer 2422 stores the acquired weather record information in the weather information storage 2437.

Thereafter, the neuro engine 404 calculates, on the basis of the operation history information, the environment history information, and the weather record information, the preference feature amount of the air conditioner 16004 using the neural network in which the weighting coefficient is set by the coefficient setter 16424. Moreover, the schedule identifier 16425 identifies the schedule information corresponding to the calculated preference feature amount (step S16010). Next, the device setting updater 16419 determines whether a predetermined update period of the device setting information of the air conditioner 16004 has arrived (step S16011). When the device setting updater 16419 determines that the update period of the device setting information has not arrived (step S16011; No), the processing of step S16101 is executed again. Meanwhile, when the device setting updater 16419 determines that the update period of the device setting information has arrived (step S16011; Yes), the device setting updater 16419 updates, on the basis of the schedule information identified by the schedule identifier 16425, the device setting information stored in the device setting storage 431 (step S16012). Then, the processing of step S16101 is executed again.

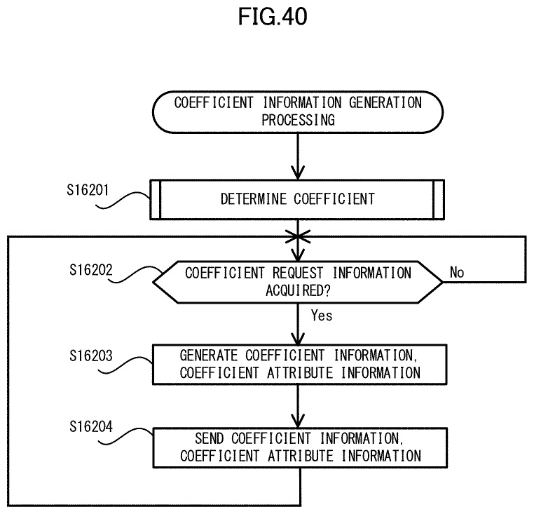

Next, coefficient information generation processing executed by the cloud server 16002 according to the present embodiment is described while referencing FIG. 40. After the power to the cloud server 16002 is turned ON, this coefficient information generation processing may, for example, be executed every time the operation history information, the environment history information, the weather record information, and the preference feature amount information stored in the teacher information storage 15235 are updated.

Firstly, coefficient determination processing is executed for determining the coefficient of the neural network on the basis of the operation history information, the environment history information, the weather record information, and the preference feature amount information that are acquired from the teacher information storage 15235 (step S16201). The content of the coefficient determination processing is the same as that of the coefficient determination processing described using FIG. 26 in Embodiment 2.

Then, the coefficient information generator 16218 determines whether the coefficient request information is acquired from the air conditioner 16004 (step S16202). When the coefficient information generator 16218 determines that the coefficient request information is not acquired (step S16202; No), the processing of step S16202 is executed again. Meanwhile, when the coefficient information generator 16218 determines that the coefficient request information is acquired (step S16202; Yes), the coefficient information generator 16218 generates coefficient information including the weighting coefficient information stored in the neural network storage 16233, and coefficient attribute information (step S16203). Next, the coefficient sender 16219 sends the coefficient information and the coefficient attribute information that are generated to the air conditioner 16004 (step S16204). Then, the processing of step S16202 is executed again.

As described above, with the control system according to the present embodiment, in the cloud server 16002, the coefficient determiner 16215 determines the weighting coefficient of the neural network and sends the coefficient information that includes the information expressing the determined weighting coefficient to the air conditioner 16004. In the air conditioner 16004, the neuro engine 404 uses the neural network, in which the weighting coefficient expressed by the coefficient information received from the cloud server 16002 is set, to calculate the preference feature amount that is the feature amount of the preference of the user of the air conditioner 16004, from the operation history information, the environment history information, and the weather record information. Then, the schedule identifier 16425 identifies the schedule information corresponding to the preference feature amount calculated by the neuro engine 404. Moreover, the device controller 414 controls the air conditioner 16004 in accordance with the operation schedule expressed by the schedule information. As a result, the air conditioner 16004 can be controlled as a result of the air conditioner 16004 merely sending the history information to the cloud server 16002 and acquiring the coefficient information from the cloud server 16002 every time the schedule update period arrives, and acquiring the weather information from the cloud server 16002 every time the coefficient information update period arrives. Therefore, the frequency at which the history information and the coefficient information are exchanged between the air conditioner 16004 and the cloud server 16002 is reduced, which leads to the benefit of a reduction of the effects, on the operations of the air conditioner 16004, of the communication traffic on the external network NT1.

### Embodiment 5

With a control system according to the present embodiment, a device determines a weighting coefficient of a neural network, and uses the neural network for which the weighting coefficient is determined to calculate a future device setting parameter of the device. Here, the neural network has a predetermined number of nodes and a predetermined number of layers, and is for calculating the future device setting parameter of the device. A server determines an initial coefficient that is a weighting coefficient initially set in the neural network used by the device. The server includes an initial coefficient determiner that determines the initial coefficient of the weighting coefficient of the neural network, and a coefficient sender that sends, to the device, coefficient information including initial coefficient information expressing the initial coefficient. Additionally, the device includes a coefficient acquirer that acquires the coefficient information; a history information acquirer that acquires operation history information and environment history information of the device; a weather information acquirer that acquires weather information including weather record information expressing a past weather condition and weather prediction information expressing a future weather condition; a coefficient determiner that determines the weather record information of the neural network on the basis of the initial coefficient information, the operation history information, the environment history information, and the weather record information; a neural network calculator that uses the neural network to calculate the future device setting parameter of the device from the future weather condition expressed by the weather prediction information and an environment parameter, included in the environment history information, indicating an environment at present; and a device controller that controls the device on the basis of the calculated device setting parameter.

As with the control system described using FIG. 1 in Embodiment 1, the control system according to the present embodiment includes an air conditioner and a water heater installed in a house H, and a cloud server that is capable of communicating with the air conditioner and the water heater via an external network NT1. Note that, in the present embodiment, constituents that are the same as in Embodiments 1 and 3 are denoted with the same reference numerals used in Embodiments 1 and 3. Additionally, it is assumed that an internal network NT2 is laid and a router and a data line terminal device that are connected to the internal network NT2 are installed in the house H. Furthermore, a customer server 3003 that manages customers that purchase the air conditioner, for example, is connected to the external network NT1.

The customer server 3003 includes a storage (not illustrated in the drawings) in which history information and device identification information that identifies the air conditioner are associated and stored. Here, the history information includes a history of device setting information of the air conditioner purchased by a customer and a history of environment information expressing an environment parameter including temperature information. Every time the customer server 3003 periodically receives the history information from the air conditioner purchased by the customer, the customer server 3003 associates the received history information with the device identification information, and stores the associated information in the storage, Additionally, when the customer server 3003 receives history request information from a cloud server 3002, the customer server 3003 identifies, from the history information stored in the storage, the operation history information and the environment history information that correspond to the history request information. In one example, the customer server 3003 identifies another house in which an air conditioner of the same model as the air conditioner 3004 is installed, and generates the history information including the operation history information and the environment history information of the air conditioner installed in the identified house. Note that a configuration is possible in which, for example, the operation history information and the environment history information included in the history information express a history of an average of the device setting parameter and a history of an average of the environment parameter of a plurality of households in which air conditioners, of the same model as the air conditioner 3004 installed in the house H, are installed.

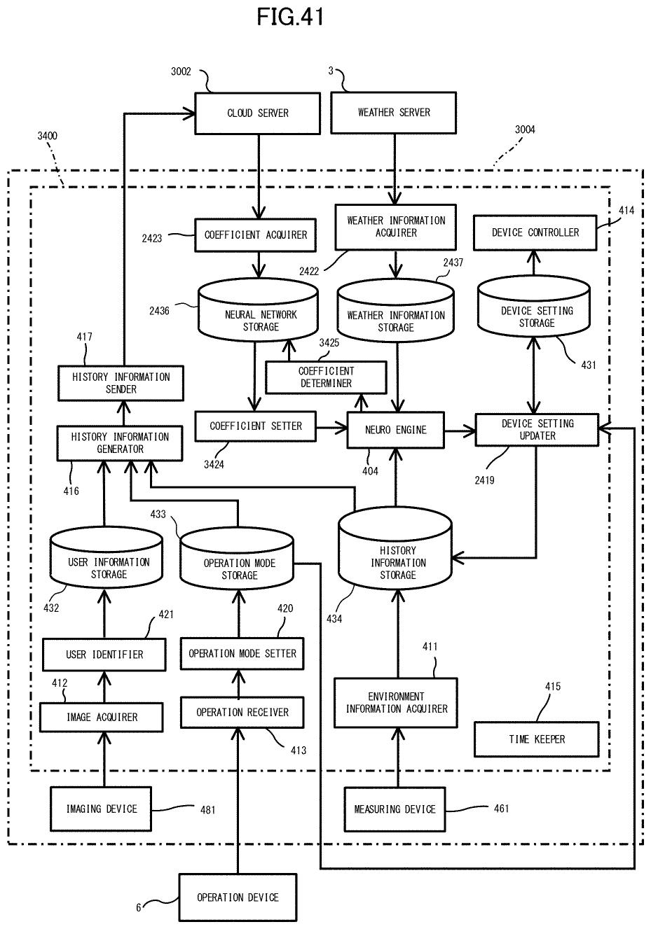

The hardware configuration of the air conditioner 3004 according to the present embodiment is the same as the hardware configuration of the air conditioner 2004 illustrated in FIG. 28 of Embodiment 3. The controller 3400 includes a CPU (not illustrated), a main storage (not illustrated), an auxiliary storage (not illustrated), a communication interface (not illustrated), a measuring device interface (not illustrated), a wireless module (not illustrated), an imaging interface (not illustrated), a neuro engine 404, and a bus (not illustrated) that connects these components to each other. In the controller 3400, the CPU reads out a program stored in the auxiliary storage to the main storage and executes the program to function as an environment information acquirer 411, an image acquirer 412, an operation receiver 413, a device controller 414, a time keeper 415, a history information generator 416, a history information sender 417, a device setting updater 2419, an operation mode setter 420, a user identifier 421, a weather information acquirer 2422, a coefficient acquirer 2423, a coefficient determiner 3425, and a coefficient setter 3424, as illustrated in FIG. 41. Note that, in FIG. 41, the constituents that are the same as in Embodiments 1 and 3 are denoted with the same reference numerals as used in FIGS. 3 and 30. Additionally, the auxiliary storage includes a device setting storage 431, a user information storage 432, an operation mode storage 433, a history information storage 434, a neural network storage 2436, and a weather information storage 2437. Note that the CPU, the main storage, and the auxiliary storage are the same as the CPU 401, the main storage 402, and the auxiliary storage 403 illustrated in FIG. 28. The coefficient acquirer 2423 acquires, from the cloud server 3002 via the external network NT1, coefficient information including initial weighting coefficient information expressing an initial weighting coefficient of the neural network set initially in the neuro engine 404. Here, the coefficient acquirer 2423 acquires the coefficient information including the initial weighting coefficient information from the cloud server 3002 by sending coefficient request information requesting, to the cloud server 3002, sending of the coefficient information.

The coefficient determiner 3425 determines the weighting coefficient of the neural network on the basis of the operation history information, the environment history information, and the weather record information. Firstly, the coefficient determiner 3425 acquires the initial weighting coefficient information from the neural network storage 2436. Then, the coefficient setter 3424 sets, in the neuro engine 404, the weighting coefficient expressed by the initial weighting coefficient information acquired by the coefficient determiner 3425. Next, the coefficient determiner 3425 acquires the device setting parameter calculated by the neuro engine 404 on the basis of a past environment parameter expressed by the environment history information, a date and time expressed by date and time information, and information obtained by quantifying the past weather condition expressed by the weather record information. Next, the coefficient determiner 3425 acquires a past device setting parameter expressed by the operation history information stored in the history information storage 434, and calculates an error from the device setting parameter calculated by the neuro engine 404. Then, the coefficient determiner 3425 determines, on the basis of the calculated error, the weighting coefficient of the neural network by the backpropagation method.

The coefficient setter 3424 sets the weighting coefficient determined by the coefficient determiner 3425 as the weighting coefficient of the neural network. The neuro engine 404 uses the neural network to calculate the future device setting parameter of the air conditioner 3004 from the weather prediction information and the environment parameter indicating the environment at present included in the environment history information.

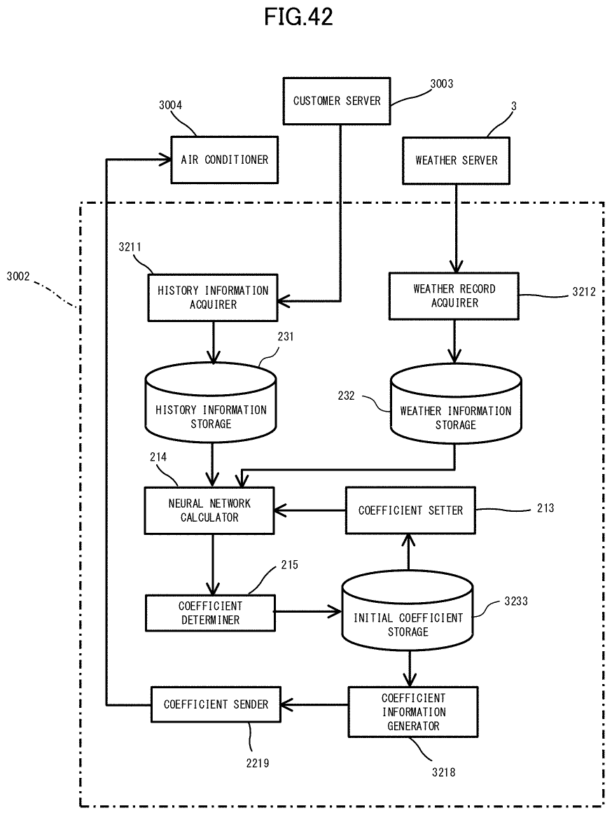

The hardware configuration of the cloud server 3002 is the same as the hardware configuration of the cloud server 2 of Embodiment 1 illustrated in FIG. 10. The CPU 201 illustrated in FIG. 10 reads out a program stored in the auxiliary storage 203 to the main storage 202 and executes the program to function as a history information acquirer 3211, a weather record acquirer 3212, a coefficient setter 213, a neural network calculator 214, a coefficient determiner 215, a coefficient information generator 3218, and a coefficient sender 3219, as illustrated in FIG. 42. Note that, in FIG. 42, the constituents that are the same as in Embodiment 3 are denoted with the same reference numerals as used in FIG. 31. Additionally, as illustrated in FIG. 42, the auxiliary storage 203 illustrated in FIG. 10 includes a history information storage 231, a weather information storage 232, and an initial coefficient storage 3233. The initial coefficient storage 3233 stores information expressing the initial coefficient of the neural network determined on the basis of the weather record information and the history information including the operation history information and the environment history information of the air conditioner of the other house in which the air conditioner, of the same model as the air conditioner 3004 installed in the house H, is installed.

The history information acquirer 3211 acquires the history information including the operation history information and the environment history information of the air conditioner of the other house in which the air conditioner, of the same model as the air conditioner 3004 installed in the house H, is installed. In one example, the history information acquirer 3211 acquires the history information, via the external network NT1, from the customer server 3003 that manages customers that purchase the air conditioner. The weather record acquirer 3212 acquires the weather record information, expressing the past weather condition of the region in which the house of the household exists, corresponding to the history information. Here, the weather record acquirer 3212 acquires the weather record information from the weather server 3 via the external network NT1. As in Embodiment 1, the coefficient determiner 215 determines the weighting coefficient of the neural network on the basis of the history information and the weather record information. The coefficient information generator 3218 generates coefficient information that includes information expressing the weighting coefficient determined by the coefficient determiner 215 and information expressing that the weighting coefficient is the initial coefficient. The coefficient sender 3219 sends the coefficient information generated by the coefficient information generator 3218 to the air conditioner 3004 via the external network NT1.

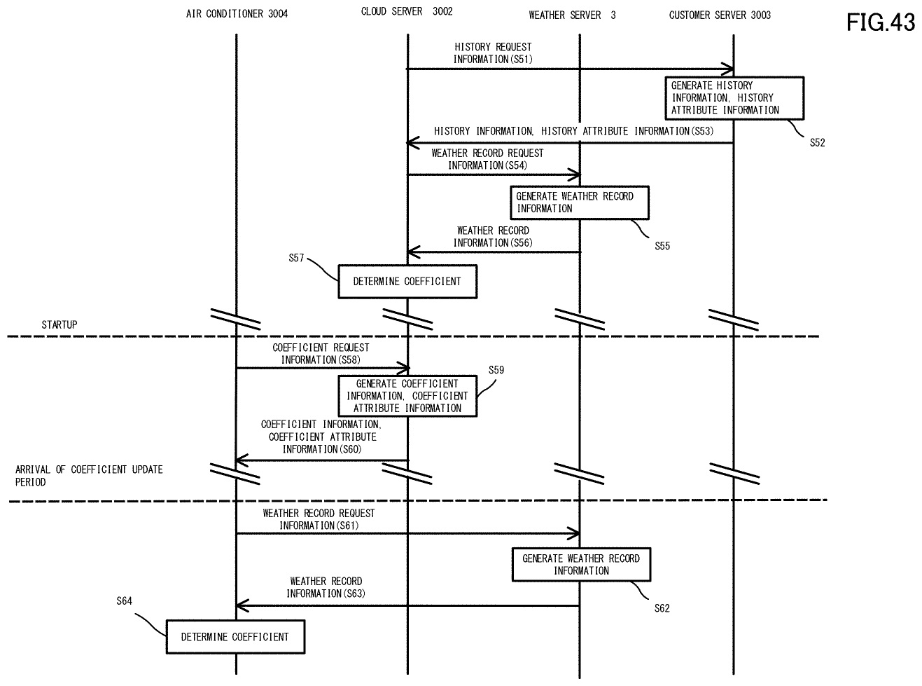

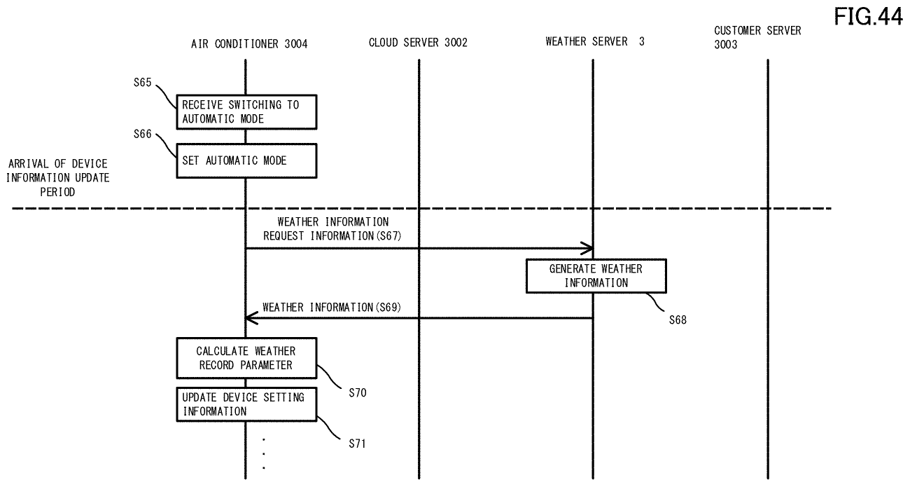

Next, the operations of the control system according to the present embodiment are described while referencing FIGS. 43 and 44. Firstly, as illustrated in FIG. 43, history request information requesting, to the customer server 3003, sending of the history information is sent from the cloud server 3002 to the customer server 3003 (step S51). Here, the history information includes the operation history information and the environment history information of the air conditioner of the other house in which the air conditioner, of the same model as the air conditioner 3004, is installed. Meanwhile, when the customer server 3003 receives the history request information, the customer server 3003 identifies the other house in which the air conditioner, of the same model as the air conditioner 3004, is installed, and generates history information including the operation history information and the environment history information of the air conditioner installed in the identified house, and history attribute information (step S52). Next, the history information and the history attribute information that are generated are sent from the customer server 3003 to the cloud server 3002 (step S53).

Next, a weather record information request requesting, to the weather server 3, sending of the weather record information is sent from the cloud server 3002 to the weather server 3 (step S54). Meanwhile, when the weather server 3 receives the weather record request information, the weather server 3 generates weather record information of the region in which the house H exists (step S55). Here, the weather record information is weather record information, expressing the past weather condition of the region in which the house of the household exists, that corresponds to the history information. Then, the generated weather record information is sent from the weather server 3 to the cloud server 3002 (step S56). Meanwhile, when the cloud server 3002 receives the weather record information, the cloud server 2 stores the received weather record information in the weather information storage 232. Then, the cloud server 3002 determines, as the initial coefficient, the weighting coefficient of the neural network on the basis of the operation history information, the environment history information, and the weather record information that are acquired (step S57). The cloud server 3002 stores the initial weighting coefficient information expressing the determined initial weighting coefficient in the initial coefficient storage 3233.

Next, it is assumed that a new air conditioner 3004 is installed in the house H and is started up. At this time, coefficient request information requesting, to the weather server 3002, sending of the initial coefficient is sent from the air conditioner 3004 to the weather server 3002 (step S58). Meanwhile, when the cloud server 3002 receives the coefficient request information, the cloud server 3002 generates coefficient information including the initial weighting coefficient information stored in the initial coefficient storage 3233, and coefficient attribute information (step S59). The structures of the coefficient information and the coefficient attribute information are the same as the structures of the coefficient information and the coefficient attribute information described using FIG. 33 in Embodiment 3. Next, the coefficient information and the coefficient attribute information that are generated are sent from the cloud server 3002 to the air conditioner 3004 (step S60). Meanwhile, when the air conditioner 3004 receives the coefficient information and the coefficient attribute information, the air conditioner 3004 stores the received coefficient information and coefficient attribute information in the neural network storage 2436.

Thereafter, it is assumed that the air conditioner 3004 determines that a predetermined update period of the weighting coefficient of the neural network has arrived. In this case, weather record request information requesting, to the weather server 3, sending of the weather record information is sent from the air conditioner 3004 to the weather server 3 (step S61) and, meanwhile, when the weather server 3 receives the weather record request information, the weather server 3 generates the weather record information for the region in which the house H exists (step S62). Next, the generated weather record information is sent from the weather server 3 to the air conditioner 3004 (step S63). Meanwhile, when the air conditioner 3004 receives the weather record information, the air conditioner 3004 stores the received weather record information in the weather information storage 2437. Then, the air conditioner 3004 determines the weighting coefficient of the neural network on the basis of the operation history information, the environment history information, the date and time information, the user information, and the weather record information that are acquired (step S64). The air conditioner 3004 stores weighting coefficient information expressing the determined weighting coefficient in the neural network storage 2436. Thereafter, the series of processing from step S61 to step S64 is repeatedly executed every time the update period of the weighting coefficient of the neural network arrives.

Next, as illustrated in FIG. 44, it is assumed that the air conditioner 3004 receives a switching operation performed by the user for switching to the automatic mode (step S65). In this case, the operation mode is set to the automatic mode by the air conditioner 3004 storing, in the operation mode storage 433, operation mode information expressing that the operation mode is the automatic mode (step S66).

Then, it is assumed that the air conditioner 3004 determines that the update period of device setting information of the air conditioner 3004 has arrived. In this case, weather information request information requesting, to the weather server 3, sending of the weather information including the weather prediction information and the weather record information is sent from the air conditioner 3004 to the weather server 3 (step S67). Meanwhile, when the weather server 3 receives the weather information request information, the weather server 3 identifies the weather prediction information and the weather record information of the region in which the house H exists, and generates the weather information including the weather prediction information and the weather record information that are identified (step S68). Next, the generated weather information is sent from the weather server 3 to the air conditioner 3004 (step S69).

Next, the air conditioner 3004 uses the neural network, in which the weighting coefficient is set to calculate the future device setting parameter of the air conditioner 3004 from the weather prediction information and the environment parameter indicating the environment at present included in the environment history information (step S70). Then, the air conditioner 3004 uses the calculated device setting parameter to update the device setting information stored in the device setting storage 431 (step S71). Thereafter, the series of processing from step S67 to step S71 is repeatedly executed every time the update period of the device setting information arrives.

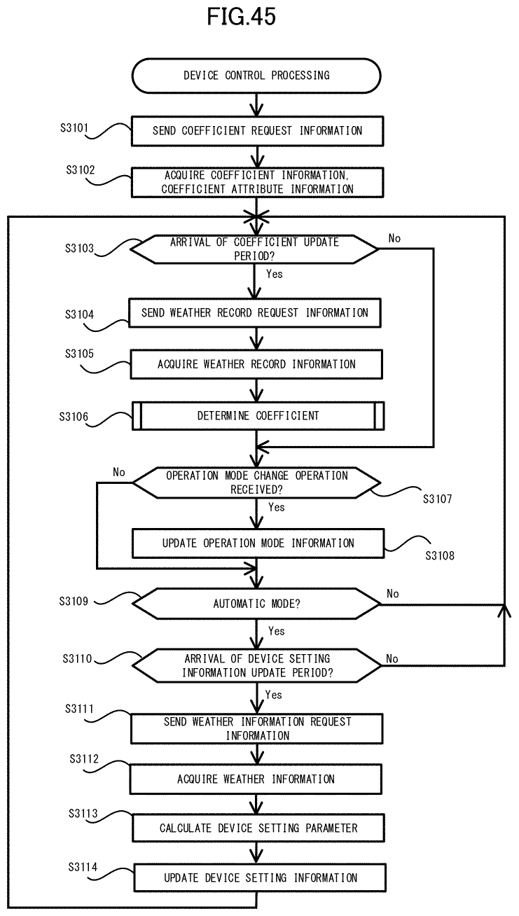

Next, device control processing executed by the air conditioner 3004 according to the present embodiment is described while referencing FIG. 45. In one example, this device control processing starts when the power to the air conditioner 3004 is turned ON.

Firstly, the coefficient acquirer 2423 sends coefficient request information to the cloud server 3002 (step S3101) to acquire, from the cloud server 3002, the coefficient information including the initial weighting coefficient information of the neural network and the coefficient attribute information (step S3102). The coefficient acquirer 2423 stores the initial weighting coefficient information included in the coefficient information and the coefficient attribute information that are acquired in the neural network storage 2436.

Next, the coefficient determiner 3425 determines whether a coefficient update period of the neural network has arrived (step S3103). When the coefficient determiner 3425 determines that the coefficient update period has not arrived (step S3103; No), the processing of hereinafter described step S3110 is executed without modification. However, it is assumed that the coefficient determiner 3425 determines that the coefficient update period has arrived (step S3103; Yes). In this case, the weather information acquirer 2422 sends the weather record request information to the weather server 3 (step S3104) to acquire the weather record information from the weather server 3 (step S3105). The weather information acquirer 2422 stores the acquired weather record information in the weather information storage 2437. Thereafter, coefficient determination processing is executed (step S3106). The content of this coefficient determination processing is the same as that of the coefficient determination processing described using FIG. 17 in Embodiment 1.

Next the processing of steps S3107 and S3108 is executed. The content of the processing of steps S3107 and S3108 is the same as that of the processing of steps S105 and S106 described using FIG. 15 in Embodiment 1. Then, the device setting updater 2419 references the operation mode information stored in the operation mode storage 433 to determine whether the operation mode of the air conditioner 3004 is the automatic mode (step S3109). When the device setting updater 2419 determines that the operation mode of the air conditioner 3004 is the manual mode (step S3109; No), the processing of step S3103 is executed again. However, when the device setting updater 2419 determines that the operation mode of the air conditioner 3004 is the automatic mode (step S3109; Yes), the device setting updater 2419 determines whether a predetermined update period of the device setting information of the air conditioner 3004 has arrived (step S3110). When the device setting updater 2419 determines that the update period of the device setting information of the air conditioner 3004 has not arrived (step S3110; No), the processing of step S3103 is executed again. However, it is assumed that the device setting updater 2419 determines that the update period of the device setting information of the air conditioner 3004 has arrived (step S3110; Yes). In this case, the series of processing from step S3111 to step S3114 is executed. Here, the content of the series of processing from step S3111 to step S3114 is the same as the series of processing from step S2112 to step S2115 described using FIG. 34 in Embodiment 3. Then, the processing of step S3103 is executed again.

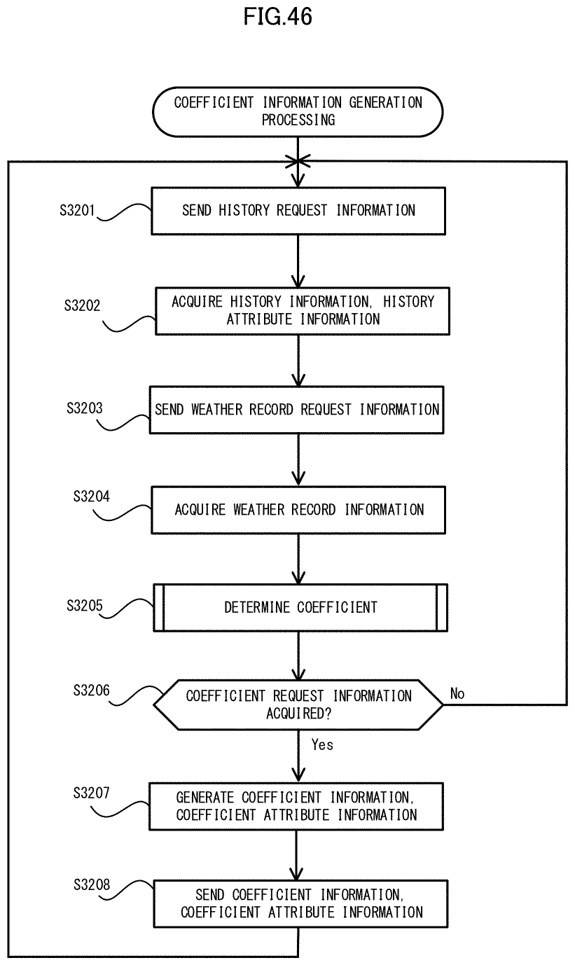

Next, coefficient information generation processing executed by the cloud server 3002 according to the present embodiment is described while referencing FIG. 46. In one example, this coefficient information generation processing starts when the power to the cloud server 3002 is turned ON.

Firstly, the history information acquirer 3211 sends, to the customer server 3003, history request information requesting, to the customer server 3003, sending of the history information including the operation history information and the environment history information of an air conditioner of the same model as the air conditioner 3004 installed in the house H (step S3201) to acquire the history information and the history attribute information from the customer server 3003 (step S3202). Next, the weather record acquirer 2212 sends weather record request information requesting sending, to the weather server 3, of the weather record information (step S3203) to acquire the weather record information from the weather server 3 (step S3204). Next, coefficient determination processing for determining, on the basis of the operation history information and the environment history information included in the history information and the weather record information, the coefficient of the neural network described above is executed (step S3205). The content of the coefficient determination processing is the same as that of the coefficient determination processing described using FIG. 17 in Embodiment 1. The initial weighting coefficient information expressing the initial weighting coefficient calculated by this coefficient determination processing is stored in the initial coefficient storage 3233.

Thereafter, the coefficient information generator 3218 determines whether the coefficient request information is acquired from the air conditioner 3004 (step S3206). When the coefficient information generator 3218 determines that the coefficient request information is not acquired (step S3206; No), the processing of step S3201 is executed again. Meanwhile, when the coefficient information generator 3218 determines that the coefficient request information is acquired (step S3206; Yes), the coefficient information generator 3218 generates the coefficient information including the initial weighting coefficient information stored in the initial coefficient storage 3233, and the coefficient attribute information (step S3207). Thereafter, the coefficient sender 3219 sends the coefficient information and the coefficient attribute information that are generated to the air conditioner 3004 (step S3208). Then, the processing of step S3201 is executed again.

As described above, with the control system according to the present embodiment, in the cloud server 3002, the coefficient determiner 215 determines the initial coefficient of the neural network and sends, to the air conditioner 3004, the coefficient information that includes the information expressing the determined initial coefficient. Additionally, in the air conditioner 3004, the coefficient setter 2121 sets the weighting coefficient of the neural network to the initial coefficient only one time after startup of the air conditioner 3004. Then, in the air conditioner 3004, the coefficient determiner 3122 updates the weighting coefficient of the neural network. Moreover, the neuro engine 2104 uses the neural network, for which the weighting coefficient is updated by the coefficient determiner 3122, to calculate the future device setting parameter of the air conditioner 3004 from the weather prediction information and the environment parameter at present included in the environment history information. Then, the device setting updater 2419 updates the device setting information stored in the device setting storage 431 using the device setting information generated on the basis of the device setting parameter calculated by the neuro engine 2104. Thus, the device controller 414 of the air conditioner 3004 controls the air conditioner 3004 using the device setting parameter calculated by the neuro engine 2104. As a result, the device controller 414 can control the air conditioner 3004 by merely acquiring the weather information from the cloud server 2002. Therefore, the amount of information exchanged between the air conditioner 3004 and the cloud server 3002 is reduced, which leads to the benefit of a reduction of the effects, on the operations of the air conditioner 3004, of the communication traffic on the external network NT1.

### Embodiment 6

With a control system according to the present embodiment, a device determines a weighting coefficient of a neural network, and uses a second neural network for which the weighting coefficient is determined to calculate a preference feature amount that indicates a feature amount of a preference of a user of the device. Here, the neural network has a predetermined number of nodes and a predetermined number of layers, and is for calculating the preference feature amount of the device. The server manages teacher information that is used when determining the weighting coefficient of the second neural network in the device. The server includes a teacher information identifier that identifies the teacher information to be used when determining the weighting coefficient of the second neural network, and a teacher information sender that sends the teacher information to the device. Additionally, the device includes a teacher information acquirer that acquires the teacher information; a history information acquirer that acquires operation history information and environment history information of the device; a weather information acquirer that acquires weather information including weather record information expressing a past weather condition and weather prediction information expressing a future weather condition; a coefficient determiner that determines the weighting coefficient of the second neural network on the basis of the teacher information; a neural network calculator that uses the second neural network to calculate the preference feature amount from the operation history information, the environment history information, and the weather record information; and a schedule identifier that identifies schedule information corresponding to the calculated preference feature amount.

As with the control system described using FIG. 1 in Embodiment 1, the control system according to the present embodiment includes an air conditioner and a water heater installed in a house H, and a cloud server that is capable of communicating with the air conditioner and the water heater via an external network NT1. Note that, in the present embodiment, constituents that are the same as in Embodiments 4 and 5 are denoted with the same reference numerals used in Embodiments 4 and 5. Additionally, it is assumed that an internal network NT2 is laid and a router and a data line terminal device that are connected to the internal network NT2 are installed in the house H.

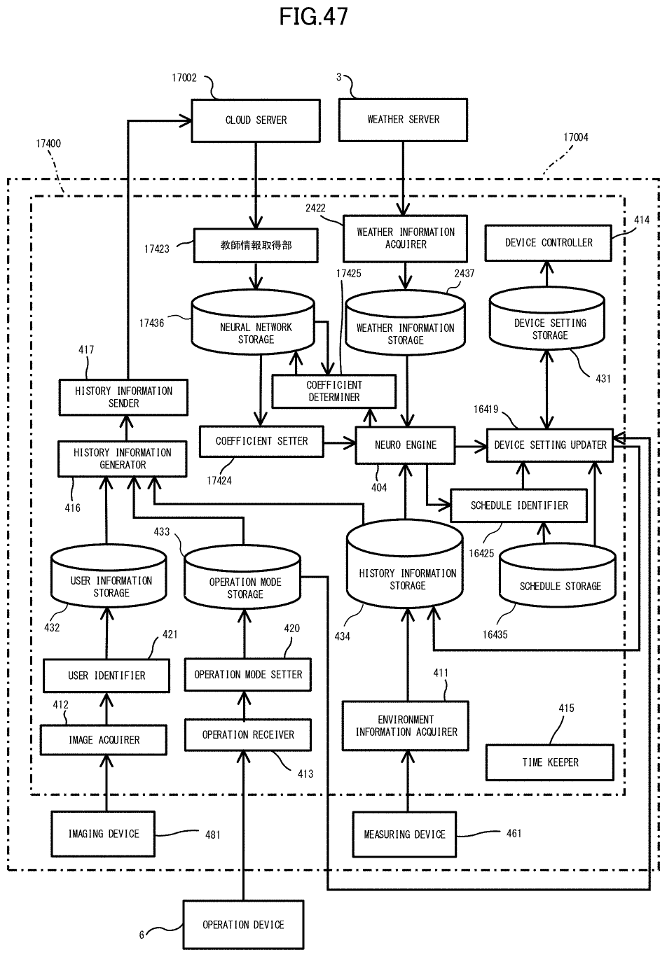

The hardware configuration of the air conditioner 17004 according to the present embodiment is the same as the hardware configuration of the air conditioner 2004 illustrated in FIG. 28 of Embodiment 2. In a device controller 17400, the CPU reads out a program stored in an auxiliary storage to a main storage and executes the program to function as an environment information acquirer 411, an image acquirer 412, an operation receiver 413, a device controller 414, a time keeper 415, a history information generator 416, a history information sender 417, a device setting updater 2419, an operation mode setter 420, a user identifier 421, a weather information acquirer 2422, a teacher information acquirer 17423, a coefficient setter 17424, a coefficient determiner 17425, and a schedule identifier 16425, as illustrated in FIG. 47. Note that, in FIG. 47, the constituents that are the same as in Embodiments 4 and 5 are denoted with the same reference numerals as used in FIGS. 36 and 41. Additionally, the auxiliary storage includes a device setting storage 431, a user information storage 432, an operation mode storage 433, a history information storage 434, a neural network storage 17436, a weather information storage 2437, and a schedule storage 16435. Note that the CPU, the main storage, and the auxiliary storage are the same as the CPU 401, the main storage 402, and the auxiliary storage 403 illustrated in FIG. 28. As described above, the schedule storage 16435 associates a plurality of types of schedule information with the preference feature amount, and stores the associated information. Additionally, the neural network storage 17436 stores the weighting coefficient of the neural network together with the teacher information that is acquired from a cloud server 17002 and is used by the coefficient determiner 17425 to determine the neural network coefficient.

The teacher information acquirer 17423 acquires the teacher information from the cloud server 17002. Here, the teacher information acquirer 17423 acquires the teacher information from the cloud server 17002 by sending teacher information request information requesting, to the cloud server 17002, sending of the teacher information. Additionally, the teacher information acquirer 17423 stores the acquired teacher information in the neural network storage 17436.

The coefficient determiner 17425 determines the weighting coefficient of the neural network on the basis of the teacher information. Firstly, the coefficient determiner 17425 sets a predetermined initial weighting coefficient in the neuro engine 404. Next, the coefficient determiner 17425 acquires the preference feature amount that the neuro engine 404 calculates on the basis of the operation history information, the environment history information, and the weather record information included in the teacher information stored in the neural network storage 17436. Then, the coefficient determiner 17425 calculates an error between the preference feature amount included in the teacher information stored in the neural network storage 17436 and the preference feature amount calculated by the neuro engine 404. Then, the coefficient determiner 17425 determines, on the basis of the calculated error, the weighting coefficient of the neural network by the backpropagation method.

The coefficient setter 17424 sets the weighting coefficient determined by the coefficient determiner 17425 as the weighting coefficient of the neural network. Then, the neuro engine 404 uses the neural network in which the weighting coefficient is set to calculate the preference feature amount from the operation history information, the environment history information, and the weather record information.

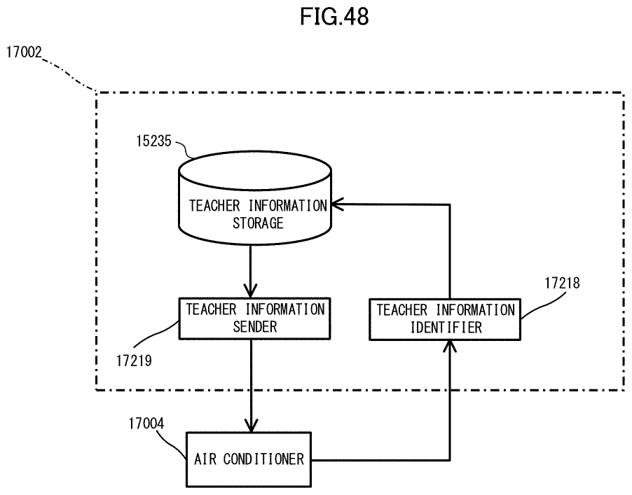

The hardware configuration of the cloud server 17002 is the same as the hardware configuration of the cloud server 2 of Embodiment 1 illustrated in FIG. 10. With the cloud server 17002, the CPU reads out a program stored in the auxiliary storage to the main storage and executes the program to function as a teacher information identifier 17218 and a teacher information sender 17219, as illustrated in FIG. 48. Additionally, the auxiliary storage includes a teacher information storage 15235. Note that the CPU, the main storage, and the auxiliary storage are the same as the CPU 201, the main storage 202, and the auxiliary storage 203 illustrated in FIG. 10. As in Embodiment 2, the teacher information storage 15235 stores teacher information that is used by the coefficient determiner 16213 to determine the neural network coefficient. When the teacher information identifier 17218 acquires, from the air conditioner 17004, the teacher information request information requesting sending of the teacher information, the teacher information identifier 17218 identifies, from among the plurality of types of teacher information stored in the teacher information storage 15235, the teacher information corresponding to the teacher information request information. The teacher information sender 17219 sends the identified teacher information to the air conditioner 17004 that is the sender of the teacher information request information.

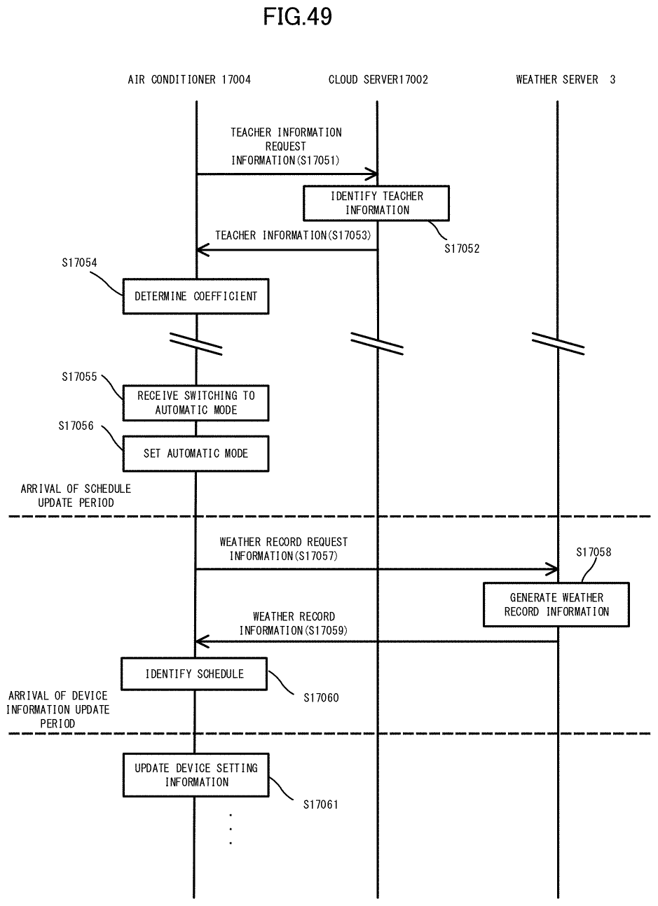

Next, the operations of the control system according to the present embodiment are described while referencing FIG. 49. Firstly, it is assumed that a new air conditioner 17004 is installed in the house H and is started up. At this time, teacher information request information requesting, to the cloud server 17002, sending of the teacher information is sent from the air conditioner 17004 to the cloud server 17002 (step S17051). When the cloud server 17002 receives the teacher information request information, the cloud server 17002 identifies, from among the plurality of types of teacher information stored in the teacher information storage 15235, the teacher information corresponding to the air conditioner 17004 (step S17052). Then, the identified teacher information is sent from the cloud server 17002 to the air conditioner 17004 (step S17053). Meanwhile, when the air conditioner 17004 receives the teacher information, the air conditioner 17004 stores the received teacher information in the neural network storage 17436. Next, the air conditioner 17004 determines the weighting coefficient of the neural network on the basis of the teacher information stored in the neural network storage 17436 (step S17054).

Next, it is assumed that the air conditioner 17004 receives a switching operation performed by the user for switching to the automatic mode (step S17055). In this case, the operation mode is set to the automatic mode by the air conditioner 17004 storing, in the operation mode storage 433, operation mode information expressing that the operation mode is the automatic mode (step S17056).

Then, it is assumed that the air conditioner 17004 determines that an update period of the schedule information has arrived. In this case, weather record request information requesting, to the weather server 3, sending of the weather record information is sent from the air conditioner 17004 to the weather server 3 (step S17057). Meanwhile, when the weather server 3 receives the weather record request information, the weather server 3 generates the weather record information of the region in which the house H exists (step S17058). Next, the generated weather information is sent from the weather server 3 to the air conditioner 17004 (step S17059).

Thereafter, the air conditioner 17004 uses the neural network in which the weighting coefficient is set to calculate the preference feature amount from the operation history information, the environment history information, and the weather record information. Moreover, the air conditioner 16004 identifies, from the plurality of types of schedule information stored in the schedule storage 16435, the schedule information corresponding to the calculated preference feature amount (step S17060). Then, the air conditioner 17004 updates, on the basis of the identified schedule information, the device setting information stored in the device setting storage 431 (step S17061). Thereafter, the processing of the aforementioned step S17061 is repeatedly executed every time an update period of the device setting information arrives.

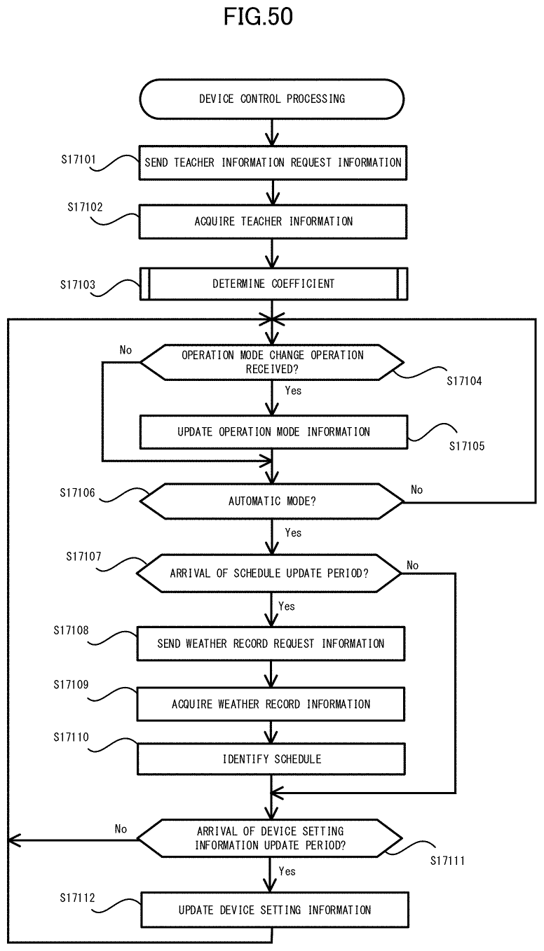

Next, device control processing executed by the air conditioner 17004 according to the present embodiment is described while referencing FIG. 50. In one example, this device control processing starts when the power to the air conditioner 17004 is turned ON. Firstly, the teacher information acquirer 17423 sends the teacher information request information to the cloud server 17002 (step S17101) to acquire the teacher information from the cloud server 17002 (step S17102). The teacher information acquirer 17423 stores the acquired teacher information in the neural network storage 17436.

Next, coefficient determination processing for determining the weighting coefficient of the neural network on the basis of the teacher information is executed (step S17103). The content of this coefficient determination processing is the same as that of the coefficient determination processing described using FIG. 26 in Embodiment 2. Then, the processing of steps S17104 and S17105 is executed. Here, the processing of steps S17104 and S17105 is the same as that of the processing of steps S105 and S106 described using FIG. 15 in Embodiment 1. Then, the device setting updater 16419 references the operation mode information stored in the operation mode storage 433 to determine whether the operation mode of the air conditioner 17004 is the automatic mode (step S17106). When the device setting updater 16419 determines that the operation mode of the air conditioner 17004 is the manual mode (step S17106; No), the processing of step S17104 is executed again. However, it is assumed that the device setting updater 16419 determines that the operation mode of the air conditioner 17004 is the automatic mode (step S17106; Yes). In this case, the schedule identifier 16425 determines whether a predetermined schedule update period of the air conditioner 17004 has arrived (step S17107). When the schedule identifier 16425 determines that the schedule update period of the air conditioner 17004 has not arrived (step S17105; No), the processing of hereinafter described step S17111 is executed.

However, it is assumed that the schedule identifier 16425 determines that the schedule update period of the air conditioner 17004 has arrived (step S17107; Yes). In this case, the weather information acquirer 2422 sends, to the weather server 3, the weather record request information (step S17108) to acquire the weather record information (step S17109). Next, the neuro engine 404 uses the neural network to calculate the preference feature amount from the operation history information, the environment history information, and the weather prediction information. Moreover, the schedule identifier 16425 identifies, from the plurality of types of schedule information stored in the schedule storage 16435, the schedule information corresponding to the calculated preference feature amount (step S17110).

Thereafter, the device setting updater 16419 determines whether an update period of the device setting information of the air conditioner 17004 has arrived (step S17111). When the device setting updater 16419 determines that the update period of the device setting information of the air conditioner 17004 has not arrived (step S17111; No), the processing of step S17104 is executed again. However, it is assumed that the device setting updater 16419 determines that the update period of the device setting information of the air conditioner 17004 has arrived (step S17111; Yes). In such a case, the device setting updater 16419 updates, on the basis of the schedule information identified by the schedule identifier 16426, the device setting information stored in the device setting storage 431 (step S17112). Then, the processing of step S17104 is executed again.

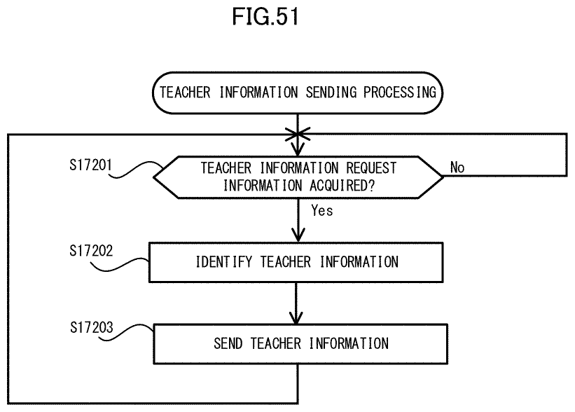

Next, teacher information sending processing executed by the cloud server 17002 according to the present embodiment is described while referencing FIG. 51. In one example, this teacher information sending processing starts when the power to the cloud server 17002 is turned ON. Firstly, the teacher information identifier 17218 determines whether the teacher information request information requesting sending of the teacher information is acquired from the air conditioner 17004 (step S17201). When the teacher information identifier 17218 determines that the teacher information request information is not acquired (step S17201; No), the processing of step S17201 is executed again. Meanwhile, when the teacher information identifier 17218 determines that the teacher information request information is acquired (step S17201; Yes), the teacher information identifier 17218 identifies, from among the plurality of types of teacher information stored in the teacher information storage 15235, the teacher information corresponding to the teacher information request information (step S17202). Next, the teacher information sender 17219 sends the identified teacher information to the air conditioner 17004 that is the sender of the teacher information request information (step S17203). Then, the processing of step S17201 is executed again.

As described above, with the control system according to the present embodiment, in the cloud server 17002, the coefficient determiner 16215 determines the initial coefficient of the neural network and sends, to the air conditioner 17004, the coefficient information that includes the determined initial weighting coefficient information. Additionally, in the air conditioner 17004, the coefficient setter 17424 sets the weighting coefficient of the neural network to the initial weighting of coefficient expressed in the initial weighting coefficient information only one time after startup of the air conditioner 17004. Then, in the air conditioner 17004, the coefficient determiner 17425 updates the weighting coefficient of the neural network. Then, the neuro engine 404 uses the neural network, for which the weighting coefficient is updated by the coefficient determiner 17425, to calculate the preference feature amount from the weather prediction information, the operation history information, and the environment history information. Moreover, the schedule identifier 16425 identifies, from the plurality of types of schedule information stored in the schedule storage 16435, the schedule information corresponding to the calculated preference feature amount. Additionally, the device setting updater 16419 updates, on the basis of the schedule information identified by the schedule identifier 16425, the device setting information stored in the device setting storage 431. Thus, the device controller 17400 of the air conditioner 17004 controls the air conditioner 17004 in accordance with the schedule corresponding to the preference feature amount calculated by the neuro engine 404. As a result, the device controller 414 can control the air conditioner 17004 by merely acquiring the weather information from the cloud server 17002 every time a coefficient information update period arrives. Therefore, the amount of information exchanged between the air conditioner 17004 and the cloud server 17002 is reduced, which leads to the benefit of a reduction of the effects, on the operations of the air conditioner 17004, of the communication traffic on the external network NT1.

### Embodiment 7

With a control system according to the present embodiment, a device determines a weighting coefficient of a neural network, and uses the neural network for which the weighting coefficient is determined to calculate a preference feature amount that is a feature amount of a preference of a user. Here, the neural network has a predetermined number of nodes and a predetermined number of layers, and is for calculating the preference feature amount that is a feature amount of a preference of a user. Additionally, the device includes a neural network calculator that uses the neural network to calculate the preference feature amount from weather prediction information, operation history information, and environment history information, a schedule identifier that identifies schedule information corresponding to the calculated preference feature amount, and a preference feature amount sender that sends the calculated preference feature amount to another device.

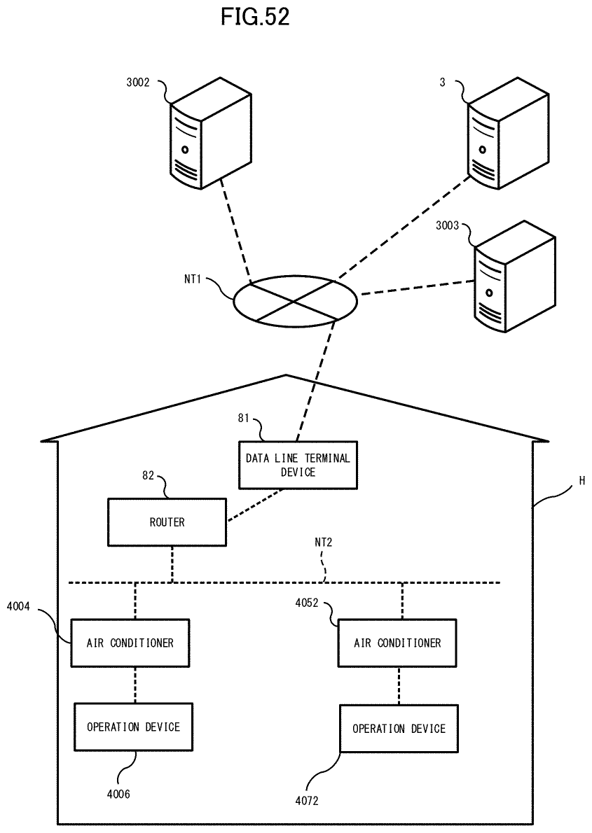

As illustrated in FIG. 52, the control system according to the present embodiment includes an air conditioner 4004, a cloud server 3002 capable of communicating with the air conditioner 4004 via an external network NT1, and an air conditioner 4052 capable of communicating with the air conditioner 4004 via an internal network NT2. Note that, in FIG. 52, the constituents that are the same as in Embodiment 1 are denoted with the same reference numerals as used in FIG. 1. A weather server 3 and the customer server 3003 described in Embodiment 3 are connected to the external network NT1. Operation devices 4006, 4072 for operating the air conditioners 4004, 4052 are installed in the house H. Additionally, as in Embodiment 1, a router 82 and a data line terminal device 81 are installed in the house H.

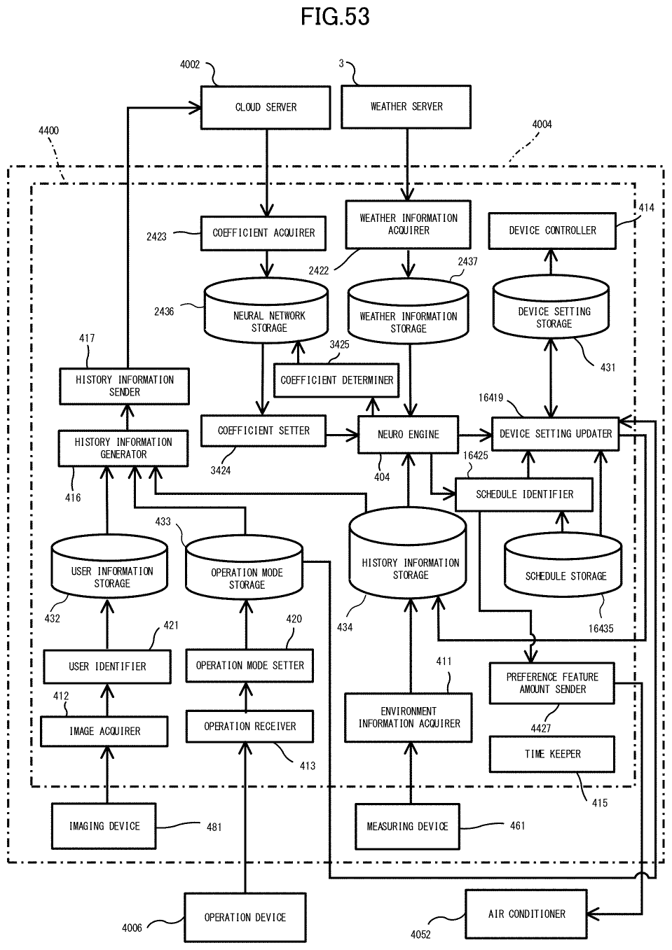

The hardware configuration of the air conditioner 4004 according to the present embodiment is the same as the hardware configuration of the air conditioner 2004 according to Embodiment 3, and includes a controller 4400. In the controller 4400, as illustrated in FIG. 53, for example, the CPU reads out a program stored in an auxiliary storage to a main storage and executes the program to function as an environment information acquirer 411, an image acquirer 412, an operation receiver 413, a device controller 414, a time keeper 415, a history information generator 416, a history information sender 417, a device setting updater 2419, an operation mode setter 420, a user identifier 421, a weather information acquirer 2422, a coefficient acquirer 2423, a coefficient setter 3424, a coefficient determiner 3425, a schedule identifier 16425, and a preference feature amount sender 4427. Note that, in FIG. 53, the constituents that are the same as in Embodiment 6 are denoted with the same reference numerals as used in FIG. 47. Additionally, the auxiliary storage includes a device setting storage 431, a user information storage 432, an operation mode storage 433, a history information storage 434, a neural network storage 2436, a weather information storage 2437, and a schedule storage 16435. Note that the CPU, the main storage, and the auxiliary storage are the same as the CPU 401, the main storage 402, and the auxiliary storage 403 illustrated in FIG. 28.

The schedule storage 16435 associates a plurality of types of schedule information expressing an operation schedule of the air conditioner 4004 with the preference feature amount, and stores the associated information. The schedule identifier 16425 identifies, from the plurality of types of schedule information stored in the schedule storage 16435, the schedule information the basis of the preference feature amount of the user calculated by the neuro engine 404 from the weather record information, the operation history information, and the environment history information. The preference feature amount sender 4427 sends, to the air conditioner 4052, preference feature amount information expressing the preference feature amount calculated by the neuro engine 404.

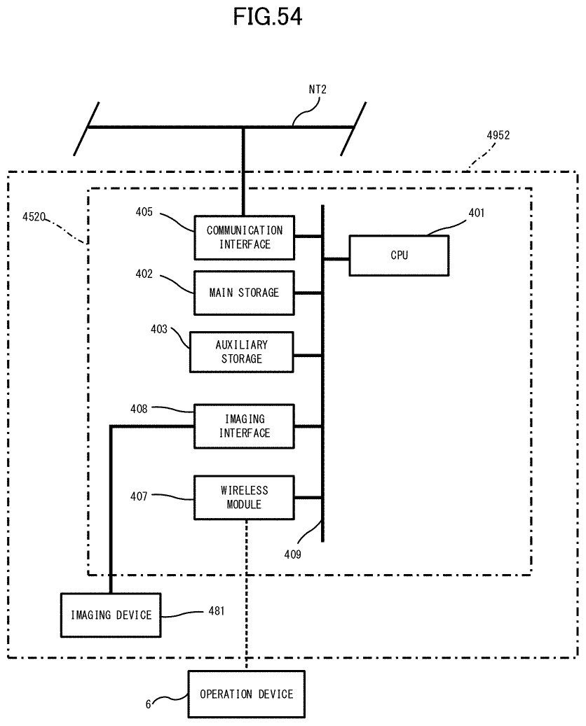

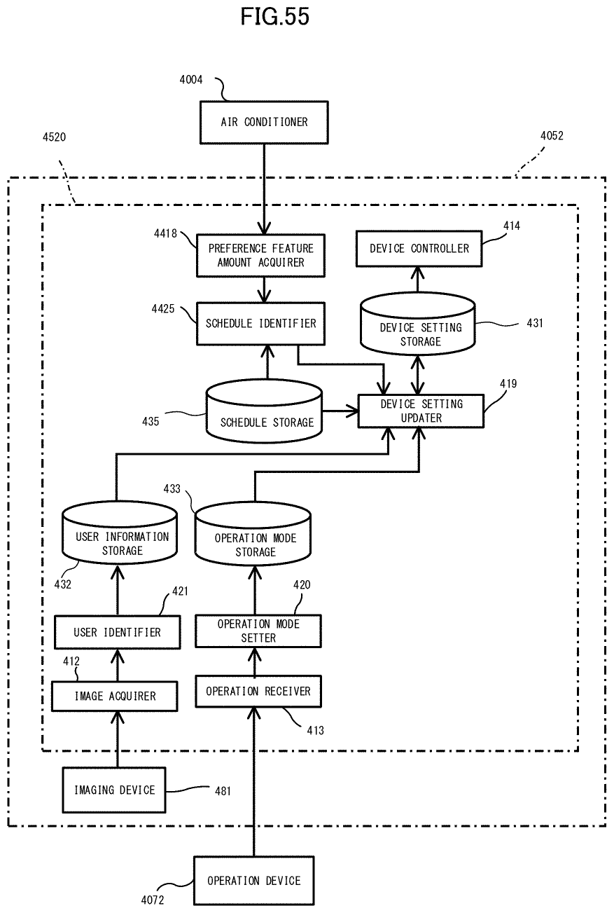

As with the air conditioner 4 described in Embodiment 1, the air conditioner 4052 does not include a neuro engine. As illustrated in FIG. 54, the air conditioner 4052 includes a controller 4520 and an imaging device 481. Additionally, the air conditioner 4052 includes a compressor (not illustrated in the drawings) and a blowing fan (not illustrated in the drawings) that operate on the basis of command signals input from the controller 4520. The controller 4520 includes a CPU 401, a main storage 402, an auxiliary storage 403, a communication interface 405, a wireless module 407, an imaging interface 408, and a bus 409 that connects these components to each other. Note that, in FIG. 54, the constituents that are the same as in Embodiment 1 are denoted with the same reference numerals as used in FIG. 2. The CPU 401 reads out the program stored in the auxiliary storage 403 to the main storage 402 and executes the program to function as an image acquirer 412, an operation receiver 413, a device controller 414, a time keeper 415, a preference feature amount acquirer 4418, a device setting updater 419, an operation mode setter 420, and a user identifier 421, as illustrated in FIG. 55. Additionally, the auxiliary storage 403 includes a device setting storage 431, a user information storage 432, an operation mode storage 433, a history information storage 434, and a schedule storage 435. The preference feature amount acquirer 4418 acquires the preference feature amount information from the air conditioner 4004, and notifies the schedule identifier 4425 of the acquired preference feature amount information. The schedule identifier 4425 identifies, from among the plurality of types of schedule information stored in the schedule storage 435, the schedule information corresponding to the notified preference feature amount. Then, the device setting updater 4419 updates, on the basis of the schedule information identified by the schedule identifier 4425, the device setting information stored in the device setting storage 431.

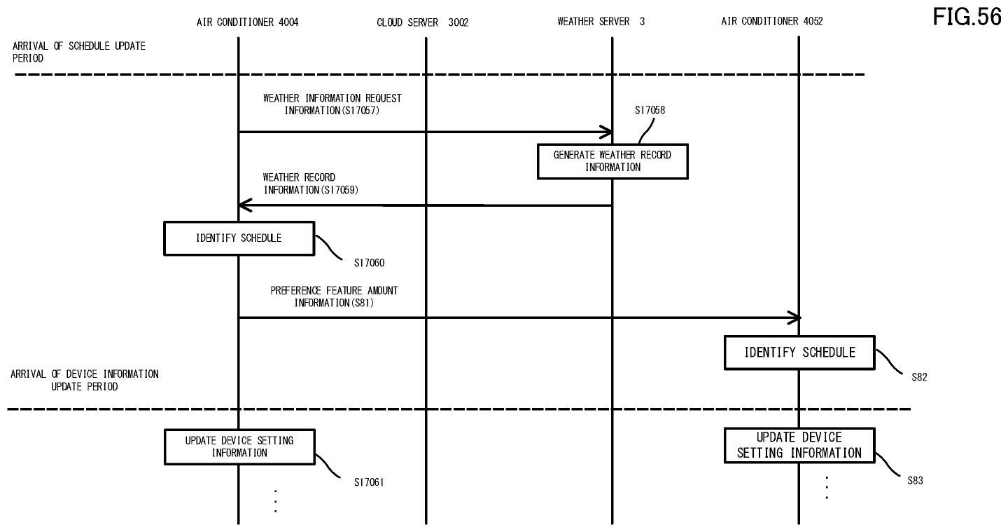

Next, the operations of the control system according to the present embodiment are described while referencing FIG. 56. Note that, in FIG. 56, the processes that are the same as in Embodiment 6 are denoted with the same reference numerals as used in FIG. 49. When the air conditioner 4004 determines that a schedule update period has arrived, the series of processing from step S17057 to S17060 of FIG. 56 is executed and, as a result, the air conditioner 4004 acquires the weather record information. Next, the air conditioner 4004 uses the neural network in which the weighting coefficient is set to calculate the preference feature amount from the operation history information, the environment history information, and the weather record information. Moreover, the air conditioner 4004 identifies, from the plurality of types of schedule information stored in the schedule storage 16435, the schedule information corresponding to the calculated preference feature amount (step S17060). Then, the preference feature amount information expressing the preference feature amount identified by the air conditioner 4004 is sent from the air conditioner 4004 to the air conditioner 4052 (step S81). Meanwhile, when the air conditioner 4052 receives the preference feature amount information, the air conditioner 4052 identifies the schedule information corresponding to the receives preference feature amount information (step S82). Then, when an update period of the device setting information arrives, the air conditioner 4004 uses the identified schedule information to update the device setting information stored in the device setting storage 431 (step S17061). Additionally, the air conditioner 4052 also uses the identified schedule information to update the device setting information stored in the device setting storage 431 (step S83). Thereafter, the processing of step S17061 and the processing of step S83 are repeatedly executed every time the update period of the device setting information arrives.

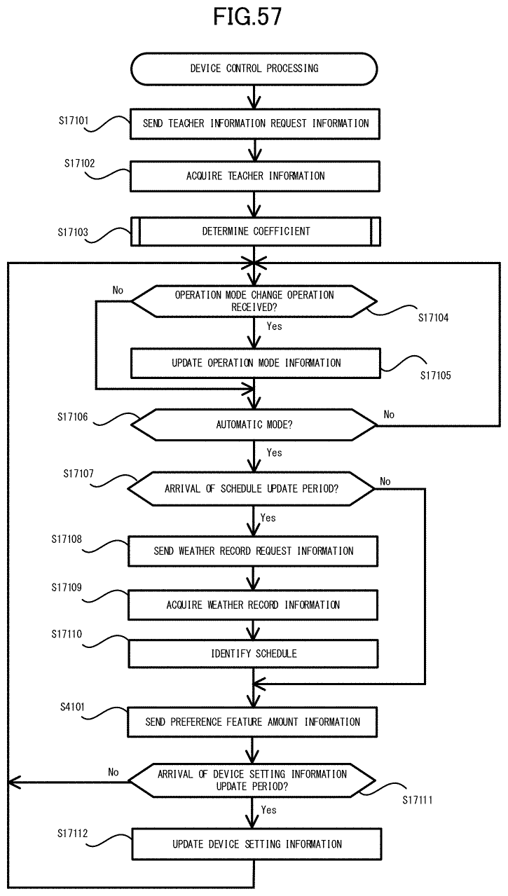

Next, device control processing executed by the air conditioner 4004 according to the present embodiment is described while referencing FIG. 57. Note that, in FIG. 57, the processes that are the same as in Embodiment 6 are denoted with the same reference numerals as used in FIG. 50.

Firstly, the series of processing from step S3101 to step S3112 is executed. Next, the schedule identifier 16425 determines whether the predetermined schedule update period of the air conditioner 4004 has arrived (step S17105). When the schedule identifier 16425 determines that the schedule update period of the air conditioner 17004 has not arrived (step S17105; No), the processing of hereinafter described step S17109 is executed. However, it is assumed that the schedule identifier 16425 determines that the schedule update period of the air conditioner 17004 has arrived (step S17105; Yes). In this case, the processing of step S17106 and step S17107 are executed and, then, the neuro engine 404 uses the neural network to calculate the preference feature amount from the operation history information, the environment history information, and the weather prediction information. Moreover, the schedule identifier 16425 identifies, from the plurality of types of schedule information stored in the schedule storage 16435, the schedule information corresponding to the calculated preference feature amount (step S17008). Then, the preference feature amount sender 4427 sends a preference feature information amount expressing the preference feature amount calculated by the neuro engine 404 to the air conditioner 4052 (step S4101). Then, the processing of step S17109 and subsequent processing is executed.

As described above, with the control system according to the present embodiment, in the air conditioner 4004, the neuro engine 404 uses the neural network to calculate the preference feature amount from the operation history information, the environment history information, and the weather prediction information. Moreover, moreover, the schedule identifier 16425 identifies, from the plurality of types of schedule information stored in the schedule storage 16435, the schedule information corresponding to the calculated preference feature amount, and the preference feature amount sender 4427 sends the preference feature amount calculated by the neuro engine 404 to the air conditioner 4052. As a result, even though the air conditioner 4052 does not include a neuro engine, the air conditioner can be controlled in accordance with an operation schedule expressed by the schedule information corresponding to the preference feature amount identified in the air conditioner 4004. Accordingly, the schedule information identified in the air conditioner 4004 that includes the neuro engine 404 can be shared with the air conditioner 4052 that does not include a neuro engine. Therefore, by linking with the air conditioner 4052 that does not include a neuro engine, it is possible to maintain the entire house H, in which the air conditioners 4004, 4052 are installed, at an environment that is comfortable to the user.

### Embodiment 8

A control system according to the present embodiment includes a plurality of devices having functions for determining a weighting coefficient of a neural network, and using the neural network for which the weighting coefficient is determined to calculate a future device setting parameter of the device. Here, the neural network has a predetermined number of nodes and a predetermined number of layers, and is for calculating the future device setting parameter.

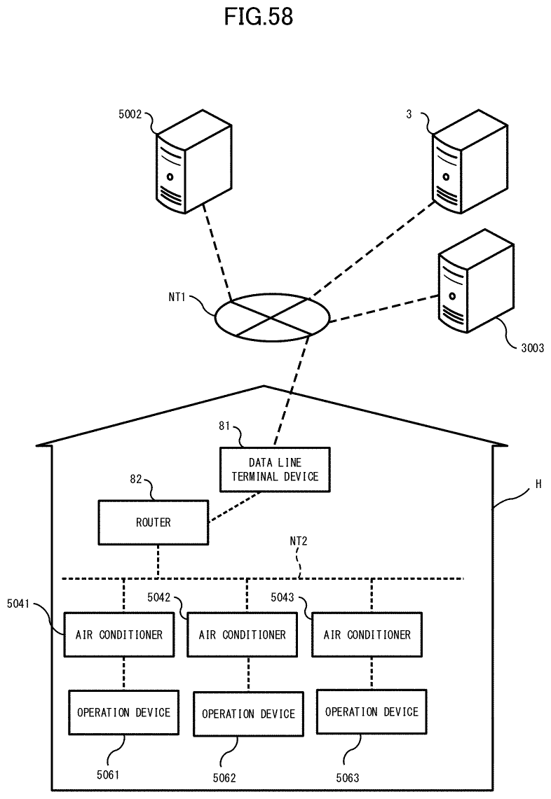

As illustrated in FIG. 58, the control system according to the present embodiment includes air conditioners 5041, 5042, 5043, and a cloud server 5002. Note that, in FIG. 58, the constituents that are the same as in Embodiment 1 are denoted with the same reference numerals as used in FIG. 1.

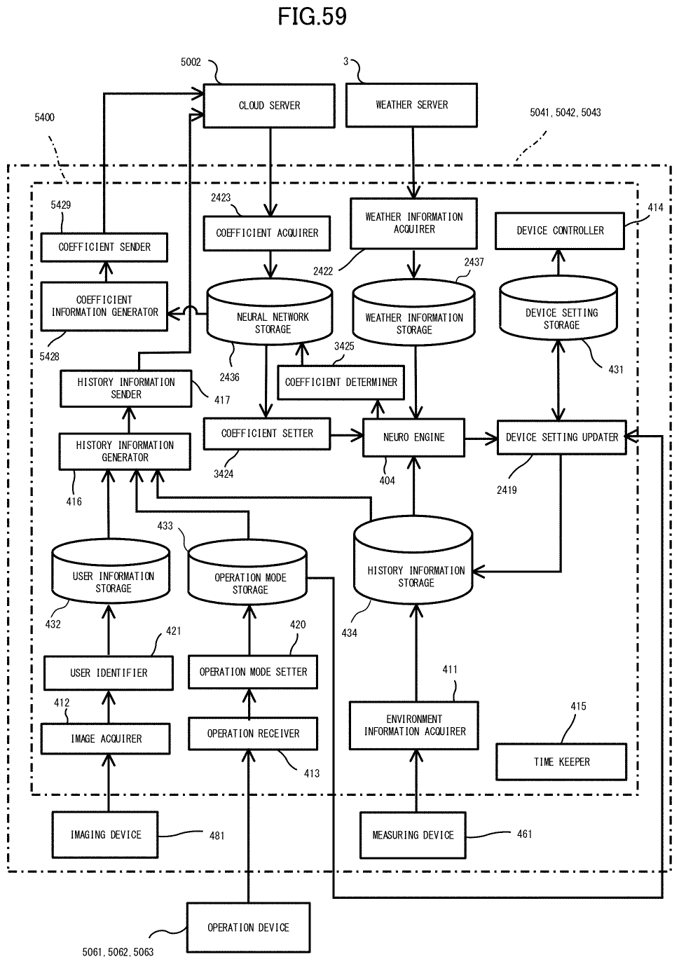

The hardware configuration of the air conditioners 5041, 5042, 5043 is the same as the hardware configuration of the air conditioner 2004 according to Embodiment 3. The CPU reads out a program stored in an auxiliary storage to a main storage and executes the program to function as an environment information acquirer 411, an image acquirer 412, an operation receiver 413, a device controller 414, a time keeper 415, a history information generator 416, a history information sender 417, a device setting updater 2419, an operation mode setter 420, a user identifier 421, a weather information acquirer 2422, a coefficient acquirer 2423, a coefficient setter 3424, a coefficient determiner 3425, a coefficient information generator 5428, and a coefficient sender 5429, as illustrated in FIG. 59. Note that, in FIG. 59, the constituents that are the same as in Embodiment 5 are denoted with the same reference numerals as used in FIG. 41. Additionally, the auxiliary storage includes a device setting storage 431, a user information storage 432, an operation mode storage 433, a history information storage 434, a neural network storage 2436, and a weather information storage 2437. Note that the CPU, the main storage, and the auxiliary storage are the same as the CPU 401, the main storage 402, and the auxiliary storage 403 illustrated in FIG. 28.

The coefficient acquirer 2423 is a second coefficient acquirer that acquires coefficient information and coefficient attribute information from the cloud server 5002. The coefficient information generator 5428 generates coefficient information including weighting coefficient information stored in the neural network storage 2436, and coefficient attribute information. The coefficient sender 5429 sends the coefficient information and the coefficient attribute information generated by the coefficient information generator 5428 to the cloud server 5002. When the operation receiver 413 receives an operation for setting the operation mode of the air conditioners 5041, 5042, 5043, the operation mode setter 5423 stores operation mode information expressing the operation mode corresponding to the received operation content in the operation mode storage 433.

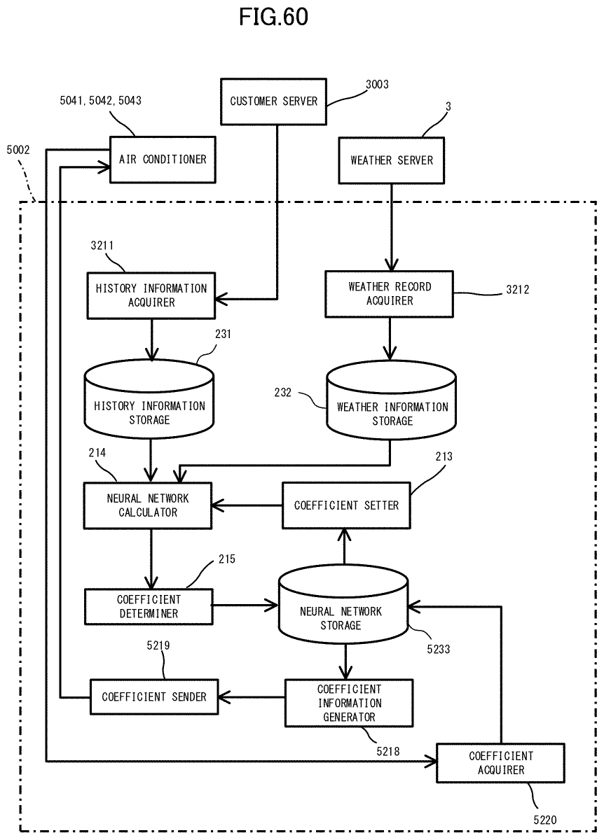

The hardware configuration of the cloud server 5002 is the same as the hardware configuration of the cloud server 2 described in Embodiment 1. The CPU reads out the program stored in the auxiliary storage to the main storage and executes the program to function as a history information acquirer 3211, a weather record acquirer 2212, a coefficient setter 213, a neural network calculator 214, a coefficient determiner 215, a coefficient information generator 5218, a coefficient sender 5219, and a coefficient acquirer 5220, as illustrated in FIG. 60. Note that, in FIG. 60, the constituents that are the same as in Embodiment 5 are denoted with the same reference numerals as used in FIG. 42. Additionally, the auxiliary storage includes a history information storage 231, a weather information storage 232, and a neural network storage 5233. Note that the CPU, the main storage, and the auxiliary storage are the same as the CPU 201, the main storage 202, and the auxiliary storage 203 illustrated in FIG. 10. The neural network storage 5233 stores initial weighting coefficient information expressing an initial weighting coefficient of the neural network determined on the basis of the operation history information, the environment history information, and the weather record information of an air conditioner of another house in which an air conditioner, of the same the model as the air conditioners 5041, 5042, 5043 installed in the house H, is installed. Additionally, the neural network storage 5233 associates the weighting coefficient information included in the coefficient information acquired from the air conditioners 5041, 5042, 5043 with device identification information of the air conditioners 5041, 5042, 5043 that are the senders of the coefficient information, and stores the associated information.

The coefficient information generator 5218 generates coefficient information that includes the weighting coefficient information expressing the weighting coefficient determined by the coefficient determiner 215. Additionally, the coefficient information generator 5218 generates coefficient information including the weighting coefficient information stored in the neural network storage 5233, and coefficient attribute information. The coefficient sender 5219 sends the coefficient information and the coefficient attribute information generated by the coefficient information generator 3218 to the air conditioners 5041, 5042, 5043. The coefficient acquirer 5220 is a first coefficient acquirer that, when the coefficient information and the coefficient attribute information sent from the air conditioners 5041, 5042, 5043 are acquired, associates the weighting coefficient information included in the acquired coefficient information with the device identification information of the air conditioners 5041, 5042, 5043, and stores the associated information in the neural network storage 5233.

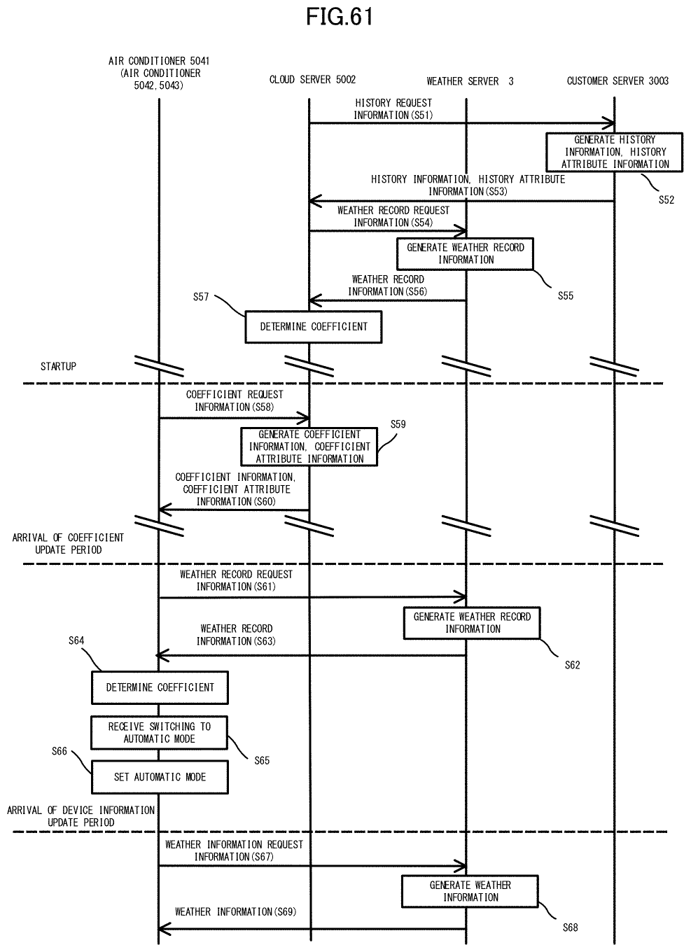

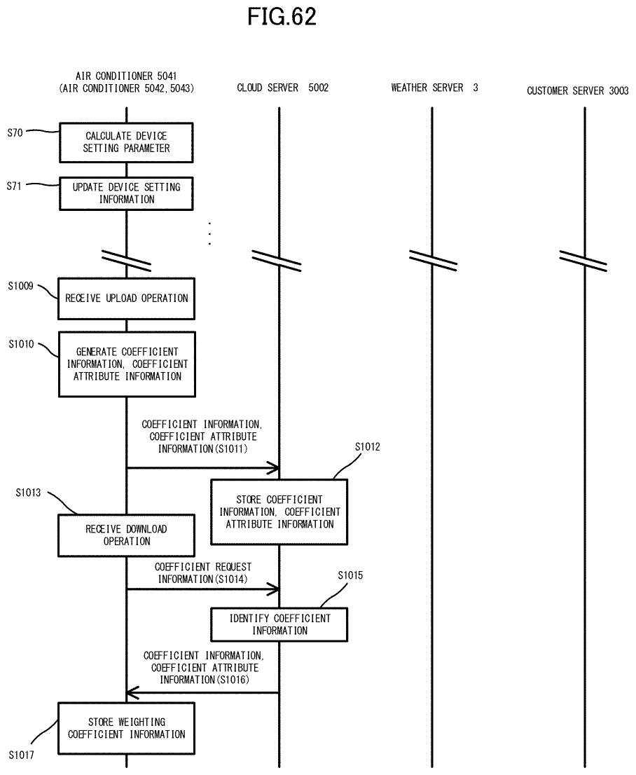

Next, the operations of the control system according to the present embodiment are described while referencing FIGS. 61 and 62. Note that, in FIGS. 61 and 62, the processes that are the same as in Embodiment 5 are denoted with the same reference numerals as used in FIGS. 43 and 44. As illustrated in FIG. 61, firstly, the series of processing from step S51 to step S57 is executed and, as a result, the initial weighting coefficient of the neural network is determined. Here, the cloud server 5002 stores the initial weighting coefficient information expressing the determined initial weighting coefficient in the neural network storage 5233. Next, it is assumed that a new air conditioner 5041 (5042, 5043) is installed in the house H and is started up. At this time, coefficient request information requesting, to the cloud server 5002, sending of the coefficient information including the initial weighting coefficient information is sent from the air conditioner 5041 (5042, 5043) to the cloud server 5002 (step S58). Meanwhile, when the cloud server 5002 receives the coefficient request information, the cloud server 5002 generates coefficient information including the initial weighting coefficient information stored in the neural network storage 5233, and coefficient attribute information (step S59). Next, the coefficient information and the coefficient attribute information that are generated are sent from the cloud server 5002 to the air conditioner 5041 (5042, 5043) (step S60). Then, it is assumed that the air conditioner 5041 (5042, 5043) determines that a predetermined coefficient update period for updating the weighting coefficient of the neural network has arrived. In this case, the series of processing from step S61 to S65 is executed and, as a result, the air conditioner 5041 (5042, 5043) acquires the weather record information. Then, the air conditioner 5041 (5042, 5043) determines the weighting coefficient of the neural network on the basis of the operation history information, the environment history information, the date and time information, and the user information stored in the history information storage 434, and the weather record information stored in the weather information storage 2437 (step S66). Thereafter, the series of processing from step S61 to step S66 is repeatedly executed every time the update period of the weighting coefficient of the neural network arrives.

Next, it is assumed that the air conditioner 5041 (5042, 5043) determines that the update period of the device setting information stored in the device setting storage 431 has arrived. In this case, the series of processing from step S67 to S69 is executed and, as a result, the air conditioner 5041 (5042, 5043) acquires the weather record information. Next, as illustrated in FIG. 62, the air conditioner 5041 (5042, 5043) uses the neural network to calculate the future device setting parameter of the air conditioner 5041 (5042, 5043) from the weather prediction information and the environment parameter indicating the environment at present (step S70). Then, the air conditioner 5041 (5042, 5043) uses the calculated device setting parameter to update the device setting information stored in the device setting storage 431 (step S71). Thereafter, the series of processing from step S67 to step S71 is repeatedly executed every time the update period of the device setting information arrives.

Thereafter, it is assumed that the air conditioner 5041 (5042, 5043) receives an operation for uploading, to the cloud server 3002, the coefficient information including the weighting coefficient information stored in the neural network storage 2436 (step S1009). In this case, the air conditioner 5041 (5042, 5043) uses the weighting coefficient information stored in the neural network storage 2436 to generate the coefficient information and to generate the coefficient attribute information (step S1010). Then, the coefficient information and the coefficient attribute information that are generated are sent from the air conditioner 5041 (5042, 5043) to the cloud server 5002 (step S1011). Meanwhile, when the cloud server 5002 receives the coefficient information and the coefficient attribute information, the cloud server 5002 associates the received coefficient information and coefficient attribute information with the device identification information identifying the air conditioner 5041 (5042, 5043), and stores the associated information in the neural network storage 2436 (step S1012).

Additionally, it is assumed that the air conditioner 5041 (5042, 5043) receives an operation for downloading the coefficient information from the cloud server 5002 (step S1013). In this case, coefficient request information requesting, to the cloud server 5002, sending of the coefficient information is sent from the air conditioner 5041 (5042, 5043) to the cloud server 5002 (step S1014). This coefficient request information includes the device identification information of the air conditioner 5041 (5042, 5043). Meanwhile, when the cloud server 5002 receives the coefficient request information, the cloud server 5002 identifies the coefficient information associated with the device identification information included in the received coefficient request information (step S1015). Next, the identified coefficient information and the coefficient attribute information corresponding thereto are sent from the cloud server 5002 to the air conditioner 5041 (5042, 5043) (step S1016). Meanwhile, when the air conditioner 5041 (5042, 5043) receives the coefficient information and the coefficient attribute information, the air conditioner 5041 (5042, 5043) stores the weighting coefficient information included in the received coefficient information in the neural network storage 2436 (step S1017).

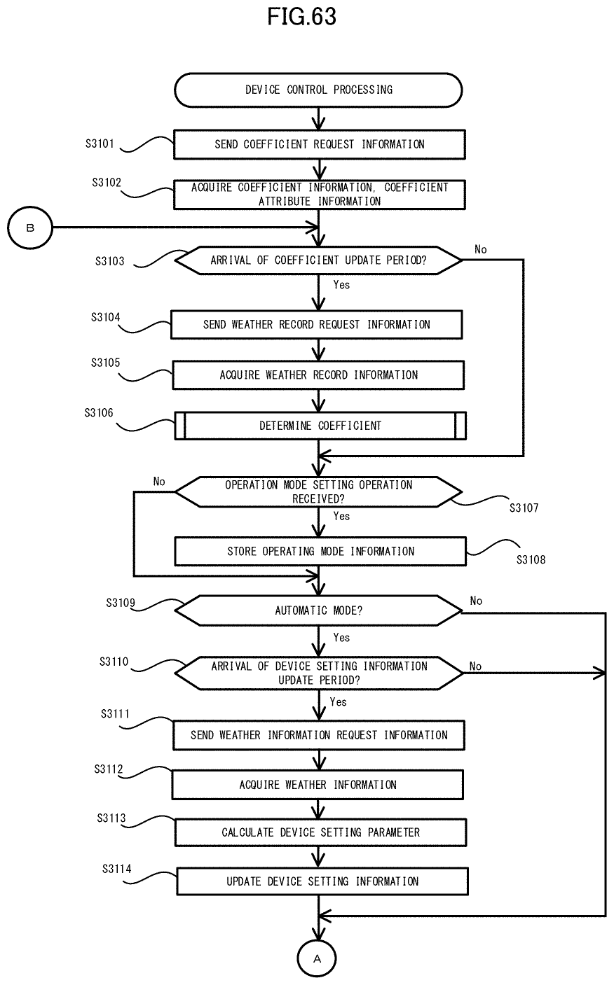

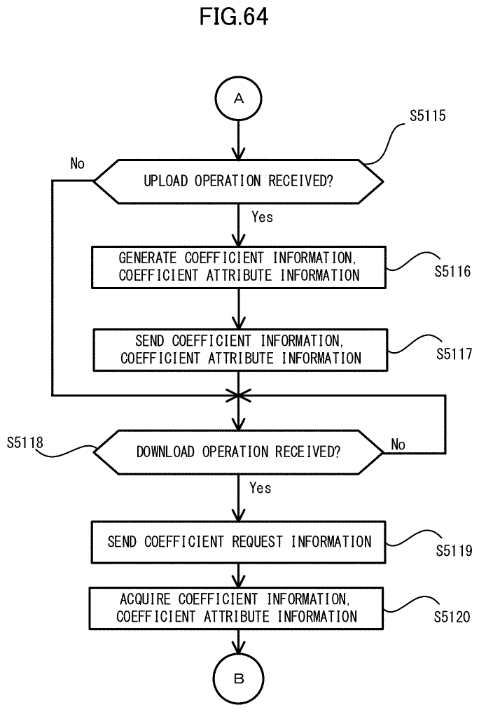

Next, device control processing executed by the air conditioner 5041 (5042, 5043) according to the present embodiment is described while referencing FIGS. 63 and 64. Note that, in FIGS. 63 and 64, the processes that are the same as in Embodiment 5 are denoted with the same reference numerals as used in FIG. 44. Firstly, the coefficient acquirer 2423 sends coefficient request information to the cloud server 5002 (step S3101) to acquire, from the cloud server 5002, coefficient information including information expressing an initial coefficient of the neural network (step S3102). The coefficient acquirer 2423 stores the acquired information expressing the initial coefficient in the neural network storage 2436.

Next, the coefficient determiner 3425 determines whether a coefficient update period of the neural network has arrived (step S3103). When the coefficient determiner 3425 determines that the coefficient update period has not arrived (step S3103; No), the processing of hereinafter described step S3107 is executed without modification. However, it is assumed that the coefficient determiner 3425 determines that the coefficient update period has arrived (step S3103; Yes). In this case the processing of steps S3014 and S3015 is executed. Thereafter, coefficient determination processing is executed (step S3106). The content of this coefficient determination processing is the same as that of the coefficient determination processing described using FIG. 17 in Embodiment 1. Next the processing of steps S3107 and S3108 is executed. The content of the processing of steps S3107 and S3108 is the same as that of the processing of steps S105 and S106 described using FIG. 15 in Embodiment 1.

Then, the device setting updater 2419 determines whether the operation mode of the air conditioner 5041 (5042, 5043) is the automatic mode (step S3109). When the device setting updater 2419 determines that the operation mode of the air conditioner 5041 (5042, 5043) is the manual mode (step S3109; No), the processing of hereinafter described step S3115 is executed. However, when the device setting updater 2419 determines that the operation mode of the air conditioner 5041 (5042, 5043) is the automatic mode (step S3109; Yes), the device setting updater 2419 determines whether a predetermined update period of the device setting information of the air conditioner 5041 (5042, 5043) has arrived (step S3110). When the device setting updater 2419 determines that the device setting information update period has not arrived (step S3110; No), the processing of hereinafter described step S5115 is executed. However, it is assumed that the device setting updater 2419 determines that the update period of the device setting information has arrived (step SS3110; Yes). In this case, the series of processing from step S3111 to step S3114 is executed. Here, the content of the series of processing from step S3111 to step S3114 is the same as the series of processing from step S3111 to step S3114 described using FIG. 44 in Embodiment 5. Then, as illustrated in FIG. 64, the operation receiver 413 determines whether an upload operation for uploading the coefficient information to the cloud server 5002 is received (step S5115). When the operation receiver 413 determines that the upload operation is not received (step S5115; No), the processing of hereinafter described step S5118 is executed. Meanwhile, when the operation receiver 413 determines that the upload operation is received (step S5115; Yes), the coefficient information generator 5428 generates coefficient information including the weighting coefficient information stored in the neural network storage 5433, and also generates coefficient attribute information corresponding to the coefficient information (step S5116). Next, the coefficient sender 5429 sends the coefficient information and the coefficient attribute information that are generated to the cloud server 5002 (step S5117). Then, the operation receiver 413 determines whether a download operation for downloading the coefficient information from the cloud server 5002 is received (step S5118). When the operation receiver 413 determines that the download operation is not received (step S5118; No), the processing of step S5113 is executed again. Meanwhile, when the operation receiver 413 determines that the download operation is received (step S5118; Yes), the coefficient acquirer 2423 sends coefficient request information to the cloud server 5002 (step S5119) to acquire the coefficient information and the coefficient attribute information from the cloud server 5002 (step S5120). The coefficient acquirer 2423 stores the weighting coefficient information included in the acquired coefficient information in the neural network storage 2436. Then, the processing of step S3103 is executed again.

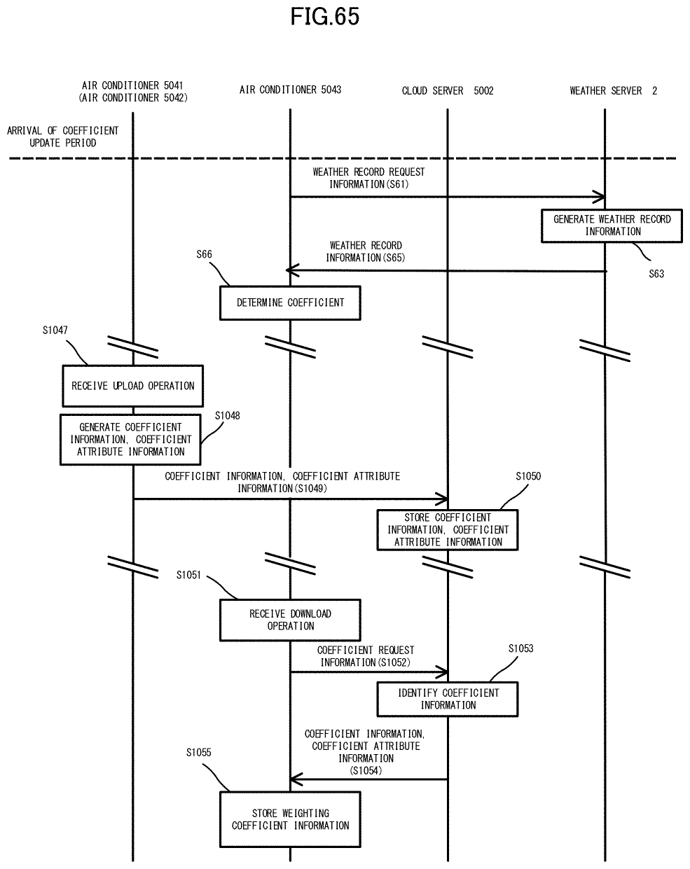

Here, while referencing FIG. 65, a case is described in which the weighting coefficient of the neural network determined in the air conditioner 5041 (5042) is transmitted to the air conditioner 5043. Note that, in FIG. 65, the processes that are the same as the processes described above using FIGS. 61 and 62 are denoted with the same reference numerals as used in FIGS. 61 and 62. Firstly, it is assumed that the air conditioner 5041 (5042) determines that a predetermined update period of the weighting coefficient of the neural network has arrived. In this case, the series of processing from step S61 to step S66 is executed and, as a result, the weighting coefficient of the neural network of the air conditioner 5041 (5042) is determined. Thereafter, it is assumed that the air conditioner 5041 (5042) receives an operation for uploading the coefficient information to the cloud server 5002 (step S1047). In this case, the air conditioner 5041 (5042) uses the information expressing the weighting coefficient information stored in the neural network storage 2436 to generate coefficient information and coefficient attribute information corresponding thereto (step S1048). Then, the coefficient information and the coefficient attribute information that are generated are sent from the air conditioner 5041 (5042) to the cloud server 5002 (step S1049). Meanwhile, when the cloud server 5002 receives the coefficient information and the coefficient attribute information, the cloud server 5002 associates the received coefficient information and coefficient attribute information with the device identification information identifying the air conditioner 5041 (5042), and stores the associated information in the neural network storage 5233 (step S1050).

Then, it is assumed that the air conditioner 5043 is newly installed in the house H, for example and, thereafter, receives an operation for downloading the coefficient information from the cloud server 5002 (step S1051). In this case, coefficient request information is sent from the air conditioner 5043 to the cloud server 5002 (step S1052). In one example, this coefficient request information includes the device identification information of the air conditioner 5041 (5042). Meanwhile, when the cloud server 5002 receives the coefficient request information, the cloud server 5002 identifies the coefficient information associated with the device identification information included in the received coefficient request information (step S1053). Next, the identified coefficient information and the coefficient attribute information corresponding thereto are sent from the cloud server 5002 to the air conditioner 5043 (step S1054). Meanwhile, when the air conditioner 5043 receives the coefficient information and the coefficient attribute information, the air conditioner 5043 stores the weighting coefficient information included in the received coefficient information in the neural network storage 2436 of the air conditioner 5043 (step S1054). Thus, it is possible to set the weighting coefficient set in the neural network used by the air conditioner 5041 (5042) in the neural network used by the air conditioner 5043.

In the device setting processing described using FIGS. 63 and 64, the air conditioner 5041 (5042, 5043) may upload the history information of the cloud server 5002, download the history information from the cloud server 5002, and the like. In this case, it is sufficient that the air conditioner 5041 (5042, 5043) includes a history information generator that generates history information including the operation history information and the environment history information stored in the history information storage 434, and history attribute information corresponding to the history information, a history information sender that sends the history information and the history attribute information, and a device side history information acquirer that is a second history information acquirer that acquires the history information and the history attribute information of another air conditioner from the cloud server 5002. Moreover, when the history information acquirer of the cloud server 5002 acquires the history information and the history attribute information sent from the air conditioners 5041, 5042, 5043, it is sufficient that the cloud server 5002 functions as a cloud side history information acquirer that is a first history information acquirer that associates the history information and the history attribute information that are acquired with the device identification information of the air conditioners 5041, 5042, 5043, and stores the associated information in the history information storage 231.

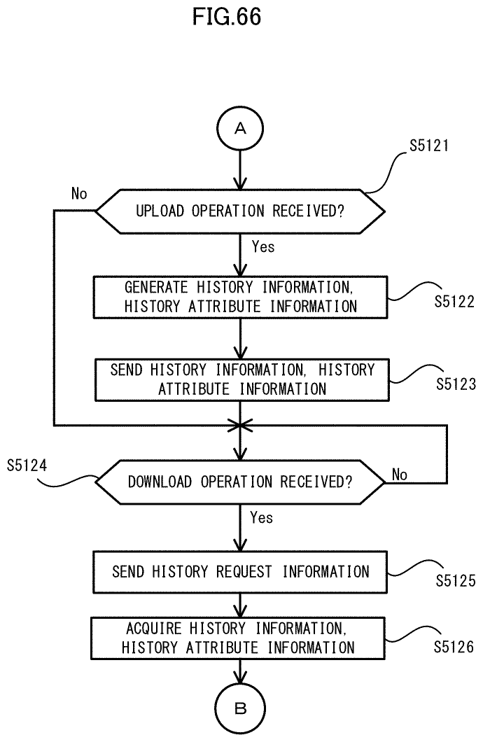

In the air conditioner 5041 (5042, 5043), after step S3114 described using FIG. 63, as illustrated in FIG. 66, the operation receiver 413 determines whether an upload operation for uploading the history information to the cloud server 5002 is received (step S5121). When the operation receiver 413 determines that the upload operation is not received (step S5121; No), the processing of hereinafter described step S5124 is executed. Meanwhile, when the operation receiver 413 determines that the upload operation is received (step S5121; Yes), the history information generator generates history information including the operation history information and the environment information stored in the history information storage 5434, and also generates history attribute information corresponding to the history information (step S5122). Next, the history information sender sends the history information and the history attribute information that are generated to the cloud server 5002 (step S5123). At this time, the cloud side history information acquirer associates the history information and the history attribute information acquired from the air conditioner 5041 (5042, 5043) with the device identification information of the air conditioner 5041 (5042, 5043), and stores the associated information in the history information storage 231. Then, the operation receiver 413 determines whether a download operation for downloading the history information from the cloud server 5002 is received (step S5124). When the operation receiver 413 determines that the download operation is not received (step S5124; No), the processing of step S3113 is executed again. Meanwhile, when the operation receiver 413 determines that the download operation is received (step S5124; Yes), the device side history information acquirer sends history request information to the cloud server 5002 (step S5125) to acquire the history information and the history attribute information from the cloud server 5002 (step S5126). The history information acquirer stores, in the history information storage 434, the operation history information, the environment history information, and the user information included in the acquired history information. Then, the processing of step S3103 is executed again.

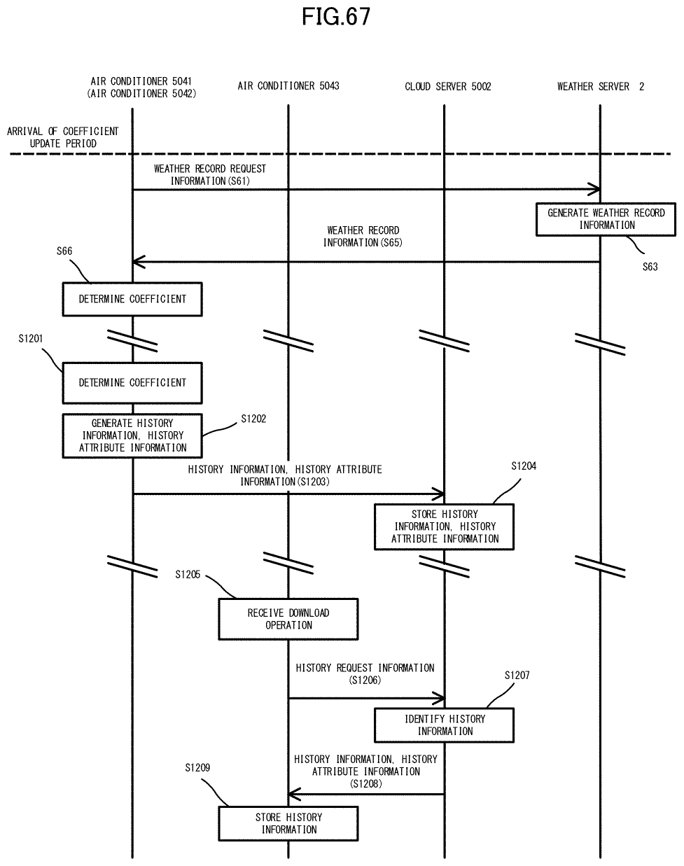

Here, while referencing FIG. 67, a case is described in which the operation history information and the environment history information accumulated in the air conditioner 5041 (5042) are transmitted to the air conditioner 5043. Note that, in FIG. 67, the processes that are the same as the processes described above using FIGS. 61 and 62 are denoted with the same reference numerals as used in FIGS. 61 and 62. Firstly, when the air conditioner 5041 (5042) determines that the predetermined update period of the weighting coefficient of the neural network has arrived, the series of processing from step S61 to step S66 is executed and, as a result, the weighting coefficient of the neural network of the air conditioner 5041 (5042) is determined. Thereafter, it is assumed that the air conditioner 5041 (5042) receives an operation for uploading the history information to the cloud server 5002 (step S1201). In this case, the air conditioner 5041 (5042) generates history information including the operation history information and the environment information stored in the history information storage 5434, and also generates history attribute information corresponding to the history information (step S1202). Then, the history information and the history attribute information that are generated are sent from the air conditioner 5041 (5042) to the cloud server 5002 (step S1203). Meanwhile, when the cloud server 5002 receives the history information and the history attribute information, the cloud server 5002 associates the received history information and history attribute information with the device identification information identifying the air conditioner 5041 (5042), and stores the associated information in the history information storage 231.

Then, it is assumed that the air conditioner 5043 is newly installed in the house H, for example and, thereafter, receives an operation for downloading the history information from the cloud server 5002 (step S1205). In this case, history request information is sent from the air conditioner 5043 to the cloud server 5002 (step S1206). In one example, this history request information includes the device identification information of the air conditioner 5041 (5042). Meanwhile, when the cloud server 5002 receives the history request information, the cloud server 5002 identifies the history information associated with the device identification information included in the received history request information (step S1207). Next, the identified history information and the history attribute information corresponding thereto are sent from the cloud server 5002 to the air conditioner 5043 (step S1208). Meanwhile, when the air conditioner 5043 receives the history information and the history attribute information, the air conditioner 5043 stores the operation history information and the environment information included in the received history information in the history information storage 434 of the air conditioner 5043 (step S1209). Thus, it is possible to store the operation history information and the environment history information accumulated in the air conditioner 5041 (5042) in the history information storage 434 of the air conditioner 5043. As a result, in the air conditioner 5043, the coefficient determiner 5420 can determine the weighting coefficient of the neural network using the operation history information and the environment history information acquired from the air conditioner 5041 (5042).

As described above, with the control system according to the present embodiment, the weighting coefficient of the neural network of the air conditioner 5041, 5042, 5043 is downloaded from the cloud server 5002 and updated and, as a result, the control system according to the present embodiment can flexibly adapt to changes of the use method of the user of the air conditioners 5041, 5042, 5043, particularly, changes in the installation environment of the air conditioners 5041, 5042, 5043 caused by moving of the user, changes in the family structure of the user, and the like. Additionally, when introducing a new air conditioner 5041, 5042, 5043, information expressing the weighting coefficient of the neural network, which is uploaded in advance to the cloud server 5002, is downloaded. As a result, the operation tendencies when in automatic operation of the air conditioners 5041, 5042, 5043 used to-date can be passed on to the new air conditioner 5041, 5042, 5043.

Furthermore, with the control system according to the present embodiment, coefficient information corresponding to each user can be downloaded and used by uploading, in advance to the cloud server 5002, weighting coefficient information of the neural network corresponding to a plurality of different users. As a result, even in cases in which the number of users increases substantially, the air conditioners 5041, 5042, 5043 can be caused to automatically operate in accordance with operation tendencies suited to each user.

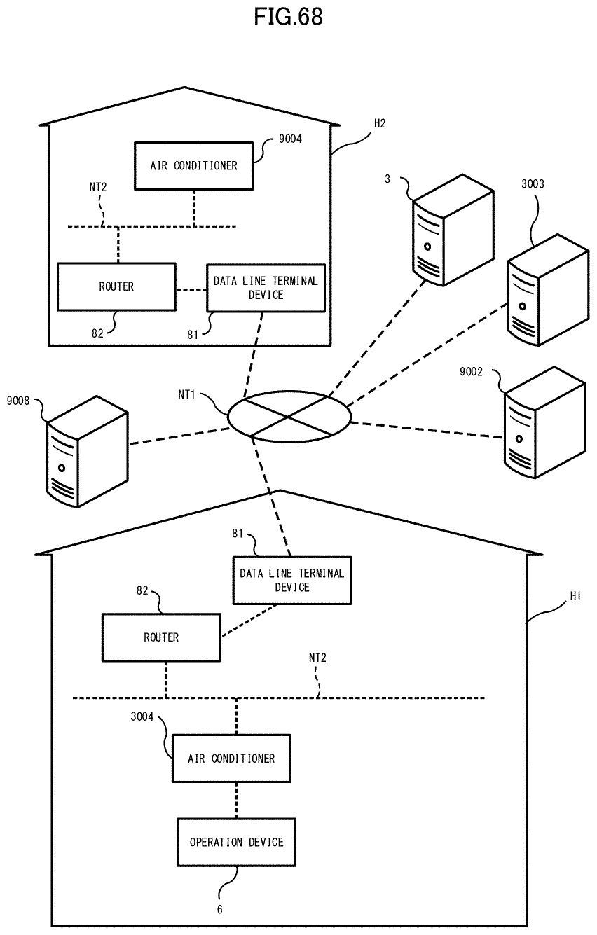

Embodiments of the present disclosure are described above, but the present disclosure is not limited to the configurations described in the embodiments. For example, as illustrated in FIG. 68, a configuration is possible in which the control system includes a storage server 9008 that manages neural network related information (hereinafter referred to as “NN related information”) that includes history information, coefficient information, and the like related to the neural network used by the air conditioner 3004. Note that, in FIG. 68, the air conditioner 3004 is the same as the air conditioner 3004 described in Embodiment 5. Additionally, in FIG. 68, the constituents that are the same as in Embodiment 1 are denoted with the same reference numerals as used in FIG. 1. In the present modified example, an air conditioner 9004 that has the same configuration as the air conditioner 3004 is installed in another house H2 that differs from a house H1. The storage server 9008 is capable of communicating with a server 9002 via an external network NT1.

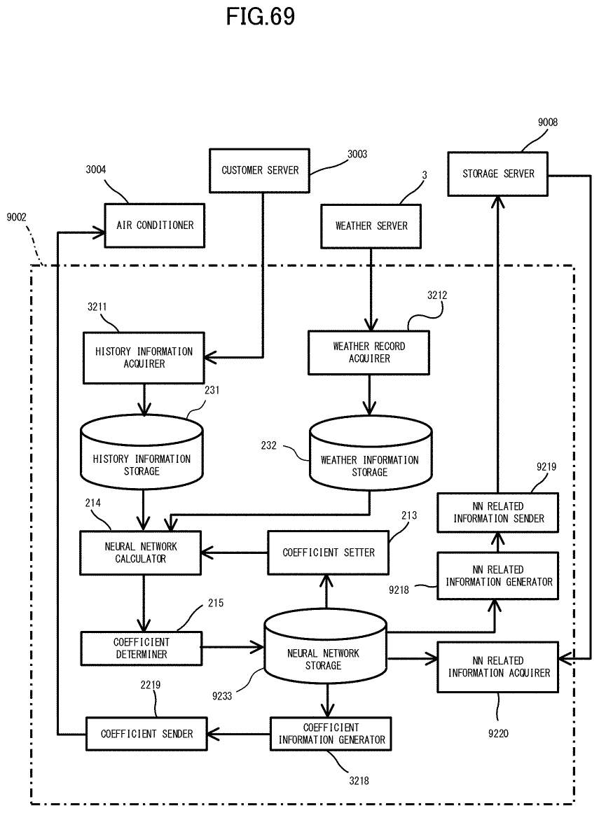

The hardware configuration of the cloud server 9002 is the same as the hardware configuration of the cloud server 2 of Embodiment 1 illustrated in FIG. 10. With the cloud server 9002, the CPU reads out a program stored in an auxiliary storage to a main storage and executes the program to function as a history information acquirer 3211, a weather record acquirer 3212, a coefficient setter 213, a neural network calculator 214, a coefficient determiner 215, a coefficient information generator 3218, a coefficient sender 2219, a neural network related information generator (hereinafter referred to as “NN related information generator”) 9218, a neural network related information sender (hereinafter referred to as “NN related information sender”) 9219, and a neural network related information acquirer (hereinafter referred to as “NN related information acquirer”) 9220, as illustrated in FIG. 69. Note that, in FIG. 69, the constituents that are the same as in Embodiment 5 are denoted with the same reference numerals as used in FIG. 42. Additionally, the auxiliary storage includes a history information storage 231, a weather information storage 232, and an initial coefficient storage 3233. Note that the CPU, the main storage, and the auxiliary storage are the same as the CPU 201, the main storage 202, and the auxiliary storage 203 illustrated in FIG. 10.

The NN related information generator 9218 acquires the history information from the air conditioner 3004 and generates, on the basis of user information included in the acquired history information, use situation information expressing a use situation of the air conditioner 3004 Moreover, the NN related information generator 9218 acquires operation history information and environment history information from the history information storage 231, and generates the NN related information that includes the operation history information and the environment history information that are acquired, and the generated information expressing the use situation. The NN related information sender 9219 sends the generated NN related information to the storage server 9008. The NN related information acquirer 9220 acquires the NN related information from the storage server 9008 by sending, to the storage server 9008, NN related information request information requesting, to the storage server 9008, sending of the NN related information. The NN related information request information includes the use situation information expressing the use situations of the air conditioner 9004 in the house H1.

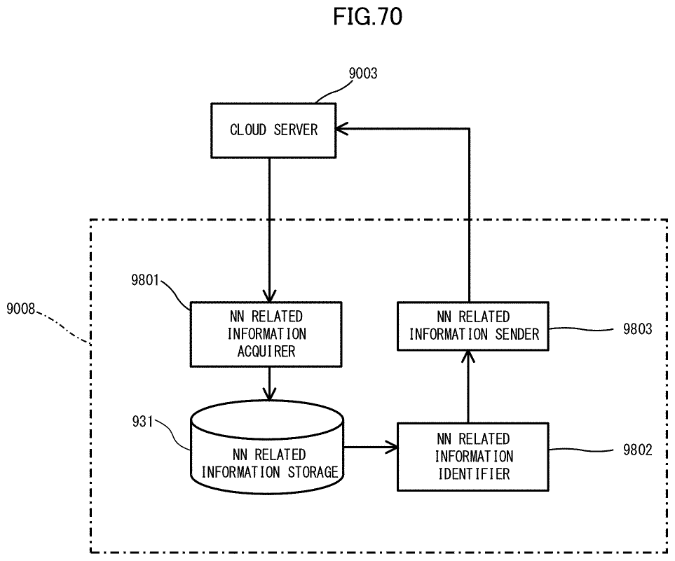

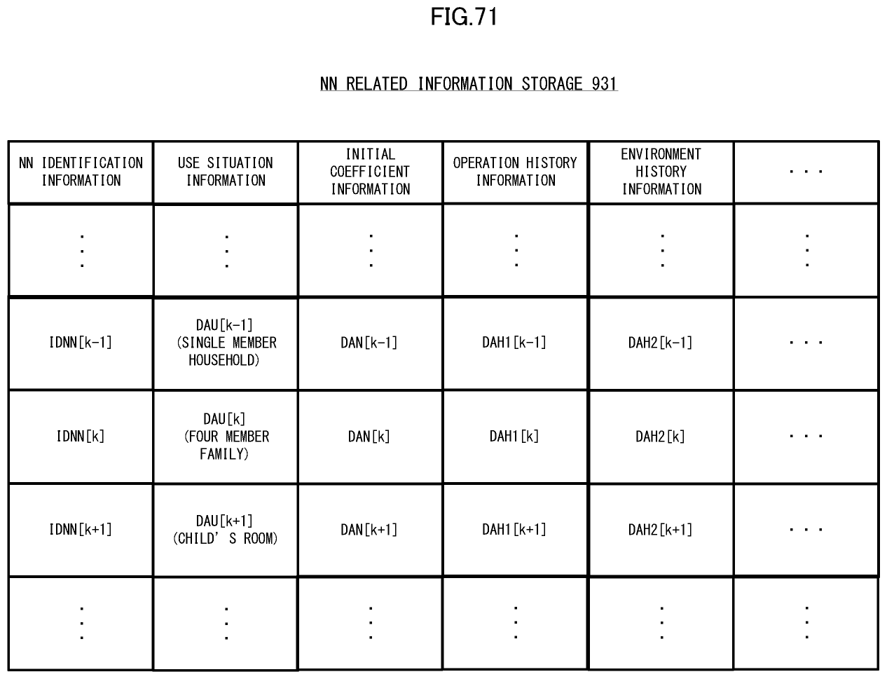

The hardware configuration of the storage server 9008 is the same as the hardware configuration of the cloud server 2 of Embodiment 1 illustrated in FIG. 10. With the storage server 9008, the CPU reads out a program stored in an auxiliary storage to a main storage and executes the program to function as an NN related information acquirer 9801, a neural network related information identifier (hereinafter referred to as “NN related information identifier) 9802, and an NN related information sender 9803, as illustrated in FIG. 70. Additionally, the auxiliary storage includes an NN related information storage 931 that stores the NN related information acquired from the cloud server 9002. Note that the CPU, the main storage, and the auxiliary storage are the same as the CPU 201, the main storage 202, and the auxiliary storage 203 illustrated in FIG. 10. In one example, as illustrated in FIG. 71, the NN related information storage 931 associates the use situation information, the coefficient information, the operation history information, the environment history information, and the like included in the NN related information with neural network identification information (hereinafter referred to as “NN identification information) that identifies the NN related information, and stores the associated information.

The NN related information acquirer 9801 acquires the NN related information sent from the cloud server 9002, imparts identification information to the acquired NN related information, and stores the resulting NN related information in the NN related information storage 931. When the NN related information identifier 9802 acquires the NN related information request information sent from the cloud server 9002, the NN related information identifier 9802 extracts the use situation information from the acquired NN related information request information. Then, the NN related information identifier 9802 identifies, from among the NN related information stored in the NN related information storage 931, NN related information for which the content of the use situation information thereof is similar to the content of the extracted use situation information. The NN related information sender 9803 sends the NN related information identified by the NN related information identifier 9802 to the cloud server 9002.

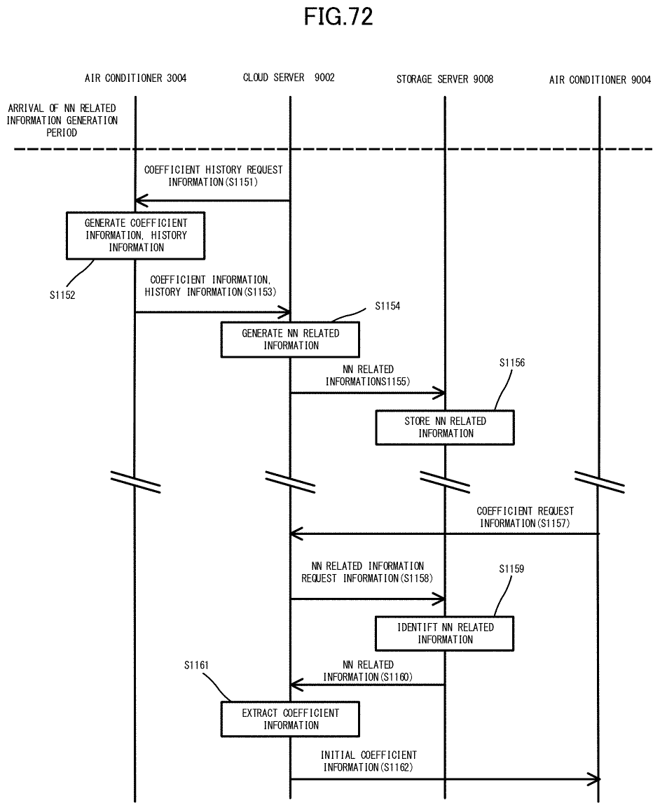

Next, the operations of the control system according to the present modified example are described while referencing FIG. 72. Here, a case is described in which the air conditioner 9004 is newly installed in the house H2. Firstly, it is assumed that the cloud server 9002 determines that a predetermined NN related information generation period has arrived. In this case, coefficient history request information requesting, to the air conditioner 3004, sending of coefficient information and history information is sent from the cloud server 9002 to the air conditioner 3004 (step S1151). Meanwhile, when the air conditioner 3004 acquires the coefficient history request information, the air conditioner 3004 generates the coefficient information and the history information (step S1152). Next, the coefficient information and the history information that are generated are sent from the air conditioner 3004 to the cloud server 9002 (step S1153). Meanwhile, when the cloud server 9002 acquires the coefficient information and the history information, the cloud server 9002 generates, on the basis of the user information included in the acquired history information, use situation information expressing the use situation of the air conditioner 3004. Additionally, the cloud server 9002 stores the operation history information and the environment history information included in the history information in the history information storage 231. Moreover, the cloud server 9002 acquires the operation history information and the environment history information from the history information storage 231, and generates the NN related information that includes the operation history information and the environment history information that are acquired, and the generated information expressing the use situation (step S1154). Next, the generated NN related information is sent from the cloud server 9002 to the storage server 9008 (step S1155). Meanwhile, when the storage server 9008 acquires the NN related information, the storage server 9008 imparts identification information to the acquired NN related information, and stores the resulting NN related information in the NN related information storage 931.

Thereafter, the air conditioner 9004 is newly installed in the house H2, and coefficient request information requesting, to the cloud server 9002, the initial coefficient of the neural network is sent from the air conditioner 9004 to the cloud server 9002 (step S1157). Next, when the cloud server 9002 acquires the coefficient request information, the NN related information described above is sent from the cloud server 9002 to the storage server 9008 (step S1158). Meanwhile, when the storage server 9008 acquires the NN related information request information, the storage server 9008 extracts the use situation information from the acquired NN related information request information. Then, the storage server 9008 identifies, from among the NN related information stored in the NN related information storage 931, NN related information for which the content of the use situation information thereof is similar to the content of the extracted use situation information (step S1159).

Next, the NN related information identified by the storage server 9008 is sent from the storage server 9008 to the cloud server 9002 (step S1160). Meanwhile, when the cloud server 9002 acquires the NN related information, the cloud server 9002 extracts the coefficient information from the acquired NN related information (step S1161). Thereafter, the extracted coefficient information is sent from the cloud server 9002 to the air conditioner 9004 (step S1162). Thus, the air conditioner 9004 can acquire the information expressing the weighting coefficient that is stored in the neural network storage 2436 of the air conditioner 3004, and store the acquired information expressing the weighting coefficient in the neural network storage of the air conditioner 9004.

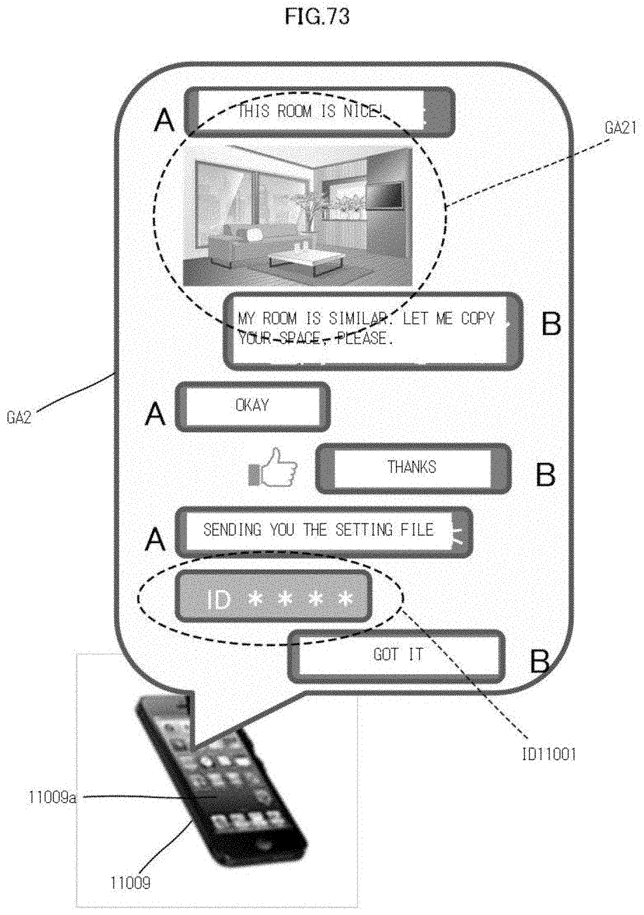

Additionally, as illustrated in FIG. 73, for example, a configuration is possible in which a terminal device 11009 is a device for displaying an image GA2 on a display 11009a. Here, the image GA2 includes a photograph image GA21 of inside the house in which the air conditioner 3004 is installed, and NN identification information ID 11001 imparted to the neural network used by the air conditioner 3004.

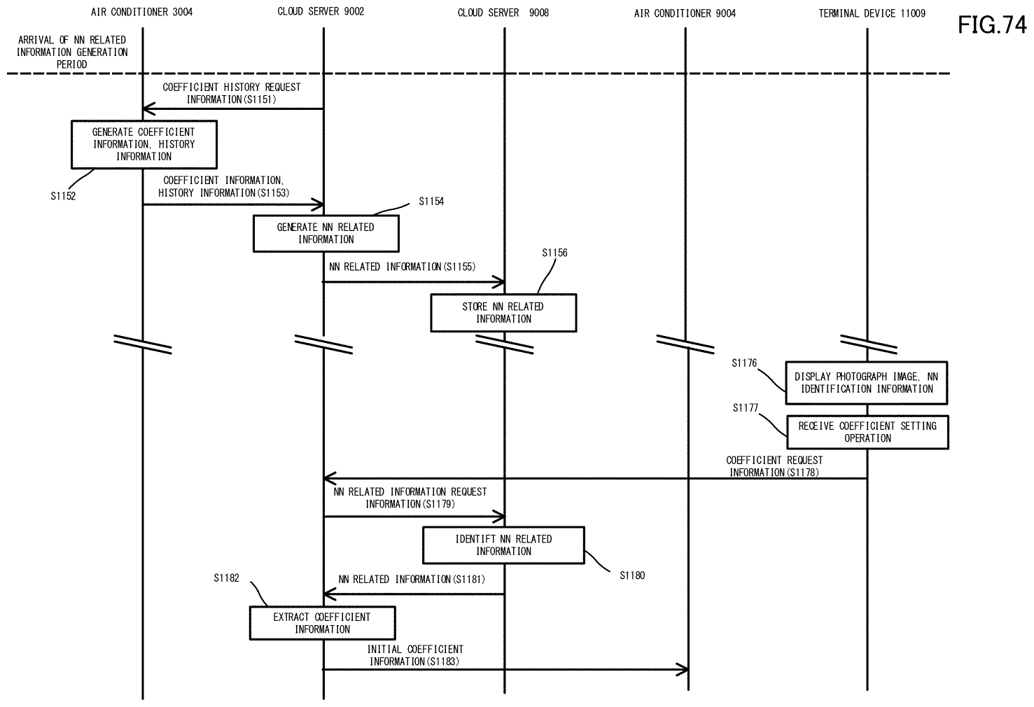

In this case, as illustrated in FIG. 74, for example, firstly, the series of processing from step S1152 to step S1156 is executed and, as a result, the storage server 9008 stores, in the NN related information storage 931, the NN related information corresponding to the neural network used by the air conditioner 3004. Note that, in FIG. 74, the processes that are the same as the processes described using FIG. 72 are denoted with the same reference numerals. Then, as illustrated in FIG. 74, for example, it is assumed that the terminal device 11009 displays the image GA2 including the photograph image GA21 and the NN identification information ID 11001 on the display 11009a (step S1176). Here, it is assumed that the user of the terminal device 11009 performs, on the terminal device 11009, a coefficient setting operation for setting a weighting coefficient, that is the same as the weighting coefficient set in the neural network used by the air conditioner 3004, in the neural network used by the air conditioner 9004. In this coefficient setting operation, the user inputs the NN identification information ID 11001 from a predetermined operation screen, for example. Upon such input, the terminal device 11009 receives the coefficient setting operation performed by the user (step S1177). Next, coefficient request information including the NN identification information ID 11001 is sent from the terminal device 11009 to the cloud server 9002 (step S1178).

Then, when the cloud server 9002 acquires the coefficient request information, NN related information request information including the NN identification information ID 11001 is sent from the cloud server 9002 to the storage server 9008 (step S1179). Meanwhile, when the storage server 9008 acquires the NN related information request information, the storage server 9008 extracts the NN identification information ID 11001 from the acquired NN related information request information. Then, the storage server 9008 identifies, from among the NN related information stored in the NN related information storage 931, the NN related information to which the NN identification information ID 11001 is imparted (step S1180).

Thereafter, the NN related information identified by the storage server 9008 is sent from the storage server 9008 to the cloud server 9002 (step S1181). Meanwhile, when the cloud server 9002 acquires the NN related information, the cloud server 9002 extracts the coefficient information from the acquired NN related information (step S1182). Thereafter, the extracted coefficient information is sent from the cloud server 9002 to the air conditioner 9004 (step S1183).

In Embodiment 3, an example is described in which the history information is directly sent from the air conditioner 2004 to the cloud server 2002, and the coefficient information is directly sent from the cloud server 2002 to the air conditioner 2004. However, the sending method of the history information and the coefficient information in Embodiment 2 is not limited thereto. For example, a configuration is possible in which the history information is sent from the air conditioner 2004 to the cloud server 2002, relayed through a terminal device (not illustrated in the drawings) that has a so-called tethering function, and the coefficient information is sent from the cloud server 2002 to the air conditioner 2004, relayed through the terminal device. In Embodiment 5, an example is described in which the coefficient information and the weather record information are directly sent from the cloud server 3002 to the air conditioner 3004. However, the sending method of the coefficient information and the weather record information in Embodiment 3 is not limited thereto. For example, a configuration is possible in which the coefficient information and the weather record information are sent from the cloud server 3002 to the air conditioner 3004, relayed through a terminal device. Here, a mobile terminal such as a smartphone or the like, for example, can be used as the terminal device.

According to the present configuration, even when the air conditioner 2004, 3004 is not directly connected to the network, it is possible to send the history information from the air conditioner 2004 to the cloud server 2002, and to send the coefficient information and the weather record information from the cloud server 2002, 3002 to the air conditioner 2004, 3004.

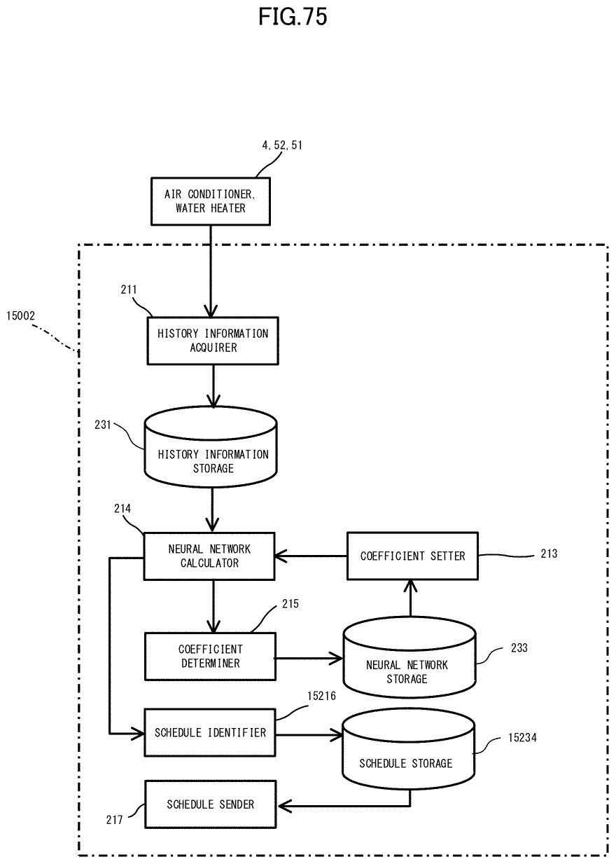

In Embodiment 2, a configuration is described in which the cloud server 15002 uses the weather information acquired from the weather server 3 to generate the schedule information. However, the present disclosure is not limited thereto, and a configuration is possible in which, for example, the cloud server 15002 calculates the device setting parameter without using the weather information to generate the schedule information. In such a case, for example, as illustrated in FIG. 75, it is sufficient that the cloud server 15002 has a configuration that does not include the weather information acquirer 212 and the weather information storage 232.

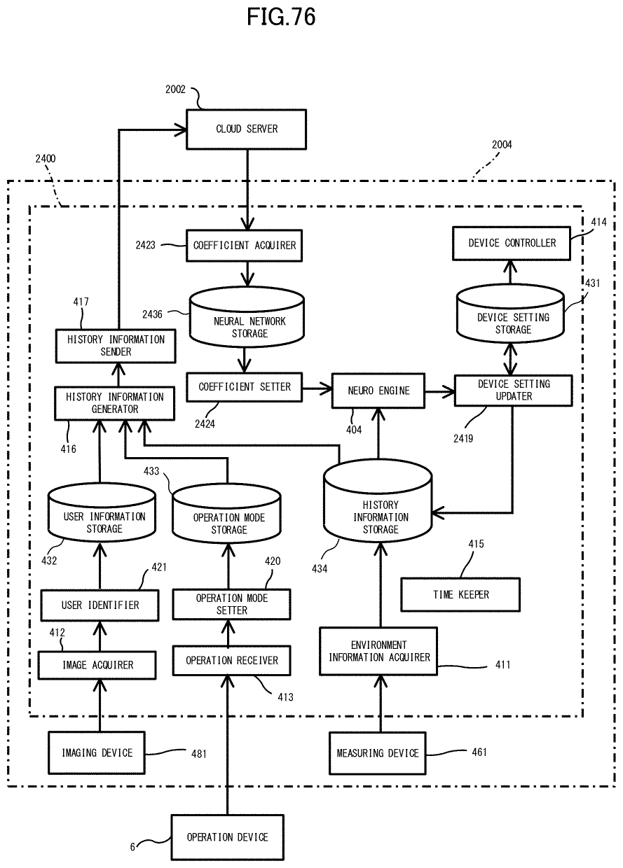

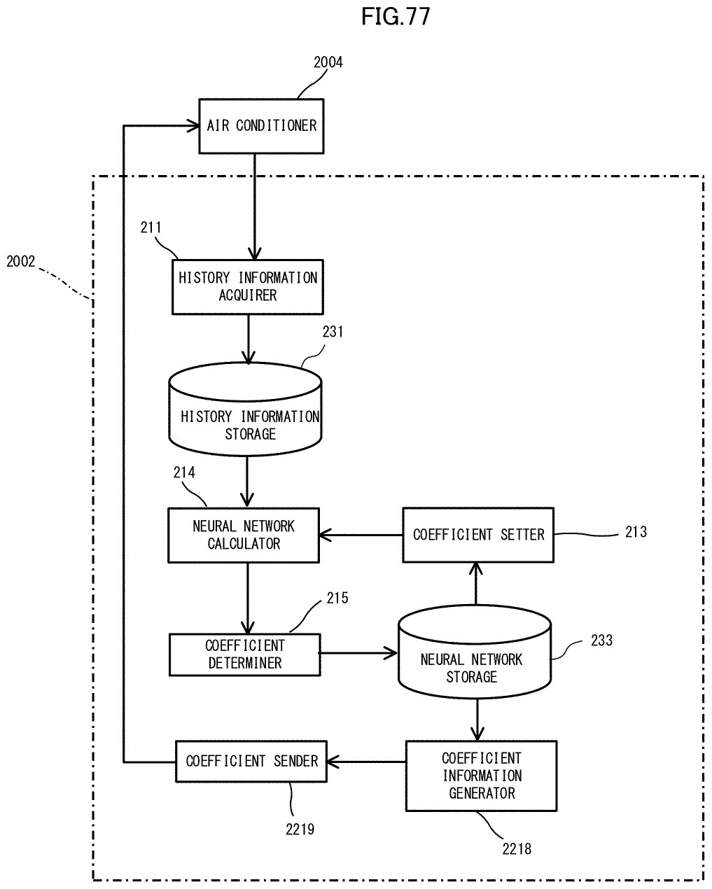

In Embodiment 3, a configuration is described in which the air conditioner 2004 uses the weather information acquired from the weather server 3 to calculate the device setting parameter. However, the present disclosure is not limited thereto, and a configuration is possible in which, for example, the air conditioner 2004 calculates the device setting parameter without using the weather information. In such a case, for example, as illustrated in FIG. 76, it is sufficient that the air conditioner 2004 has a configuration that does not include the weather information acquirer 2422 and the weather information storage 2437. Additionally, as illustrated in FIG. 77, a configuration is possible in which the cloud server 2002 does not include the weather information acquirer 212 and the weather information storage 232.

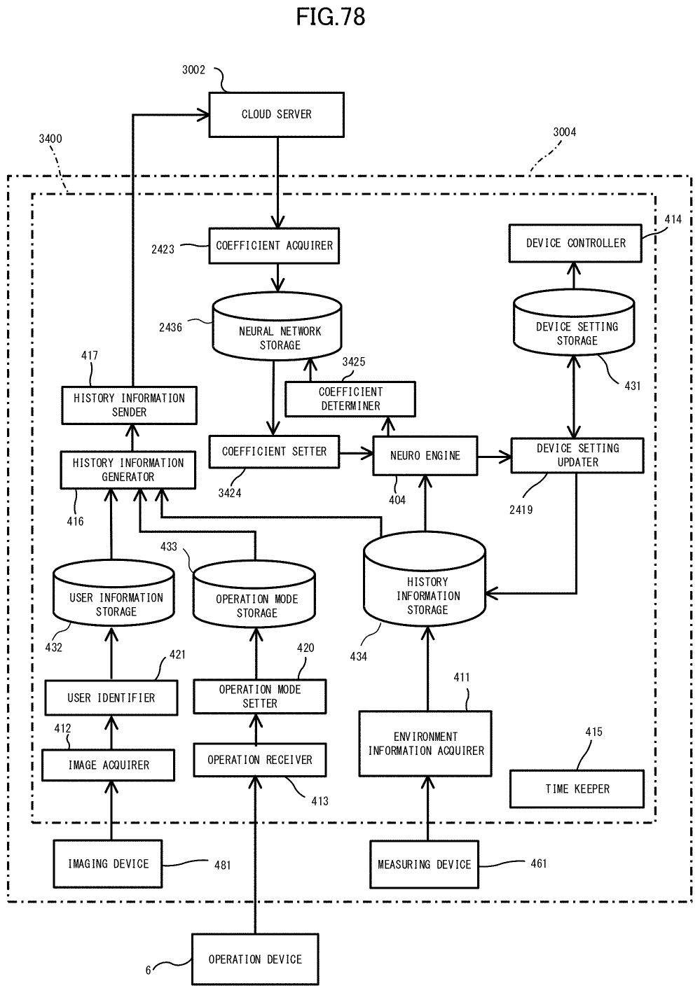

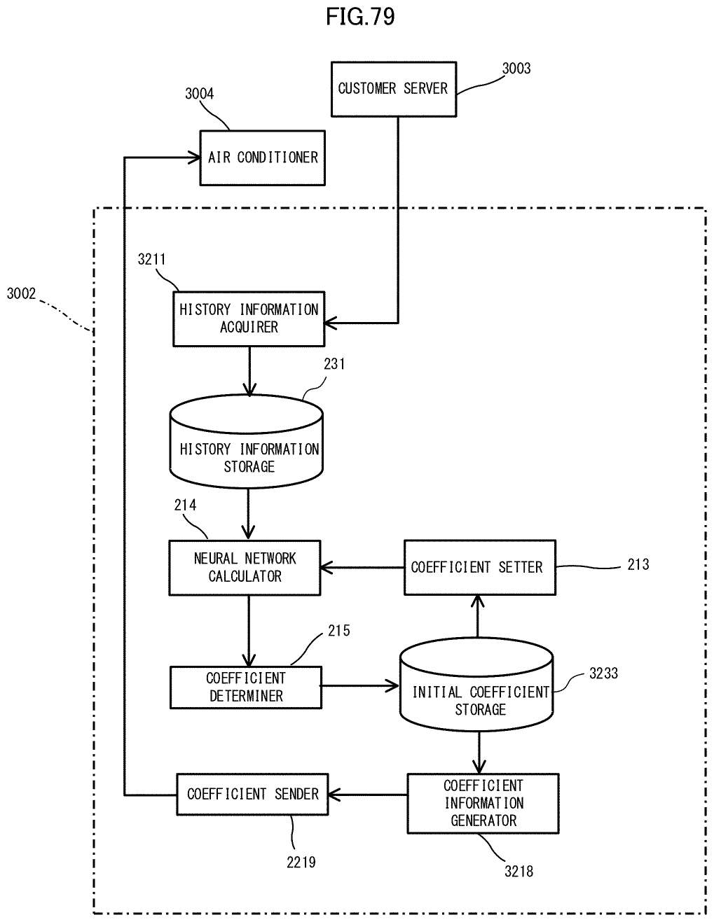

In Embodiment 5, a configuration is described in which the air conditioner 3004 uses the weather information acquired from the weather server 3 to calculate the device setting parameter. However, the present disclosure is not limited thereto, and a configuration is possible in which, for example, the air conditioner 3004 calculates the device setting parameter without using the weather information. In such a case, for example, as illustrated in FIG. 78, it is sufficient that the air conditioner 3004 has a configuration that does not include the weather information acquirer 2422 and the weather information storage 2437. Additionally, as illustrated in FIG. 79, a configuration is possible in which the cloud server 2002 does not include the weather record acquirer 3212 and the weather information storage 232.

In the various embodiments, a configuration is possible in which the user identifier 421 identifies which category, of a predetermined plurality of body types, a body type of the user of the air conditioner 4 belongs to.

Any method may be used to provide the program to a computer. For example, the program may be uploaded to a bulletin board system (BBS) of a communication line, and distributed to the computer via the communication line. Then, the computer starts up the program and, under the control of the operating system (OS), executes the program in the same manner as other applications. As a result, the computer functions as the air conditioner 4, 2004, 3004, 4004, 5041, 5042, 5043, 9004, 15004, 16004, 17004, and the cloud server 2, 2002, 3002, 4002, 5002, 9002, 15002, 16002, 17002 that execute the processings described above.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for automatically controlling the operations of a home appliance installed in a house.

1. A control system, comprising:
a server;
a first device; and
a second device, wherein
the first device includes
a first neural network calculator that calculates a future device setting parameter of the first device by using a first neural network in which a first neural network coefficient is set,
a first coefficient information generator that generates coefficient information expressing the first neural network coefficient and coefficient attribute information expressing an attribute of the coefficient information and including device identification information identifying the first device, and
a first coefficient sender that sends the coefficient information and the coefficient attribute information to the server,
the server includes
a first coefficient acquirer that receives the coefficient information and the coefficient attribute information from the first device,
a neural network storage that stores the coefficient information and the coefficient attribute information in association with the device identification information identifying the first device included in the coefficient attribute information, and
a second coefficient sender that sends the coefficient information and the coefficient attribute information stored in the neural network storage to the second device,
the second device includes
a second coefficient acquirer that acquires the coefficient information and the coefficient attribute information from the server by sending, to the server, coefficient request information requesting, to the server, sending of the coefficient information including the device identification information of the first device,
a coefficient setter that sets a neural network coefficient, expressed by the coefficient information acquired by the second coefficient acquirer, in the second neural network, and
a second neural network calculator that calculates a future device setting parameter of the second device by using a second neural network, and
when the second coefficient sender acquires the coefficient request information sent from the second device, the second coefficient sender sends the coefficient information and the coefficient attribute information to the second device.

2. The control system according to claim 1, wherein the coefficient attribute information includes format information of the neural network coefficient, structure information including information expressing a number of nodes and a number of layers of the neural network, and identification information of the device.

3. The control system according to claim 2, wherein the coefficient attribute information has a JSON schema file format.

4. The control system according to claim 1, wherein the coefficient information has a JSON file format.

5. The control system according to claim 1, further comprising
an imaging device that images a user of the device, and
a user identifier that identifies the user based on an image captured by the imaging device, wherein
the coefficient attribute information includes user information about the user identified by the user identifier.

6. The control system according to claim 1, wherein
the server includes
a history information acquirer that acquires history information including operation history information expressing a history of a device setting parameter of the first device and environment history information expressing a history of an environment in which the device operates, and history attribute information expressing an attribute of the history information,
a coefficient determiner that determines, based on the operation history information, the environment history information, and the history attribute information, a first neural network coefficient of a first neural network for calculating a future device setting parameter of the device, the first neural network having a predetermined number of nodes and a predetermined number of layers, and
a third coefficient sender that sends, to the first device, the coefficient information expressing the first neural network coefficient and the coefficient attribute information expressing the attribute of the coefficient information,
the first device includes
a third coefficient acquirer that acquires the coefficient information and the coefficient attribute information,
a coefficient setter that sets, as the first neural network coefficient, weighting coefficient information in the first neural network, the weighting coefficient information being included in the coefficient attribute information and the coefficient information acquired by the third coefficient acquirer, and
a device controller that controls the first device based on the future device setting parameter of the first device calculated by the first neural network calculator, and
the first neural network calculator calculates the future device setting parameter of the first device from an environment parameter expressing an environment at present included in the environment history information.

7. The control system according to claim 6, wherein
the server further includes a first weather information acquirer that acquires weather information including weather record information expressing a past weather condition,
the first device future includes a second weather information acquirer that acquires weather information including weather prediction information expressing a future weather condition,
the coefficient determiner determines the first neural network coefficient of the first neural network based on the operation history information, the environment history information, and the weather record information, and
the first neural network calculator calculates the future device setting parameter of the first device from the weather prediction information and the environment parameter expressing the environment at present included in the environment history information by using the first neural network in which the first neural network coefficient corresponding to the coefficient information and the coefficient attribute information acquired by the third coefficient acquirer is set.

8. A device, comprising:
a neural network calculator that calculates a future device setting parameter of the device by using a neural network in which a neural network coefficient is set;
a coefficient information generator that generates coefficient information expressing the neural network coefficient and coefficient attribute information expressing an attribute of the coefficient information and including device identification information identifying the device, and
a coefficient sender that sends the coefficient information and the coefficient attribute information to the server.

9. A control method, comprising:
calculating, by a first device, a future device setting parameter of the first device by using a first neural network in which a neural network coefficient is set;
generating, by the first device, coefficient information expressing the first neural network coefficient and coefficient attribute information expressing an attribute of the coefficient information and including device identification information identifying the first device;
sending the coefficient information and the coefficient attribute information to the server;
receiving, by the server, the coefficient information and the coefficient attribute information sent from the first device;
storing, by the server and in a neural network storage, the coefficient information and the coefficient attribute information in association with the device identification information identifying the first device included in the coefficient attribute information;
sending, by the second device and to the server, coefficient request information requesting, to the server, sending of the coefficient information including the device identification information of the first device;
sending, by the server, the coefficient information and the coefficient attribute information stored in the neural network storage to the second device when the server acquires the coefficient request information from the second device;
acquiring the coefficient information and the coefficient attribute information from the server;
setting, by the first device, a neural network coefficient expressed by the acquired coefficient information in the second neural network; and
calculating, by the second device, a future device setting parameter of the second device by using the second neural network.
